(19) United States
(12) Patent Application Publication
(10) Pub. No.: US 2025/0105645 A1
(43) Pub. Date: Mar. 27, 2025

(54) ENERGY STORAGE EQUIPPED SAFETY SYSTEM AND METHOD

(71) Applicant: Channing Street Copper Company, Berkeley, CA (US)

(72) Inventors: Samuel Calisch, Oakland, CA (US); Tucker Gilman, Oakland, CA (US); Dan Goldwater, Amherst, MA (US); Eric Wilhelm, Oakland, CA (US); David Kosecoff, San Francisco, CA (US); Pushan Chandra Panda, San Francisco, CA (US); Mitchell Heinrich, Oakland, CA (US)

(21) Appl. No.: 18/892,107

(22) Filed: Sep. 20, 2024

Related U.S. Application Data
(60) Provisional application No. 63/539,760, filed on Sep. 21, 2023.

(51) Int. Cl. H02J 7/00; F24C 7/00; H05B 6/04; H05B 6/12

(52) U.S. Cl. CPC H02J 7/0068; F24C 7/00; H02J 7/0029; H05B 6/04; H05B 6/1209

(57) ABSTRACT

A load source that includes: a housing, a battery integrally disposed within the housing, a load source computing device, and a battery management system associated with the battery. The load source is configured for one or both of: the battery management system configured to identify a first error based at least in part on a first set of data associated with the load source and report the first error to the load source computing device to cause a change in operation of the load source, and the load source computing device configured to identify a second error based at least in part on a second set of data associated with the load source and report the second error to the battery management system to cause a change in operation of the battery.

### CROSS-REFERENCE TO RELATED APPLICATIONS

This application is a non-provisional of and claims the benefit of U.S. provisional patent application No. 63/539,760, filed Sep. 21, 2023, entitled “Energy Storage Equipped Safety System And Method,” with attorney docket number 0122186-004PR0. This application is hereby incorporated herein by reference in its entirety and for all purposes.

This application is also related to U.S. patent application Ser. No. 18/818,377, filed Aug. 28, 2024, entitled “BATTERY-INTEGRATED WATER HEATER SYSTEM AND METHOD,” with attorney docket number 0122186-003US0, which is a non-provisional of and claims the benefit of U.S. provisional patent application No. 63/535,023, filed Aug. 28, 2023, entitled “Energy Storage Equipped Water Heater Architecture,” with attorney docket number 0122186-003PR0. These applications are hereby incorporated herein by reference in their entirety and for all purposes.

This application is also related to U.S. patent application Ser. No. 18/814,022, filed Aug. 23, 2024, entitled “BATTERY-INTEGRATED APPLIANCE SYSTEM AND METHOD,” with attorney docket number 0122186-002US0, which is a non-provisional of and claims the benefit of U.S. provisional patent application No. 63/534,727, filed Aug. 25, 2023, entitled “Battery Enhanced Appliances,” with attorney docket number 0122186-002PR0. These applications are hereby incorporated herein by reference in their entirety and for all purposes.

This application is also related to U.S. patent application Ser. No. 17/692,714, filed Mar. 11, 2022, entitled “APPLIANCE LEVEL BATTERY-BASED ENERGY STORAGE,” with attorney docket number 0122186-001US0, which is a non-provisional of and claims the benefit of U.S. Provisional Application No. 63/159,851, filed Mar. 11, 2021, entitled “APPLIANCE LEVEL BATTERY-BASED ENERGY STORAGE,” which applications are hereby incorporated herein by reference in their entirety and for all purposes.

### BRIEF DESCRIPTION OF THE DRAWINGS

FIG. 1 illustrates an example of a powered building system of one embodiment.

FIG. 2 illustrates examples of load sources that can be associated with a powered building system of some embodiments.

FIG. 3 illustrates an example embodiment of a stove load source that comprises a load source system having a battery.

FIG. 4 illustrates one example embodiment of a load source system, which can comprise one or more batteries, a processor, a memory, a clock, a control system, a communication system, an interface, an electrical power bus, an AC/DC conversion module and one or more sensors.

FIG. 5 illustrates another example embodiment of a load source system that comprises an electrical input, a charger, an induction driver, a battery, a DC-DC converter, an inverter, a switch, and an auxiliary electrical output.

FIG. 6 illustrates another embodiment of a load source system.

FIG. 7 illustrates an example embodiment of a water heater load source that comprises a load source system having a battery.

FIG. 8 illustrates another example embodiment of a load source system that comprises an electrical input, a charger, a computer, a battery, a controller, and a transformer.

FIG. 9 illustrates an example battery architecture of a battery that includes a battery enclosure with three decomposable sub-packs within the enclosure that can be isolated using keys.

FIG. 10 illustrates an example embodiment of a battery network that comprises three load source systems, a battery server, and a user device, which are operably connected via a network.

FIG. 11 illustrates another embodiment of a load source system.

FIG. 12 illustrates a further embodiment of a load source system.

FIG. 13 is a block diagram of an example method of determining an operating configuration for a load source system.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Because various embodiments of Energy Storage Equipped (ESE) appliances can contain a battery energy storage system, safety can be an important feature in some examples. There are many ways such appliances can be made safe, even in the context of an uncertain environment.

In some embodiments, one or more safety-related features for appliances can be integrated in the structure and design of the appliance itself. This can span areas of eliminating the chance of a safety issue cropping up to limiting the severity of a safety issue that cannot be avoided. With respect to the battery enclosure mechanical design of various embodiments, there can be numerous ways to avoid risk of battery fires, the severity of a fire, potential for human exposure to high voltages and the exposure to battery cells to moisture and humidity. Various embodiments can include smart safety and diagnostics.

A safety feature of some embodiments includes a battery-powered device and battery module that display error codes and mutually prevent each other from full operation based on the nature of the error. This can include scenarios where the battery reports poor health, the device is faulty, there is an ID (e.g., a manufacturer-programmed software key) mismatch between the battery and device or vice versa (e.g., the battery module and device do not recognize each other or are not mutually supportive). These systems can communicate errors through various signals and may have secondary low-power states dedicated to error code transmission and display.

One advantage of various energy storage equipped devices can be that the battery continues to power the device in the event of a blackout (e.g., when the primary wall AC power source becomes unavailable). Through the use of battery power, the device in some embodiments powers circuitry that measures or senses a voltage along the primary power source's input path and powers circuitry that can inform the user about the state of the primary power source. By knowing the status of the grid and/or renewable energy sources, in various embodiments the user may make safer and more educated decisions related to their home activities.

Some appliances can include water heaters and heat pumps. In some examples, such appliances may not be located in parts of the home that the user will frequent, such as the basement or garage. For these “hidden” appliances to communicate their status to the user, it may not be sufficient to communicate the status on the device's onboard or local UI, as the user may not readily see it. If the user is unaware of any issues detected by the appliance, it may present a safety issue. Accordingly, some embodiments can include a trans-device communication protocol between devices within the ecosystem, such that the status of a “hidden” appliance can alert/be made readily visible to the user (e.g., via an appliance or device that is more frequently observed by the user).

Because various embodiments of the appliance have a battery, data can be collected during times when no external power is available, like shipping and warehousing.

The appliance or integrated battery in various embodiments can have additional layers of safety mechanisms or systems including one or more of the following. These systems can have a variety of effects and can work independently or together in concert to call for help, safely exhaust stored energy, and/or ensure the stored energy is inaccessible.

Instead of relying solely on a single type of energy storage (e.g., lithium-ion batteries), the device in some embodiments can use a hybrid system incorporating supercapacitors or other types of batteries. This diversity can offer safety advantages in some embodiments; for instance, supercapacitors can be charged and discharged much more rapidly than traditional batteries, offering an alternative means to dump energy quickly in an emergency. This can also mitigate risks associated with a particular type of energy storage going into a failure mode, as the secondary system can step in.

Systems and methods for battery enhanced appliances described in various embodiments discussed herein can function to provide various solutions and enhanced functionality for a modern appliance. In particular, the systems and methods of some examples can provide an energy storage equipped cooking stove (or other type of appliance) that uses an electrical architecture and configuration that ensures safety and provides DC power to high-load cooking elements of a stove or other type of electrical appliance.

The systems and methods of some embodiments may include components and/or operational processes to facilitate conversion from an alternating current power source (e.g., from a wall outlet) to DC power used to drive various elements of the stove (e.g., high-load elements such as convection and/or broiler heating elements of an oven, induction coil drivers, and/or integrated induction stovetop modules) and charge an auxiliary power source, which may also supply DC power. In some variations, the DC power matches voltage of the auxiliary power source (e.g., storage battery voltage) such that the high-load elements of an appliance may be powered directly from the auxiliary power source without further voltage conversion.

The systems and methods of various embodiments may include or be implemented through an AC power input, an AC/DC conversion module, and one or more heating modules/elements. The heating module/element may include an induction heating module (e.g., used for induction stovetop) and/or a resistive heating module/element (e.g., used for an oven, cooktop, clothes dryer, water heater, heat pump, or the like). The system may additionally include an auxiliary power source that can be managed and used as a backup or as a supplement to power delivered through the AC power input.

The components of various embodiments are integrated into an appliance system such as a cooking range, an oven, a cooktop, a clothes dryer, water heater, heat pump, or the like. Depending on the capabilities and features of such an appliance, the exact architecture of the appliance may be adjusted. For example, the system and methods discussed herein can be embodied in a stove or other appliance configured to be a combined stovetop and an oven, just a stovetop, just an oven, and/or any suitable type of cooking appliance.

The systems and methods are described in some examples in the context of use and application with an induction stove having a cooktop and oven and a water heater having a heat pump, but these examples should not be construed as limiting. The systems and methods of various embodiments may additionally or alternatively comprise resistive heating in addition to or in place of induction heating. The systems and methods of various embodiments can be modified or configured for use with other electrical appliances or devices such as air conditioners, laundry machines/dryers, heat pumps, and the like.

In some variations, a battery enhanced appliance may be used in connection with a network of other appliances. These can be other appliances in the same house, which may also be battery enhanced appliances or may be other types of electrical appliances without battery or power storage. In some variations, the systems and methods of some examples may be used with a powered building system and electric power distribution system such as the one described in U.S. patent application Ser. No. 17/692,714, filed Mar. 11, 2022, entitled “APPLIANCE LEVEL BATTERY-BASED ENERGY STORAGE,” which is incorporated by reference.

As one potential benefit, the systems and methods of some examples can enable use of a line power source (i.e., a wall outlet power source) with a battery power source to augment capabilities of an electric stove. The systems and methods of some examples can preserve functionality and capabilities of more traditional natural gas ranges while enabling a transition to electrical power. Enabling use of an electrical power source can have many benefits as the world transitions to more sustainable power sources.

As one potential benefit, the system and method of some examples may lower the requirements of a building's existing electrical system when using an electrical appliance, thereby enabling wider adoption of electrical appliances. Common residential electrical outlets (e.g., “120V standard outlet”) can have insufficient power capacity for many appliances, typically requiring installation of a higher voltage and higher power outlet (e.g., “240V appliance outlet”). By augmenting an appliance with the systems and methods of some embodiments (e.g., an integral or attached energy storage system such as a battery), a standard 120V electrical outlet may be used with the systems and methods of various examples to supply a much higher power level to the appliance in a non-continuous-use application. In some embodiments, this can be an equivalent power level to a traditional 240V appliance outlet.

In some variations, such as an on-demand hot water heater, even a single 240V appliance outlet can be insufficient for the appliance, and by using some embodiments herein, sufficient power can be provided to the appliance in various examples, which might otherwise require a multi-circuit and/or hard-wired electrical installation, or might exceed the capacity of the entire load center.

As another potential benefit, the systems and methods of some embodiments may enable use of the stove and/or other appliance type during varying power availability. For example, some variations described herein may allow for use of the stove during power blackouts, during increased grid use (e.g., when electrical costs are high), and/or when using other electrical appliances at the same time.

As another potential benefit, systems and methods of various embodiments can avoid limitations and problems that occur with AC induction-based heating appliances. This may include audible and tactile vibrations that can make the cooking experience less pleasurable. Furthermore, some variations of the systems and methods discussed herein may enable customization of the sound and feel of induction cooking to make the cooking experience more pleasurable and/or safe. For example, some auditory and/or vibrational sensations may be actively enabled when cooking as a form of feedback that a pot is heating up. These auditory and tactile cues could be varied based on conditions.

As another potential benefit, the systems and methods of some examples may enable a reduction in usage of various components used in AC appliances. For example, the systems and methods of various embodiments may avoid or reduce the number of filter capacitors/inductors, rectification systems. In particular, the systems and methods of some examples may eliminate or reduce the need for a PFC circuit and/or EMI/RFI circuits, which may be required for an AC-powered induction device. The firmware may similarly be simplified in some embodiments. The resulting systems and methods of various embodiments may enable an appliance that can be less heavy, smaller, cheaper and quieter.

As another potential benefit, the systems and methods of some embodiments can decouple device performance from limitations of outlet capacity and/or inverter capacity. The systems and methods of various examples comprise a battery that can enable capacity and power capabilities to be based on the battery. A stove in some embodiments can be designed with power capacity to support increased number of cooktop heating zones, larger cooktop heating zones, more ovens, larger ovens, faster preheat times, more fans, more lights, and/or other features.

In one example, a system variation can include a battery charger that can draw up to 15 A from a standard 120V wall outlet, charging the battery with a nominal 230 VDC and 5 kWh capacity. Once fully charged, the system in various embodiments can supply, for example, approximately 7 kW for one hour to an appliance (5 kW from the battery+1.875 kW from the standard wall outlet), after which the battery may need re-charging. In a scenario of some examples, the battery charges whenever the appliance is not in use, or in use at a low power level, such that it is fully charged when needed or desired. The specific battery voltage can be adjusted in various embodiments based on the internal design of the appliance load elements. The battery capacity (kWh) can be adjusted in various embodiments based on a desired usage profile of the appliance, cost, or other factors. In another example, the charger may draw 30 A from a standard 240V appliance outlet, charging a battery with a nominal 230 VDC and 10 kWh capacity. Once fully charged, the system of some embodiments can provide approximately 30 kW for 20 minutes, as might be utilized in some examples by an on-demand hot water heater which may require 2× or 3× the capacity of a standard 240V appliance outlet.

One example embodiment includes a first load source system that is an integral component of and disposed within a housing of a first load source of the plurality of load sources, the first load source comprising a first power cord plugged into a first receptable of the plurality of receptacles, the first load source system comprising a first battery configured to obtain and store power from the first receptacle, the first load source being configured to be fully powered by power stored by the first battery and configured to be fully powered by power obtained from the first receptacle and configured to be partially powered by both the first battery and power obtained from the first receptacle.

Various embodiments can eliminate significant upgrade costs required to replace fossil fuel appliances. Many electric appliances (e.g., induction ranges and electric dryers) require dedicated high-capacity circuits to be installed, but only draw their full capacity for short periods of time. This electrical work can significantly increase the cost of such an upgrade, providing a large barrier to entry, and can negate any value proposition the increased efficiency of these more advanced appliances may provide. As an example, a four-burner induction cooktop with oven on its own runs from $1,000-$2,000, and (in the lucky case where an appropriate 240V circuit is already available) can be installed by the homeowner or a general contractor for $150-$200. If a stove of some embodiments is replacing a natural gas stove, however, the likelihood that an appropriate, unused circuit is available at the correct location is very low, and the cost to install the required 30-40 amp appliance circuit is roughly $800-1,000, with an additional $380-$460 required if the routing from the circuit breaker to the stove is long or inconvenient. Further, in most cases the available electrical service was designed assuming fossil fuel use and is insufficient for this large additional circuit. Upgrading the service panel in this situation can add an additional $1,500-$4,000 on top of the project cost, making the total cost of replacing the natural gas stove a factor of 2-6 higher than the underlying new appliance cost.

In various embodiments, appliances with integrated or associated batteries as discussed herein can eliminate the need to upgrade electrical service, as they can supply the required high current during use, while only drawing meager average power from an existing 110V electrical outlet to recharge. In the case of the induction stove, the overwhelming majority of dinnertime cooking needs can be met by a 0.75-1.5 kWh integrated battery. This battery can add a mere $100-$200 to the appliance cost if installed in the factory at current EV prices, and less as the scale of this industry continues to bring costs down. As a result, the total project cost to the homeowner to eliminate this source of residential emissions remains predictable and low, and the dinnertime cooking loads, which occur largely outside the productive window for solar, can be cost-effectively shifted to be powered by renewables.

Additionally, centralized main home batteries can require large, dedicated inverters to supply AC power, even when appliances (e.g., induction stoves) use internal rectification to convert the power back to DC. Placing batteries at these points of load can allow direct DC powering of the appliance, with only modest AC draw from the electrical outlet in various embodiments. On a systemic level, in various embodiments this can eliminate the inversion-rectification cycle on power drawn and deferred from the grid, and significantly reduce the power requirements on an inverter supplying power from a rooftop solar array. The result can be a reduction in system cost, and an efficiency increase due to eliminated power conversions.

Also, large battery packs that may be required for main home batteries are often spoiled by a single bad cell. In contrast, a ˜1 kWh commoditized pack that can be used to power a home appliance can be easier to manage than centralized batteries, and in various embodiments can be made easier to replace in the event of failure. Having fewer cells under a battery management system (BMS) can allow, in some embodiments, better control over charge cycle, mechanical, and thermal stress and more robust health diagnostics, leading to longer battery life. Battery management systems and supporting power electronics can be at a price point such that an increased number of them does not present a cost barrier. As an additional benefit to this approach, in some embodiments smaller battery packs used for point of load storage can be more appropriate for second-life applications of plug-in EV batteries-supply of which is expected to grow rapidly in the next 10 years. Even after use in an EV, such cells are expected to have 70% of their initial capacity and be viable for another 10 years in their second-life application.

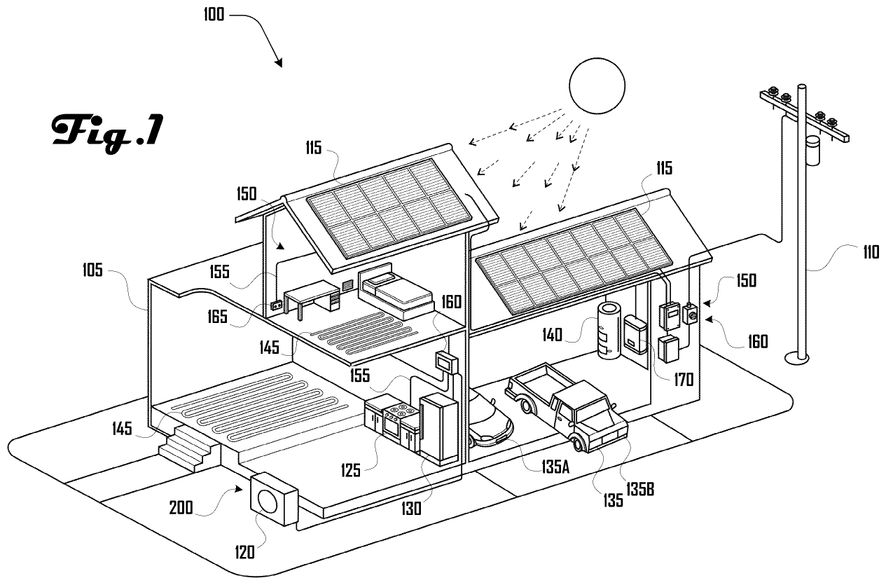

FIG. 1 illustrates an example of a powered building system 100 that comprises a building 105, which can obtain electrical power from various suitable sources such as an electrical power grid 110, one or more solar panels 115, and the like. Such electrical power can power to various suitable load sources 200 (e.g., appliances, elements, systems, vehicles, and the like), such as a heat pump 120, electric stove 125, refrigerator 130, electric vehicles 135, water heater 140, electrical floor heating elements 145, and the like. Power can be distributed to or among such load sources 200 via an electric power distribution system 150 that can comprise power lines 155, electrical sub-elements 160 that provide power to electrical receptacles 165, or the like.

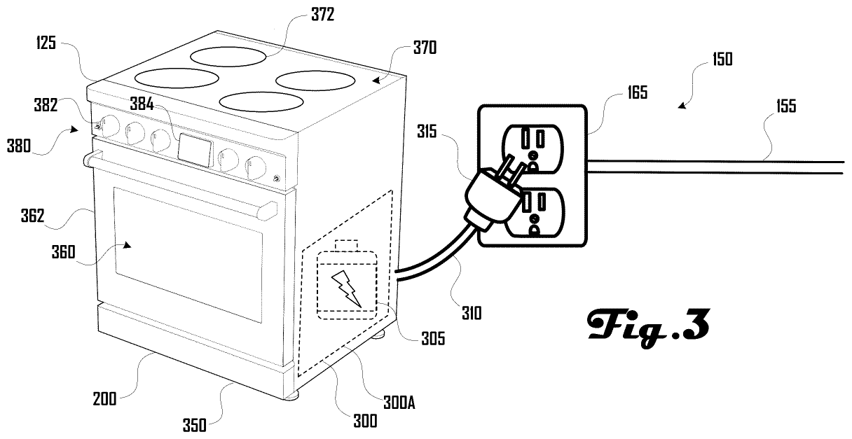

As discussed in more detail herein, in various embodiments load sources 200 can be respectively associated with a battery 305 and/or load source system 300 (See e.g., FIG. 3); however, in some embodiments, the powered building system 100 can comprise one or more building system battery 170 that is not directly associated with a specific load sources 200, and can be configured to store energy for the powered building system 100 generally for distribution to the electrical power grid 110, to the load sources 200 associated with the powered building system 100, or the like. In some embodiments a building system battery 170 can be absent.

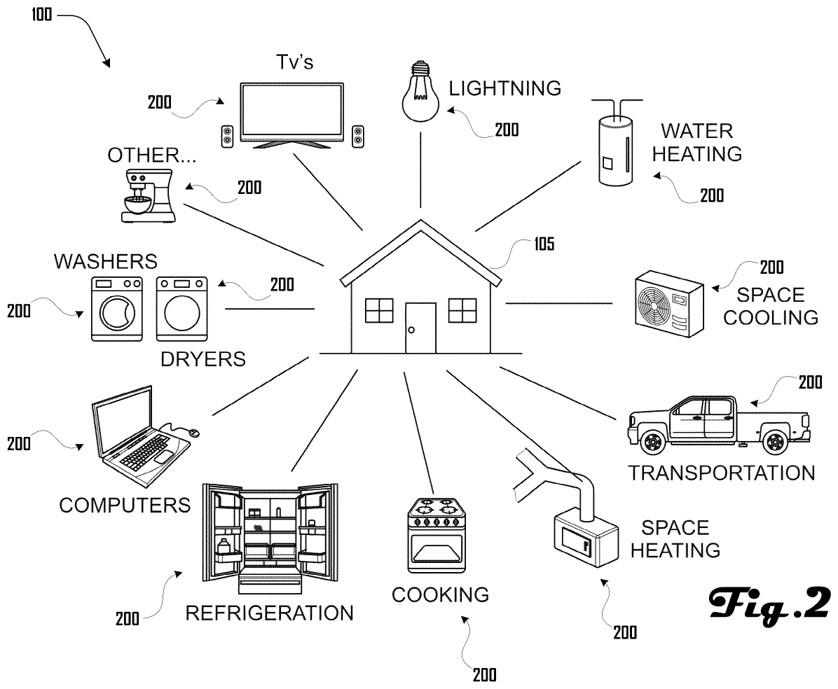

While FIG. 1 illustrates one example embodiment of a powered building system 100, such an embodiment should not be construed to be limiting on the wide variety of load sources 200 that can be powered, associated with a battery and/or load source system, or the like. For example, FIG. 2 illustrates further examples of load sources 200 that can be associated with the powered building system 100 in further embodiments. Additionally, while various embodiments of a powered building system 100 can relate to a single-family residential home, it should be clear that further embodiments can relate to multi-family residences, mixed-use buildings, commercial buildings, factories, airports, farms, or other suitable building, structure, or land. Additionally, some embodiments can be applicable to vehicles or structures such as a cruise ship, offshore platform, airplane, bus, or the like.

Also, while the example of FIG. 1 illustrates a powered building system 100 associated with an electrical power grid 110, such as regional electrical power provider that provides power to a plurality of buildings 105 and/or powered building systems 100, in further embodiments a powered building system 100 may not be associated with or connected to an electrical power grid 110. Additionally, while the example of FIG. 1 illustrates a powered building system 100 that obtains electrical power from one or more solar panels, in further embodiments any suitable additional or alternative electrical power generation systems and methods can be part of a powered building system 100, such as a wind turbine, water turbine, geothermal power generator, nuclear power system, chemical or combustion power generator, or the like.

FIG. 3 illustrates an example of a stove 125 load source 200 that comprises an embodiment 300A of a load source system 300 having a battery 305. For example, the load source system 300A can be an internal component of the stove 125, an integral component of the stove 125, disposed within a housing of the stove 125, or the like. For example, in some embodiments, a portion of the load source system 300A and/or battery 305 can be an integral part of the stove 125 such that such portions cannot be removed or easily removed from the stove 125, which can include, in some examples, such portions being enclosed within a housing of the stove 125 so that such portions are not accessible externally to users. However, in some examples, the battery 305 can be removable, replaceable, and/or modular as discussed herein.

As shown in FIG. 3, the stove 125 can comprise a power cord 310 with a plug 315 configured to couple with an electrical power receptacle 165 of a power distribution system 150. For example, the power distribution system 150 can provide power to the receptacle 165 via power lines 155, where the receptacle 165 is disposed on a wall of a building 105 (FIG. 1) with power lines 155 running though the wall, or the like. The stove 125 can plug into the receptacle 165 which can provide electrical power to the stove 125 and the battery 305 of the load source system 300, which can be configured to store electrical power and/or provide electrical power to the stove 125 as discussed herein.

In various embodiments, the stove 125 can comprise a housing 350, an oven 360 having an oven door 362, a cooktop 370 having one or more heating regions 372 and a stove interface 380 having a plurality of knobs 382 and display 384. As discussed herein in more detail such elements can be a part of or associated with the load source system 300, such as heating elements of a load source system 300 being configured to generate heat in the oven 360 and/or at the cooktop 370 based at least in part on configuration of the knobs 382 and/or display 384 of the stove interface 380. In various embodiments, the stove 125 can be an inductive stove that includes an induction driver that powers induction coils associated with one or more heating regions 372. However, the oven 360 and/or heating regions 372 of the cooktop 370 can be heated or generate heat in any suitable way in further embodiments, including inductive heating, resistive heating, gas heating, halogen heating, microwave heating, convection heating, radiant heating, steam heating, solid fuel heating, and the like.

One preferred embodiment includes a stove 125 that is standard 30-inch range having a width of 29⅞ inches; depth of 28 15/16 inches, including handle; and height of 35¾ to 36¼ inches to the cooking surface. Further embodiments of a stove can have a standardized or customized width of, or be configured for a width of, 20, 22, 24, 26, 28, 30, 32, 34, 36, 38, 40, 42, 44, 46, 28 inches, and the like, or a range between such example values. In some embodiments, a stove 125 can have depth of 25, 26, 27, 28, 29, 30 inches, or the like, or a range between such example values. In various embodiments, a stove 125 can be configured for a standard 36-inch countertop height with adjustable legs that provide adjustment of +/−0.25, 0.5, 0.75, 1.0 inches, or the like, or a range between such example values.

In one preferred embodiment, a stove 125 has an oven 360 with an oven capacity of 4.55 cubic feet, and oven width of 22⅛ inches, an oven depth of 16¼ inches, an oven height of 17 inches and five oven rack positions. Further embodiments can include an oven 360 with a capacity of 2.0, 2.5, 3.0, 3.5, 4.0, 4.5, 5.5, 6.0, 6.5 cubic feet, or the like, or a range between such example values.

In one preferred embodiment, a cooktop 370 of a stove 125 comprises four symmetrical 7.9-inch high-power induction cooking zones 372 that have a minimum pan pairing size of 3⅛ inches. In further embodiments, a stove 125 can comprise any suitable number of cooking zones 372, including 1, 2, 3, 4, 5, 6, 8, 10, 12, or the like, or a range between such example values. Such cooking zones 372 can be the same size or different sizes and can include a diameter of 5, 6, 7, 8, 9, 10, 11, 12 inches, or the like, or a range between such example values. Such cooking zones 372 can be planar or in some embodiments can be concave to accommodate a curved pan (e.g., for induction cooking). However, it should be clear that further embodiments can include any suitable stove, range, or the like, which can include any suitable elements in various suitable configurations, so the present examples should not be construed as being limiting.

In some embodiments, one or more batteries 305 and/or load source systems 300 can be integrated into a load source 200 (e.g., into an appliance housing) at the factory where the load source is manufactured or can be integrated into load source aftermarket. For example, load sources 200 (e.g., appliances) can be specifically designed to allow integration of the appropriate quantity of batteries 305 and/or other elements of a load source system 300 within their normal housing. This can allow for such load sources 200 or appliances to be placed within a residence without any change to how they are integrated into standardized fixturing, such as counters. In various embodiments, electrical connections to batteries 305 and/or other elements of a load source system 300 are made in the factory and fully integrated into the appliance circuit. This can allow for load sources 200 such as appliances that utilize DC current (e.g., induction stove) to pull power directly from the one or more batteries 305 without the added cost of a high-power inverter.

In some embodiments, batteries can be designed to be integrated into load sources (e.g., appliances) in an aftermarket factory setting. For example, a company that is not the original equipment manufacturer of an appliance buys new appliances, installs the load source system 300 in their own facility, and re-sells the appliance as new. The retrofitter in some examples installs one or more batteries 305 and/or elements of the load source system 300 within the housing of the appliance, wiring them directly into the integral electrical system of the appliance. This can be desirable in some embodiments if high-voltage connections are required given the danger of such high-voltage connection if not being handled by a professional. Also, in some embodiments where a load source 200 (e.g., an appliance) has an internal rectification circuit, such as an induction stove or the like, that is converting 60 Hz AC current to DC, it can be desirable in some examples to connect the load source system 300 directly into the internal circuitry of the load source (e.g., to avoid costly addition of high-power inversion).

In some embodiments, batteries 305 and elements of a load source system 300 are designed to nest with load sources (e.g., appliances), either as a footing, or a backing, etc. Such nesting can be done by the customer in various examples. Batteries 305 and/or elements of a load source system 300 can be designed to nest directly external to the appliance, such as by taking into consideration the shape and intended location of the appliance within a house 105. One or more batteries 305 and elements of a load source system 300 (e.g., power control stage) are packaged in such a way in various examples such that they can be placed directly alongside the appliance. The appliance can be plugged into the load source system 300 and the load source system 300 is then plugged into the wall.

Additionally, it should be clear that a powered building system 100 can include any suitable number and type of load source systems 300 including one or more of the load source systems 300 shown herein. However, in some examples one or more of the load source systems 300 shown herein can be specifically absent.

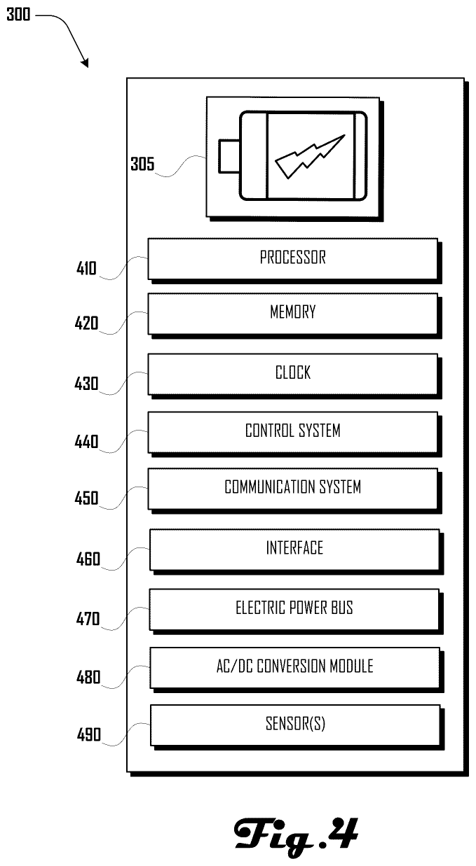

A load source system 300 can comprise various suitable elements. For example, FIG. 4 illustrates one example embodiment of a load source system 300, which can comprise one or more batteries 305, a processor 410, a memory 420, a clock 430, a control system 440, a communication system 450, an interface 460, an electrical power bus 470, an AC/DC conversion module 480 and one or more sensors 490.

For example, in some embodiments, a load source system 300 can comprise a computing device which can be configured to perform methods or portions thereof discussed herein. The memory 420 can comprise a computer-readable medium that stores instructions, that when executed by the processor 410, causes the load source system 300 to perform methods or portions thereof discussed herein, or other suitable functions. The clock 430 can be configured to determine date and/or time (e.g., year, month, day of the week, day of the year, time, and the like) which as discussed in more detail herein, can in some examples be used to configure the power storage and/or power discharge of the battery 305 based on time.

The control system 440 in various embodiments can be configured to control power storage and/or power discharge of the battery 305 based on instructions from the processor, or the like. Additionally, in some embodiments, the control system 440 can determine various aspects, characteristics or states of the battery 305 such as a charge state (e.g., percent charged or discharged), battery charge capacity, battery health, battery temperature, or the like. For example, in various embodiments, a load source system 300 can comprise various suitable sensors to determine such aspects, characteristics or states of the battery 305 or aspects, characteristics or states of other elements of a building system 100 which can include environmental conditions such as temperature, humidity, or the like, internal to or external to a building 105.

In some embodiments, the control system 440 can be configured for various features such as: maintaining a data pipeline to the cloud or another wireless device (e.g., by way of CANBus communication between peripherals and a Wi-Fi, Bluetooth, or Cellular module) to remotely log system data and manage firmware updates; interpreting the states/positions of user interface controls (e.g., knobs, buttons, switches) and carrying out corresponding actions within the device; providing feedback control to cooking operations of the load source system 300 via temperature and current sensing; and the like. The control system 440 may additionally be used in enabling and facilitating various operating modes and features (e.g., cooking features, safety features, etc.)

In various embodiments, the communication system 450 can be configured to allow the load source system 300 to communicate via one or more communication networks as discussed in more detail herein, which in some embodiments can include wireless and/or wired networks and can include communication with devices such as one or more other load source systems 300, user device, server, or the like.

The interface 460 can include various elements configured to receive input and/or present information (e.g., to a user). For example, in some embodiments, the interface can comprise a touch screen, a keyboard, one or more buttons, one or more knobs, one or more lights, a speaker, a microphone, a haptic interface, and the like. In various embodiments, the interface 460 can be used by a user for various suitable purposes, such as to configure the load source system 300, view an aspect, characteristic or state of the load source system 300, configure network connections of the load source system 300, or the like. In some embodiments, the interface 460 can comprise a stove interface 380 having a plurality of knobs 382 as shown in the example of FIG. 3.

The electrical power bus 470 can be configured to obtain electrical power from one or more sources and/or provide electrical power to one or more load sources 200. For example, in various embodiments, the electrical power bus 470 can obtain power from one or more power receptacles 165 (see, e.g., FIG. 3) or other suitable interface with a power distribution system 150, or directly from a power source such as an electrical power grid 110, solar panel 115, or the like. Such obtained electrical power can be stored via one or more batteries 305 or can be directed to one or more load sources 200 connected to the load source system 300. Such obtained electrical power can be directed to such one or more load sources 200 via the one or more batteries 305 or bypassing the one or more batteries 305.

In various embodiments, the AC/DC conversion module 480 (e.g., in an induction stove) can be configured transforming the alternating current (AC) such as from a standard household outlet into direct current (DC) suitable for powering various elements of the load source system 300 (e.g., parts of an induction stove). The AC/DC conversion module 480 of various examples can include a rectifier circuit, which converts the AC voltage into a pulsating DC voltage, followed by a filter that smooths out the fluctuations to produce a steady DC output. Additionally, the AC/DC conversion module 480 of various embodiments can include voltage regulation circuitry to ensure the output remains within a specific voltage range, accommodating the precise needs of the elements of the load source system 300 such as electronic controls and induction driver. The AC/DC conversion module 480 of some examples not only powers the main induction heating elements but also supplies DC power to auxiliary components such as a control panel, sensors, a cooling fan, and the like. Example embodiments of an AC/DC conversion module 480 and components thereof are discussed in more detail herein.

Any suitable sensors 490 can be used in a load source system 300. For example, various suitable sensors can be used for sensing temperature (e.g., for generating an over-temperature cut-off response) can including thermal fuses, thermostats, thermocouples, thermistors, PTC (Positive Temperature Coefficient) devices, RTDs (Resistance Temperature Detectors), bimetallic switches, IC temperature sensors, thermal cut-out switches, infrared sensors, and the like.

In further embodiments, sensors can include one or more of magnetic field sensors, like Hall effect sensors, to detect the presence and size of cookware; current and voltage sensors to monitor power consumption and protect against fluctuations; capacitive touch sensors for a user interface; safety features that can be supported by overheating protection and boil-dry detection sensors; pan detection sensors to identify when cookware is placed on or removed from cooking zones; power monitoring sensors to manage power distribution; residual heat sensors to indicate when a cooktop 370 is still hot after use; electromagnetic interference sensors to monitor and minimize emissions; humidity sensors to detect steam and adjust cooking parameters; weight sensors for more precise cooking; and the like.

The one or more batteries 305 can be any suitable system configured to store and discharge energy. For example, in some embodiments, the one or more batteries 305 can comprise rechargeable lead-acid, nickel-cadmium (NiCd), nickel-metal hydride (NiMH), lithium-ion (Li-ion), LiFePO₄ (Lithium Iron Phosphate), lithium-ion polymer (LiPo), rechargeable alkaline batteries, Sodium-ion (Na-ion), Lithium Titanate (LTO), Lithium Sulfur (Li—S), Nickel-Zinc (Ni—Zn), Zinc-Air, Solid-state lithium, Flow batteries (e.g., Vanadium Redox Flow Batteries), or the like.

In some embodiments, a battery 305 of a load source system 300 can be configured to generate various suitable voltages, including 80V, 90V, 100V, 110V, 120V, 130V, 140V, 150V, 160V, 170V, 180V, 190V, 200V, 210V, 220V, 230V, 240V, 250V, 260V, 270V, 280V and the like, or a range between such example values. A battery 305 in various examples can comprise a plurality of cells, which in some examples can have a nominal voltage 3.0V, 3.1V, 3.2V, 3.3V, 3.4V, 3.5V. In one example, a battery 305 can comprise 72 cells in series, which can generate a voltage of ˜240 VDC (e.g., between 230 VDC and 250 VDC, between 220 VDC and 280 VDC, and the like).

In various embodiments, components of the load source system 300, such as heating regions 372 of the cooktop 370, oven 360, auxiliary electrical output 540, and the like can be configured to operate at different input voltages such as 120V, 130V, 140V, 150V, 160V, 170V, 180V, 190V, 200V, 210V, 220V, 230V, 240V, 250V, 260V, 270V, 280V and the like, or a range between such example values. For example, such an input voltage can be based on power from one or both of a receptacle 165 (e.g., 120V receptacle) and battery 305.

As discussed herein, rechargeable in various embodiments can be defined as having the ability to store and discharge energy multiple times without substantial degradation of the ability to store and discharge energy for at least a plurality of cycles (e.g., 5, 10, 50, 100, 500, 1000, 10k, 100k, 1M, 10M, 100M, or the like). While various preferred embodiments can include chemical storage of electrical energy, in further embodiments one or more batteries 305 can be configured to store energy in various suitable ways, such as mechanical energy, compressed fluid, thermal energy, and the like.

In some embodiments, the one or more batteries 305 can contain or be defined by removable cartridges that allow the one or more batteries 305 to scale or be replaced. Battery packs in some examples can be composed of small sub-packs that can be easily removed. This can allow for old or faulty cells to be replaced in some examples. Additionally, in some examples such a configuration allows for the fine tuning of pack size within a network of load source systems 300 as discussed herein. For example, one or more batteries 305 can be initially sized and colocated with an expected load source 200.

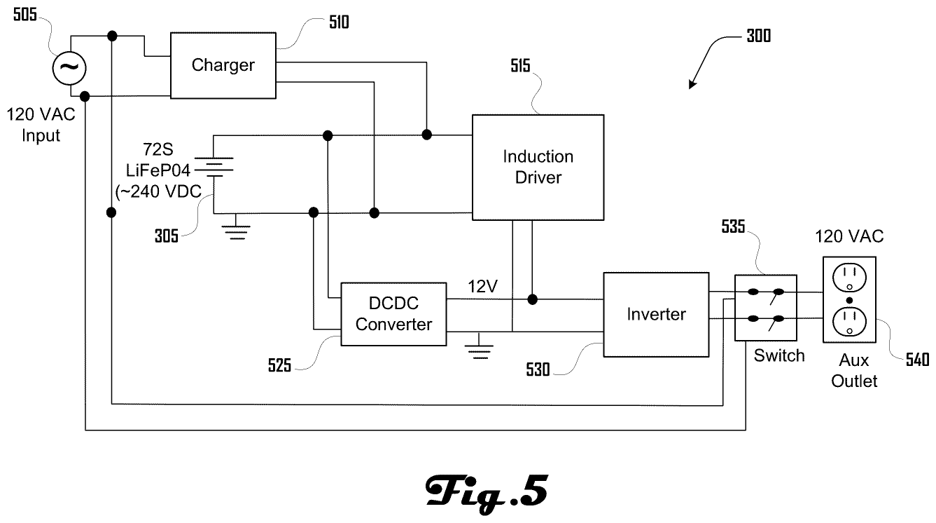

Turning to FIG. 5, another example embodiment of a load source system 300 is illustrated, which comprises an electrical input 505, a charger 510, an induction driver 515, a battery 305, a DC-DC converter 525, and inverter 530, a switch 535 and an auxiliary electrical output 540.

In various embodiments, the electrical input 505 can comprise a power cord 310 with a plug 315 configured to couple with an electrical power receptacle 165 of a power distribution system 150 (see, e.g., FIG. 3); however, various suitable elements can be part of an electrical input 505 and such an electrical input 505 can be via a direct-wire connection in various examples as discussed herein. In various embodiments, the electrical input 505 can be an AC power input that functions to provide a main source of power that can be used to charge and/or power elements of the load source system 300. The electrical input 505 may be used to power and charge an auxiliary power source or other power storage systems such as the battery 305 and/or power other elements such as a processor 410, memory 420, clock 430, control system 440, communication system 450, interface 460 (see, e.g., FIG. 4), or the like. In some examples, an AC power input of the electrical input 505 may be a 120 VAC (and/or 240 VAC) from a wall outlet (e.g., standard 15 A outlet).

In various embodiments, the charger 510 can comprise a power converter or a battery charger that manages a flow of electrical energy from the electrical input 505 to the battery 305 and/or induction diver 515. For example, in some embodiments, the charger 510 can convert an AC voltage (e.g., 120 VAC or 240 VAC) from a wall outlet into a suitable DC voltage required to charge the battery 305, which can involve rectification (converting AC to DC) and regulation (ensuring the DC output is stable and suitable for the battery). In some examples, an AC/DC regulator in an AC/DC conversion module of the charger 510 may be used to transform the power input from the electrical input 505. The charger 510 in various embodiments can monitor and control the charging process of the battery 305 to ensure it is charged efficiently and safely, preventing overcharging or overheating, and can manage the charging current and voltage according to the specifications of the battery 305.

In various embodiments, the charger 510 and/or battery 305 can supply DC power to the induction driver 515 to drive one or more induction coils to generate an electromagnetic field for heating. For example, in various embodiments, the induction driver 515 can be configured to be powered only by the charger 510; powered only by the battery 305; and/or powered by both the charger 510 and the battery 305 at the same time. As discussed herein, such powering capabilities can be desirable in various examples to allow for cooking via power from the battery 305 while power from the electrical input 505 is unavailable or undesirable such as when there is a power outage or when power obtained from the electrical input 505 is undesirably expensive (e.g., when such power obtained from a power grid is expensive). Such powering capabilities can be desirable in various examples to allow for a combination of power from the electrical input 505 and battery 305 to be used, which can allow for greater power to the induction driver 515 than would be available from the electrical input 505 alone, which can allow a stove 125 to perform near, at, or above the capability of a stove 125 powered by 240 VAC, even though the stove 125 is powered by only 120 VAC via the electrical input 505. Such powering capabilities can be desirable in various examples to allow for a combination of power from the electrical input 505 and battery 305 to be used, which can allow for a reduced amount of power consumed from the electrical input 505, which may be desirable when power obtained from the electrical input 505 is unstable, inconsistent, or undesirably expensive (e.g., when such power obtained from a power grid is expensive) or when it is desirable to draw less power from the electrical input 505 (e.g., where a circuit does not support drawing full power because of other appliances on the circuit). Such powering capabilities can be desirable in various examples to allow for the induction driver 515 to be powered via the electrical input 505, when it is undesirable to use power from the battery 305, when the battery 305 is out of power, when the battery 305 is malfunctioning, when the battery 305 is overheating, when power from the electrical input 505 is obtained from a renewable source (e.g., solar), or the like. As discussed herein, various additional and/or alternative elements can be powered via DC power from the charger 510 and/or battery 305, so the example of an induction driver 515 should not be construed to be limiting.

For example, the load source system 300 may additionally or alternatively power resistive, bake, convection and/or broiler heating elements of an oven. Further elements can include convection fans, cooling fans, oven lamps, status indicators (e.g., LEDs, displays, audio systems), user interface displays, external-facing USB ports (and their devices), speakers, externally daisy-chained high-voltage DC devices, and the like. Some of these elements may require a DC/DC regulator or a DC/AC inverter downstream (e.g., of a battery's 240 VDC) in order to operate. Some of these elements, such as the convection fans and oven lamps, may be enabled via manual control (e.g., a rocker switch), while others may be enabled via autonomous software control (e.g., via the control system 440).

The auxiliary electrical output 540 in various embodiments can comprise a standard electrical receptacle (e.g., 120 VAC receptacle) disposed on a housing of a load source 200 (e.g., a stove 125) that allows various other appliances, tools, or the like to be plugged into and powered by the load source system 300. In various embodiments, the electrical input 505 and/or battery 305 can directly or indirectly supply AC power to the auxiliary electrical output 540. For example, in various embodiments, electrical output 540 can be configured to be powered only by the electrical input 505; powered only by the battery 305; and/or powered by both the electrical input 505 and the battery 305 at the same time. As discussed herein, such powering capabilities can be desirable in various examples to allow for auxiliary power from the battery 305 while power from the electrical input 505 is unavailable or undesirable such as when there is a power outage or when power obtained from the electrical input 505 is undesirably expensive (e.g., when such power obtained from a power grid is expensive). Such powering capabilities can be desirable in various examples to allow for a combination of power from the electrical input 505 and battery 305 to be used, which can allow for greater power to the auxiliary electrical output 540 than would be available from the electrical input 505 alone, which can allow the auxiliary electrical output 540 to perform near, at, or above the capability of a stove 125 powered by 240 VAC, even though the load source system 300 is externally powered by only 120 VAC via the electrical input 505. Such powering capabilities can be desirable in various examples to allow for a combination of power from the electrical input 505 and battery 305 to be used, which can allow for a reduced amount of power consumed from the electrical input 505, which may be desirable when power obtained from the electrical input 505 is unstable, inconsistent, or undesirably expensive (e.g., when such power obtained from a power grid is expensive) or when it is desirable to draw less power from the electrical input 505 (e.g., where a circuit does not support drawing full power because of other appliances on the circuit). Such powering capabilities can be desirable in various examples to allow for the auxiliary electrical output 540 to be powered via the electrical input 505, when it is undesirable to use power from the battery 305, when the battery 305 is out of power, when the battery 305 is malfunctioning, when the battery 305 is overheating, when power from the electrical input 505 is obtained from a renewable source (e.g., solar), or the like. In some embodiments, the electrical input 505 (e.g., 120 VAC from a wall receptable) provides power to a dedicated, external-facing ‘auxiliary power’ inverter, which can function as a default passthrough for preserving the battery state of charge and avoiding power conversion losses (and the associated noise from fans).

One or more auxiliary electrical output 540 may be integrated into the load source system 300 in a convenient accessible location such as on the front of a stove 125 near the floor, behind a cover on the top of the stove 125, in a reachable location on the back of the stove 125, affixed with a small whip to allow the user to move the outlet to the kitchen counter near to the stove 125, on the top of the stove 125 with a fluids cover, and/or in any suitable location.

The auxiliary electrical output 540 may comprise a NEMA 5-15 or NEMA 5-20 plug in some examples. The auxiliary power port 540 in some examples may provide standardized AC power (e.g., 120 VAC power). DC auxiliary power ports in some alternative form (e.g., a USB port) may additionally or alternatively be included. The auxiliary electrical output 540 can be powered by in some embodiments by a DC battery and may connect to an internal inverter to convert the power from DC to AC.

An auxiliary power port 540 in some embodiments can be ‘full power’ or provide the max available power of 2400 w (nema 5-20) or 1800 w (nema 5-15), or the like. An auxiliary electrical output 540 in some examples can alternatively or dynamically provide less power, such as 1000 w, 500 w or 300 w, or the like.

The auxiliary electrical output 540 in some embodiments may be integrated into the load source system 300 as a passthrough system whereby a device could be plugged in to the auxiliary electrical output 540 and the power may by default be supplied via the AC power input, but then during a power outage or during other suitable situations, the load source system 300 can switch over to providing power via the battery 305.

The load source system 300 in some embodiments can additionally or alternatively include a DC auxiliary electrical output 540. This may provide a DC power rail in some examples. The DC auxiliary electrical output 540 may be used in various ways including to power an additional induction burner in some examples. Such an additional induction burner could be modular and could be placed on a nearby countertop to provide more stovetop capacity while cooking a larger meal. In another variation, a DC auxiliary electrical output 540 may be used to power an external inverter which could be used to provide AC power to a high-power device like an air fryer, a dishwasher, and the like. In some variations, a DC auxiliary electrical output 540 may be used to connect an external battery, which could be used as additional power storage capacity.

Additionally, or alternatively, one or more additional or alternative power inputs may be used as a power source, which may be AC and/or DC. For example, in some embodiments the electrical input 505 can be DC power. In some embodiments, there can be one or more additional DC power inputs in addition to an AC electrical input 505.

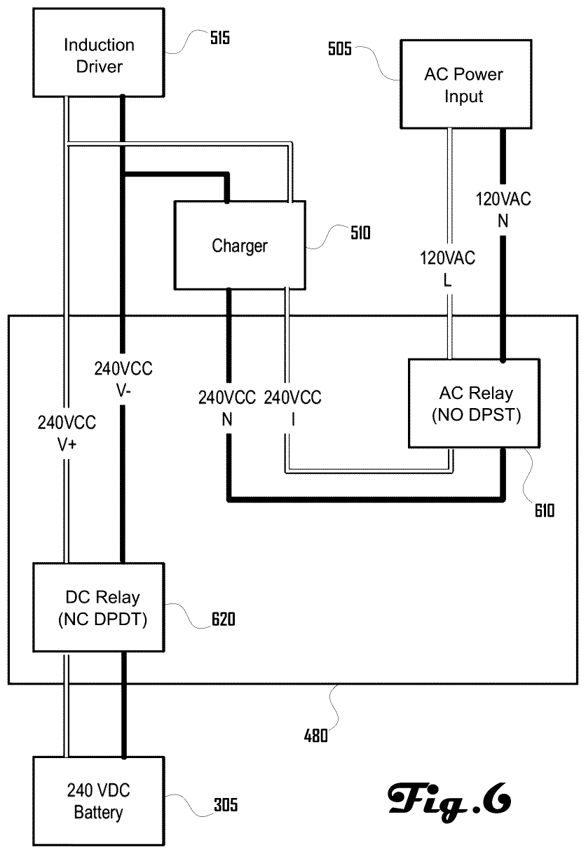

In various embodiments, an AC/DC conversion module 480 (see, e.g., FIG. 4) functions to transform AC power input from electrical input 505 and output DC power to charge the battery 305, induction driver 515, or the like. For example, as shown in the embodiment of FIG. 6, an AC power input may enter an AC/DC conversion module 480 through an AC relay 610 (e.g., normally open (NO) and double-pole, single-throw (DPST)) prior to going to a charger 510. The charger 510 can output a DC signal (e.g., 230 VDC) that may connect to the induction driver 515 and/or to a battery 305 via a DC relay 620 (e.g., normally closed (NC) and double-pole, double-throw (DPDT)).

DC power (e.g., nominally 240 VDC) from the charger 510 may be provided to the battery 305 by way of a safety relay in various examples. Current from the battery 305 can be provided to various elements of the load source system 300 by way of a safety relay and can serve as a source for powering elements such as a processor and/or safety triggers of the load source system 300 by way of a DC/DC regulator.

The AC power input 505 may connect (e.g., with a cord and plug) to an electrical receptacle (e.g., common receptable with 120 VAC 15 A, 20 A, or the like or an appliance outlet with 230 VAC with 20 A, 30 A, 50 A, or the like) to provide outside power to the load source system 300. The AC/DC conversion module 480 can use the AC power input from the power input 505 to charge the battery 305 source, used to charge supplementary load source systems or directly power various systems or elements.

In some variations, the amount of current drawn from the power input 505 may be limited in some embodiments (e.g., through a configuration setting). For example, the limit may be set below 10 A, 15 A, 20 A, 30 A, 50 A, or the like. For example, in a retrofit kitchen, there may be insufficient circuit capacity to operate all appliances at once so a stove 125 having a load source system 300 can be configured to draw less power. For example, a toaster and a microwave might be on the same circuit as a stove 125 having a load source system 300 and the stove 125 can be configured to lower maximum charging rate to facilitate operation of all appliances on the circuit.

In some embodiments, a load source system 300 can include a monitoring system that monitors incoming AC voltage of a shared branch circuit. During times of high use, the voltage can sag, and the load source system 300 can automatically lower charging current of the load source system 300 to accommodate (e.g., to avoid tripping the circuit breaker). Because the sensing and/or control can be part of the load source system 300, techniques like synchronous source detection may be used in some examples to calibrate out differences in grid voltage and for other applications.

An AC/DC conversion module 480 of some embodiments may output a DC power output (e.g., nominally 240 VDC), which as described may be provided to a battery 305 by way of a safety relay in some examples. The charger 510 and/or the battery 305 may be provided to elements of the system load source system 300 by way of a safety relay and may serve in some examples as the main source for powering one or more processors and/or safety triggers by way of a DC/DC regulator.

In some embodiments, DC power may primarily be used to directly power the high-load elements of the load source system 300. In a stovetop embodiment, the load source system 300 can include an induction heating module, which can function to perform induction heating. The induction heating module may include induction coil drives and/or interface with an integrated induction stovetop module. In some cases, the load source system 300 may be configured to interface with an outside or existing heating element. Alternatively, the heating element may be directly integrated and/or customized with the load source system 300.

As discussed, the load source system 300 in various embodiments can include one or more supplementary battery systems, which may be used as a backup to the battery 305. In some variations, such a supplementary battery system may be or include a battery-equipped Uninterruptible Power Supply (UPS); for example, in the event of a grid blackout and/or dead or disabled battery 305, to maintain some level of continuous processor operation (e.g., to continue logging events), the battery-equipped UPS can keep the processor(s) powered.

In order to satisfy a suitable safety standard (e.g., meet UL standards), in some embodiments there may be a series of redundant controls that can independently (e.g., without software) disable/disengage some or all potentially hazardous aspects of the load source system 300; for example, power to the charger 510; the output of high-voltage batteries; some or all connections powered off high-voltage batteries, and the like. Such a control scheme may include thermal fuses, current fuses, insulation fault detectors, or some combination thereof, whereby one tripped fuse can disconnect the trigger signal to the normally controlled relays that control the pathways and/or subsystems. Temperature fuses in some examples may be configured to trip/trigger at determined temperature points and may be oriented inside or near an oven, stovetop, and high-voltage battery. Current fuses may be integrated inside the battery 305 (e.g., integral to a battery management system (BMS)). Additional safety measures may include Ground Fault Protection between the one or both terminals of a DC signal (e.g., 240 VDC) and the systems chassis (e.g., range chassis), and a Ground Fault Protection between an auxiliary AC power outlet 540 and the chassis of the range.

Some variations of a load source system 300 and/or a method implemented by a load source system 300 can be configured to boost preheating capabilities of an oven or other heating element, and the like. The load source system 300 may be configured to implement process of a method that includes using the battery 305 to provide high instantaneous power output. This may be used to enable a “boost” mode for use during preheating or in other situations. Some convection ovens can utilize a rear convection element (e.g., positioned around a fan) and a top element which can principally be used for broiling. A broiling element may be used to boost the power of the oven during preheating in some examples. This may be performed in some embodiments when no food is in the oven to avoid burning of the food. Because a battery enabled stove of various embodiments can output higher instantaneous power than a conventional wired stove, this boost mode can be made to be quite powerful. In one example, a time of 5 minutes could be sufficient to preheat to 400 degrees Fahrenheit during such a boost mode, which could, for example, be two to three times as fast as a conventional preheating cycle.

In some embodiments, instead of using a power inverter to create AC power for a conventional oven fan (e.g., driven by a shaded pole motor) and/or oven light, DC-driven versions of an oven fan and/or oven light may be used. In some such variations, the driving circuitry can rely on a DC-DC converter, which may be smaller and cheaper. These DC fans and/or lights may use proportional control, which in the case of the fan, can be used to modulate airflow, limit noise, create more even oven temperatures without convection baking the food. In the case of the light, a light can create softer lighting conditions, or be used to communicate information to the user, such as whether the oven is preheated, or if the food is done cooking.

Some variations of the load source system 300 and/or a method implemented by the load source system 300 may be configured to reduce or eliminate undesirable audible and tactile artifacts associated with AC's low-frequency envelope imposed on the generated electromagnetic field. In some induction systems driven by an AC signal, the envelope of an AC signal (e.g., 60 Hz, 120 Hz) can drive the induction system which can be both felt (vibrations) and heard. The load source system 300 and/or method implemented by the load source system 300 can use the DC signal which has a flat envelope such that the electromagnetic effects causing audible or tactile vibrations can be eliminated or reduced.

The use of a DC input in some examples can reduce the size of components used in driving an induction heating system. In AC-driven induction systems, bulky ripple capacitors may be used which are both expensive and large. Ripple capacitors can also reduce the overall efficiency of the circuit and reduce the power factor. Some AC-driven systems can require a PFC circuit and/or EMI/RFI circuits, which may be eliminated or simplified in the system when powering from a line-isolated DC battery. The system's DC input to an induction system, avoiding the need for such components, may result in a more energy efficient load source system 300 in some embodiments.

In some variations, the load source system 300 may include cascaded DC and AC relays. The load source system 300 may include a single DC relay to control a plurality of AC relays in some examples. By using a DC relay to switch first, in some embodiments the AC relays can be switched in a dry state to minimize or reduce contact arcing issues that can be associated with AC relays. This may also help to prolong the life of the contacts and reduce maintenance costs. Additionally, a single DC relay can be used to control multiple AC relays, which can simplify the wiring and control systems, and reduce the overall cost of the load source system 300.

In some variations, a DC powered approach of the load source system 300 or method implemented by the load source system 300 may enable usage of Metal-Oxide-Semiconductor Field-Effect Transistors (MOSFETs) to switch power to high powered loads. For example, MOSFETs may be used to switch 230 VDC 20 A power to an oven bake/broil heating element in some embodiments. MOSFETs may have increased switching life over other switching elements that can be used in AC operated ovens. This may result in increased life, easier maintenance, and/or more accurate temperature control because of an ability to rapidly switch between power states. As one potential benefit, a system variation using FET control with faster cycling may provide more latitude to control when each of the oven elements is on, to coordinate the power draw of each in order to limit the total power draw of the stove 125.

In some variations, the load source system 300 may include a maximum power point tracker (MPPT) which may function to enable the load source system 300 to accept power generated locally by a solar panel, wind turbine, or other source of power generation. This solar powered solution may be more generally applied as part of a general energy storage equipped (ESE) appliance, which may be a range stove 125 as described herein but could be any suitable type of appliance. In some variations, the ESE could be a water heater or heat pump or other suitable load source 200 as described herein.

In one example, energy can be generated by a solar panel, and pass through the MPPT into the battery 305 of the ESE appliance. This energy in various embodiments can augment power received from a receptacle 165 to the ESE appliance and can limit the total amount of power drawn from a home's power distribution system 150 by the ESE appliance. In some variations, the load source system 300 may be configured to avoid “backfeeding” of the home's electrical system or the grid, which may mean this kind of installation can take place without permission of a utility in some examples, thereby leading to simplified installation.

In some variations, the load source system 300 can include an interface subsystem to facilitate interfacing with an induction driver 515 (see FIG. 5). Interfacing with an induction driver 515 may enable the load source system 300 to be used with existing induction drivers 515 provided by other outside load source system 300. An interface subsystem may be configured to enable a process that when performed causes creating a DC current measurement and feeding the DC current measurement to a driver and synthesizing 120 Hz signal (or other suitable frequency). This solution may be internationally deployable by adapting the frequency to any desirable frequency.

In order to make an existing, traditionally AC-powered induction driver 515 work off a DC voltage (e.g., power from the battery 305), the induction driver 515 can be augmented with a controller that provides synthesized AC signals to it that satisfy a variety of conditions it may need met in order to operate. For example, an induction driver 515 may regularly measure the amplitude and/or frequency of the input power signal to ensure that components of the induction driver 515 can properly operate or synchronize off this signal (e.g., to improve power factor by switching at the signal's zero-crossing) or that such a signal is being cleanly powered and will not propagate as radiated noise or that the signal is electrically safe to pass through. Because the induction driver 515 is being powered off DC in various embodiments, the variability of an AC signal may no longer be relevant. Thus, the operation of the induction driver 515 can become geographically agnostic and can be deployed anywhere without special SKUs.

In one variation, a load source system 300 and/or method implemented by the load source system 300 may include a slow preheat/capped burner power mode, which can function to preserve energy stored by the battery 305. A control system may be used to manage operations of the device to adjust for stored power availability, predicted power availability from an AC power input 505 or some other power source in coordination with predicted usage of the appliance (e.g., time of day, cooking habits, etc.). In some embodiments, a load source system 300 and/or method implemented by the load source system 300 may use time and/or usage-based charging profiles. Charging of the auxiliary power source and appliance heating capabilities may be adjusted to meet expected requirements. Some examples of such methods are disclosed in related U.S. patent application Ser. No. 17/692,714, filed Mar. 11, 2022, entitled “APPLIANCE LEVEL BATTERY-BASED ENERGY STORAGE,” which is incorporated herein by reference.

In another variation, a load source system 300 and/or method implemented by the load source system 300 may include detecting circuit breaker (for shared branch circuit) overdraw by measuring voltage sag from wall. In another variation, a load source system 300 and/or method implemented by the load source system 300 may use special heating modes. For example, a load source system 300 and/or method implemented by the load source system 300 may include anti-warping heating profiles for pans, which may function as a gentle mode to prevent distortions or deterioration of cookware.

In another variation, a load source system 300 and/or method implemented by the load source system 300 may operate to manage power storage of the battery 305 based on external data sources. In one such example, the load source system 300 may charge the battery 305 when emissions intensity is below a threshold, based on external data.

In another variation, a load source system 300 and/or method implemented by the load source system 300 may use an alternative heating approach to mitigate heating of a battery 305. For example, a load source system 300 and/or method implemented by the load source system 300 may use an upper oven element to assist a convection element so that lower element is not needed or used less, which may mitigate heating of a battery 305 stored below the oven.

In another variation, a load source system 300 and/or method implemented by the load source system 300 may use various sensing approaches. A load source system 300 and/or method implemented by the load source system 300 may use multi-probe oven chamber sensing. This may involve sensing and detecting uniformity of heat, and if a large enough temperature difference is detected, the load source system 300 can run convection fan for air mixing. A load source system 300 and/or method implemented by the load source system 300 may additionally include detecting operation of an oven fan (e.g., detecting a broken oven fan) and/or controlling the fan for augmented cooking.

In some variations, the load source system 300 may integrate the battery 305 into the load source system 300 in particular locations for enhanced usability and functionality. The location of the battery 305 in residential ranges for an enhanced induction range system can be desirable to ensure the efficient and safe operation of a range. One first variation can be to place the battery below the oven, within a defined cavity (e.g., where a range warming drawer may be located). In some variations, the battery 305 may be physically integrated into a warming drawer. In some variations, a battery 305 may replace a warming drawer in the appliance, or simply be below the oven. This location in various embodiments can provide access to cool air (e.g., due to a natural thermocline of the room) on the floor. The air may be utilized either passively or through forced convection to cool the battery 305 without having to pipe the air around the stove.

Additionally, having the battery 305 as low as possible or as close to the ground as possible can provide mechanical stability, acting as a counterweight to prevent the stove from falling over when the oven door is open. The battery 305 can transfer the weight directly onto the ground through feet attached to the stove or through the feet of the stove, minimizing the amount of material required to transfer the weight to the ground. Alternatively, weights (e.g., cement blocks or other counterweights) may be mounted or installed at the base of the stove. Additionally or alternatively, the load source system 300 may be mounted or fixed in position using brackets and screws.

Another variation can be to place a flat battery pack behind the stove, utilizing the space behind the stove. This location can provide a compact design of the stove, can enhance the aesthetic appeal of the stove and may not interfere with the operation of the stove. Depending on the specific design and dimensions of the enhanced induction or electric stove system, other locations can also be suitable for placing the battery.

In some variations, the load source system 300 may include battery fixturing that may facilitate moving or accessing a battery 305. This may be useful to enable cleaning, maintenance, and the like. The battery 305 may include feet of a material with low resistance (e.g., Delrin, Teflon, etc.) to enable the battery 305 to slide without loading attachment points to the stove 125. In another variation, the battery 305 may be attached to the stove 125 but have rolling feet. The load source system 300 in some examples may include design features to facilitate installation and servicing accessibility. The battery 305 and/or associated components may use connectors and fixturing mechanisms for ease of connecting power plugs and accessing the components of the battery 305 and/or associated components.

The battery 305 may be a detachable unit in some examples, which may enable the battery 305 to be supplied separately. This may be useful to allow for changing of a battery 305 and installation of the battery 305 into a previously set up appliance, swapping of a battery 305, or the like.

The battery 305 in various embodiments may include safety features to ensure that the battery 305 is used when the battery 305 is properly installed and in a safe operating condition. A battery control system that may be part of an auxiliary power source system may measure and record the state of the battery 305 through one or more sensors, which may include but is not limited to accelerometers, switches, thermometers, and the like.

In some variations, the battery 305 may include a protective casing or layer, which can be a component encasing the battery 305 in a protective material to ensure protection from fire. This may be designed to provide the battery 305 with at least 60 minutes or at least 120 minutes of protection in a building fire, or the like. For example, gypsum or similar fire retardant or phase-change material may be used. The load source system 300 in some embodiments may include a battery cooling system which in some examples can be a special cooling fan that activates only when needed to cool battery/oven interface.

A load source system 300 and/or method implemented by the load source system 300 may include an integrated safety system for addressing possible electrical safety issues. In the case of a cooking range, possible issues that may be mitigated can include detection of an oven over-temperature event, detection of a battery over-temperature event, and detection of an electrical hazard (e.g., insulation fault, incorrect installation, damaged battery, DC isolation fault, AC hazard, and the like).

In some embodiments, a method of safety system activation can comprise a determination that there is an oven over-temperature event present, that a battery over-temperature event is present, or that an electrical hazard event is present (e.g., by a control system 480 based on data from one or more sensors 490). In response, a safety system (e.g., safety circuit) can cause a suitable response, which can include a battery cut-out, a charger cut-out, grounding, ground fault circuit interruption (CFCI), and the like. In various examples, an over-temperature event can be determined based at least in part on data or physical response from a temperature sensor indicating a temperature above a given threshold for an amount of time.

In some embodiments, a safety system may enable safe operation of a battery electric range, with the battery 305 in close proximity to the oven 360 and/or cooktop 370. In some examples, over-temperature of the battery 305 can cut off the oven 360, and over-temperature of the oven 360 can cut off the battery 305, to ensure both are operating safely. Similar methods can be applied to other appliances or elements of a range or stove 125.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

In some examples, a string of over-temperature cut-offs can be associated with various heat sources generally or specifically such as the battery 305, oven 360, cooktop 370, heating zones 372, and the like. In some embodiments such a string may have redundant over-temperature cutoffs for some or all such heat source locations. In some embodiments, two or more independent strings can have just one over-temperature cut-off at some or all such heat source locations. Various suitable sensors can be used for sensing temperature and generating an over-temperature cut-off response including thermal fuses, thermostats, thermocouples, thermistors, PTC (Positive Temperature Coefficient) devices, RTDs (Resistance Temperature Detectors), bimetallic switches, IC temperature sensors, thermal cut-out switches, and the like.

Redundant relays in some embodiments can be configured to stop some or all heating of the load source system 300 by cutting off the battery 305 and/or by cutting off the charger 510, or the like. Such a cutoff can be configured to de-power the oven 360, cooktop 370, heating zones 372, or other elements, including heat sources and non-heat sources. In some embodiments, at least some non-heat sources can remain active after such a cutoff such as an interface 380, 460 screen 384, processor 410, control system 440, communication system 450, auxiliary electrical output 540, and the like.

In some embodiments, the same or different cut-off relays can be configured to respond to electrical hazards, such as electrical hazards posed by insulation, isolation faults of the battery system, and the like. In some embodiments, a sensor string can have additional sensors or relays as part of the sensor string, which can be configured to open when an electrical fault is detected, thus triggering power cut-off relays.

In some embodiments, relays that perform a battery cut-off can be disposed within a battery enclosure, and in some examples can be configured to perform a safety function of preventing the battery from energizing unless it is correctly installed into the product (e.g., in an embodiment where the battery is removable). For example, in some embodiments, a string of sensors cannot be completed without the battery 305 correctly installed into the load source system 300, such that with a battery 305 not installed or incorrectly installed (e.g., battery connections improperly or incompletely seated), cut-off relays disabling battery power cannot turn on unless the battery 305 is installed into the load source system 300.

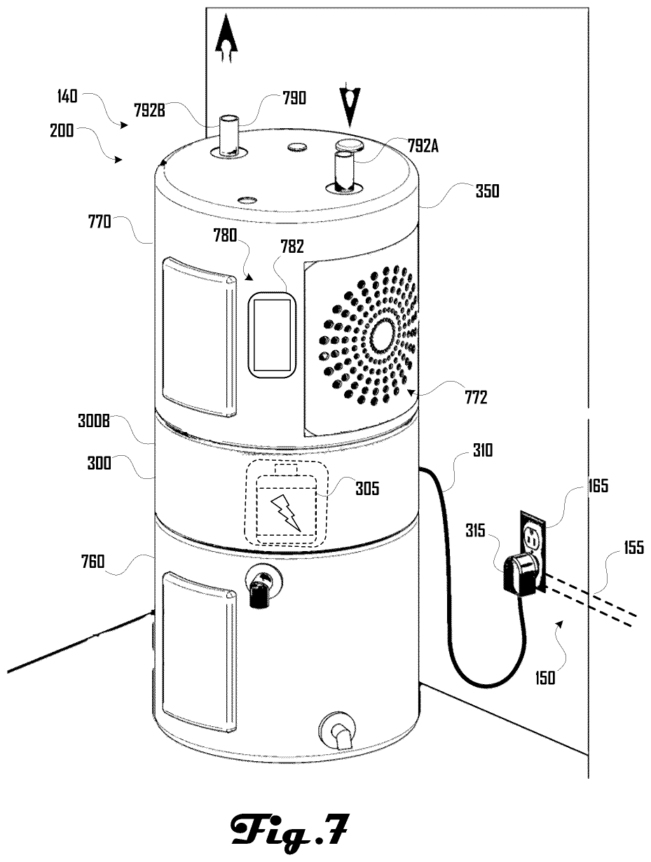

FIG. 7 illustrates an example of a water heater 140 load source 200 that comprises an embodiment 300B of a load source system 300 having a battery 305. For example, the load source system 300B can be an internal component of the water heater 140, an integral component of the water heater 140, disposed within a housing of the water heater 140, or the like. For example, in some embodiments, a portion of the load source system 300A and/or battery 305 can be an integral part of the water heater 140 such that such portions cannot be removed or easily removed from the water heater 140, which can include, in some examples, such portions being enclosed within a housing of the water heater 140 so that such portions are not accessible externally to users. However, in some examples, the battery 305 can be removable, replaceable, and/or modular as discussed herein.

As shown in FIG. 7, the water heater 140 can comprise a power cord 310 with a plug 315 configured to couple with an electrical power receptacle 165 of a power distribution system 150. For example, the power distribution system 150 can provide power to the receptacle 165 via power lines 155, where the receptacle 165 is disposed on a wall of a building 105 (FIG. 1) with power lines 155 running though the wall, or the like. The water heater 140 can plug into the receptacle 165 which can provide electrical power to the water heater 140 and the battery 305 of the load source system 300, which can be configured to store electrical power and/or provide electrical power to the water heater 140 as discussed herein.

In various embodiments, the water heater 140 can comprise a housing 350, a water tank 760, a heat pump 770 having one or more fans 772 a water heater interface 780 having a screen 782, and plumbing 790 that comprises a water in-line 792A and a water out-line 792B. As discussed herein in more detail, various elements can be a part of or associated with the load source system 300, such as heating elements of a load source system 300 being configured to generate heat in a volume of water in the water tank 760. In various embodiments, the water heater 140 can be a heat pump water heater that includes a heat pump 770; however, in further embodiments a water heater 140 can be any suitable type of water heater 140, which may or may not include a heat pump 770, such as a heat exchanger water heater, an electric resistance water heater (e.g., Electric Storage Element (ESE)), heat pump water heater, tankless water heater (e.g., on-demand or instantaneous water heater), or the like.

In one preferred embodiment, a water heater 140 has a water tank 760 with 30 gallon capacity. Further embodiments can include a water tank 760 with a capacity of 5, 10, 15, 20, 25, 30, 35, 40, 45, 50, 55, 60, 65, 70, 75, 80, 85, 90 gallons, or the like, or a range between such example values. However, in some embodiments, a water tank 760 can be absent.

In various embodiments, a heat pump 770 of a heat pump water heater 140 transfers heat from the surrounding air to the water in the tank 760, which in some examples can make a heat pump water heater (HPWH) more energy-efficient than an electric resistance water heater. A heat pump water heater 140 can comprise an evaporator comprising a coil of tubing with refrigerant inside, and as warm air from the surrounding environment is drawn over the evaporator, the refrigerant can absorb heat and evaporate into a gas. A heat pump water heater 140 can further comprise a compressor that pressurizes the gaseous refrigerant, which can cause temperature of the gaseous refrigerant to rise significantly. A heat pump water heater 140 can further comprise a condenser comprising another coil, that in various examples can be wrapped around the water tank 760 or placed inside the water tank 760. The hot, pressurized refrigerant can flow through the condenser, transferring heat from the pressurized refrigerant to water in the water tank 760.

After the refrigerant has cooled by transferring heat from the refrigerant to the water, the refrigerant can pass through an expansion valve that causes sudden expansion of the refrigerant, which in turn causes the refrigerant to cool rapidly, preparing it to absorb heat again in the evaporator. A fan 772 can be configured to draw air over the evaporator coil to facilitate heat absorption.

The heat pump 770 in various embodiments can operate in a cycle within the heat pump water heater 140, which can include a thermostat detecting that a temperature of water within the water tank 760 has dropped below the set point. The fan 772 can activate, drawing warm air over the evaporator. The refrigerant in the evaporator can absorb heat from this air and can evaporate. The compressor can then pressurize this gas, raising the temperature of the gas further. This hot, high-pressure gas can move to the condenser, where the high-pressure gas transfers heat of the high-pressure gas to the water in the water tank 760. As the refrigerant cools, the refrigerant can condense back into a liquid and then passes through the expansion valve, which rapidly cool the refrigerant before returning to the evaporator to begin the cycle again. This process continues until the water in the water tank 760 is determined to have reached a desired temperature. However, it should be clear that in further embodiments a heat pump 770 can be absent or a heat pump 770, or the like, can include any suitable elements, so the present examples should not be construed as being limiting.

In some embodiments, one or more batteries 305 and/or load source systems 300 can be integrated into a load source 200 (e.g., into an appliance housing) at the factory where the load source is manufactured or can be integrated into a load source aftermarket. For example, load sources 200 (e.g., appliances) can be specifically designed to allow integration of the appropriate quantity of batteries 305 and/or other elements of a load source system 300 within their normal housing. This can allow for such load sources 200 or appliances to be placed within a residence without any change to how they are integrated into standardized fixturing. In various embodiments, electrical connections to batteries 305 and/or other elements of a load source system 300 are made in the factory and fully integrated into the appliance circuit. This can allow for load sources 200 such as appliances that utilize DC current (e.g., a water heater 140) to pull power directly from the one or more batteries 305 without the added cost of a high-power inverter.

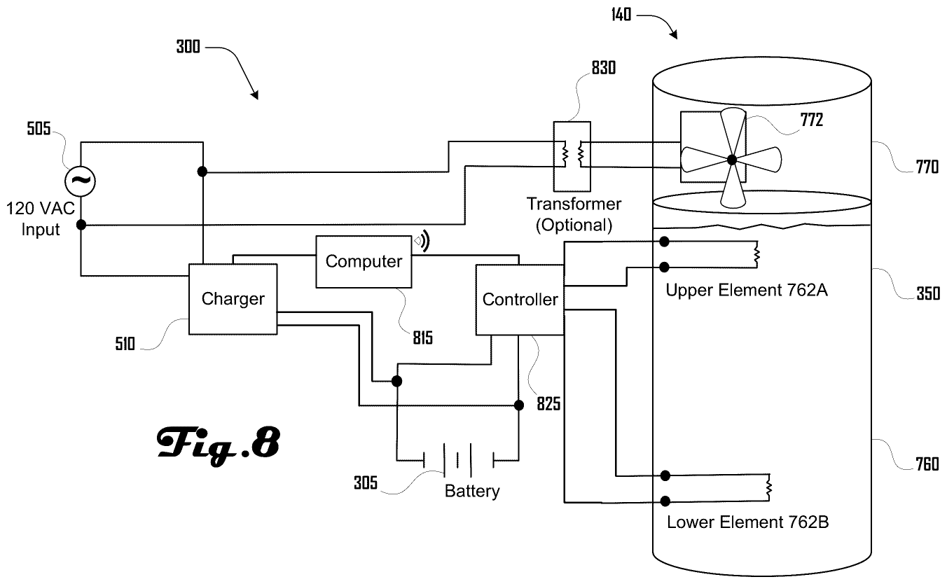

Turning to FIG. 8, another example embodiment of a load source system 300 is illustrated, which comprises an electrical input 505, a charger 510, a computer 815, a battery 305, a controller 825, and a transformer 830. The load source system 300 can further comprise a water heater 140 comprising a water tank 760 having an upper and lower element 762A, 762B and a heat pump 770 that includes a fan 772.

In various embodiments, the electrical input 505 can comprise a power cord 310 with a plug 315 configured to couple with an electrical power receptacle 165 of a power distribution system 150 (see, e.g., FIG. 7); however, various suitable elements can be part of an electrical input 505 and such an electrical input 505 can be via a direct-wire connection in various examples as discussed herein. In various embodiments, the electrical input 505 can be an AC power input that functions to provide a main source of power that can be used to charge and/or power elements of the load source system 300. The electrical input 505 may be used to power and charge an auxiliary power source or other power storage systems such as the battery 305 and/or power other elements such as a processor 410, memory 420, clock 430, control system 440, communication system 450, interface 460 (see, e.g., FIG. 4), or the like. In some examples, an AC power input of the electrical input 505 may be a 120 VAC (and/or 240 VAC) from a wall outlet (e.g., standard 15 A outlet).

In various embodiments, the charger 510 can comprise a power converter or a battery charger that manages a flow of electrical energy from the electrical input 505 to the battery 305, computer 815, controller 825, transformer 830, heat pump 770, water tank 760, heating elements 762A, 762B, or the like. For example, in some embodiments, the charger 510 can convert an AC voltage (e.g., 120 VAC or 240 VAC) from a wall outlet into a suitable DC voltage required to charge the battery 305, which can involve rectification (converting AC to DC) and regulation (ensuring the DC output is stable and suitable for the battery). In some examples, an AC/DC regulator in an AC/DC conversion module of the charger 510 may be used to transform the power input from the electrical input 505. The charger 510 in various embodiments can monitor and control the charging process of the battery 305 to ensure it is charged efficiently and safely, preventing overcharging or overheating, and can manage the charging current and voltage according to the specifications of the battery 305.

In various embodiments, the charger 510 and/or battery 305 can supply DC power to one or more of the computer 815, controller 825, transformer 830, heat pump 770, water tank 760, heating elements 762A, 762B, or the like. For example, in various embodiments, one or more of such elements can be configured to be powered only by the charger 510; powered only by the battery 305; and/or powered by both the charger 510 and the battery 305 at the same time. As discussed herein, such powering capabilities can be desirable in various examples to allow for operation of the water heater 140 or portions thereof via power from the battery 305 while power from the electrical input 505 is unavailable or undesirable such as when there is a power outage or when power obtained from the electrical input 505 is undesirably expensive (e.g., when such power obtained from a power grid is expensive). Such powering capabilities can be desirable in various examples to allow for a combination of power from the electrical input 505 and battery 305 to be used, which can allow for greater power to heating elements 762, water tank 760, or the like, than would be available from the electrical input 505 alone, which can allow a water heater 140 to perform near, at, or above the capability of a water heater 140 powered by 240 VAC, even though the water heater 140 is powered by only 120 VAC via the electrical input 505. Such powering capabilities can be desirable in various examples to allow for a combination of power from the electrical input 505 and battery 305 to be used, which can allow for a reduced amount of power consumed from the electrical input 505, which may be desirable when power obtained from the electrical input 505 is unstable, inconsistent, or undesirably expensive (e.g., when such power obtained from a power grid is expensive) or when it is desirable to draw less power from the electrical input 505 (e.g., where a circuit does not support drawing full power because of other appliances on the circuit). Such powering capabilities can be desirable in various examples to allow for one or more of the computer 815, controller 825, transformer 830, heat pump 770, water tank 760, heating elements 762A, 762B, or the like to be powered via the electrical input 505, when it is undesirable to use power from the battery 305, when the battery 305 is out of power, when the battery 305 is malfunctioning, when the battery 305 is overheating, when power from the electrical input 505 is obtained from a renewable source (e.g., solar), or the like. As discussed herein, various additional and/or alternative elements can be powered via DC power from the charger 510 and/or battery 305, so the example elements discussed herein should not be construed to be limiting.

For example, the load source system 300 may additionally or alternatively power status indicators (e.g., LEDs, displays, audio systems), user interface displays, external-facing USB ports (and their devices), speakers, externally daisy-chained high-voltage DC devices, and the like. Some of these elements may require a DC/DC regulator or a DC/AC inverter downstream (e.g., of a battery's 240 VDC) in order to operate. Some of these elements may be enabled via manual control, while others may be enabled via autonomous software control (e.g., via the control system 440).

In various embodiments the computing device 815 can be configured to implement methods discussed herein (e.g., for energy efficiency, learn usage patterns, or adjust heating based on time-of-use electricity rates) via elements such as a processor 410, memory 420 and the like. The computing device 815 in various embodiments can comprise a communication system 440 which may allow the computing device to connect to the internet, allow remote control, remote monitoring, integration with smart home systems, and the like. The communication system can operate via Wi-Fi, LTE, or the like. The computer in various embodiments can obtain data and/or input form various sources such as an interface 460, one or more sensors 490, or the like.

In various embodiments, the controller 825, can be configured to operate the heating elements 762A, 762B of the water tank 760. In some embodiments, the controller 825 can comprise a thermostat to measure water temperature within the water tank 760, safety mechanisms (e.g., thermal cutoffs), elements to maintain water temperature within a set range by activating or deactivating the heating elements 762 as needed, and the like.

In various embodiments, the transformer 830 can be configured to transfer electrical energy between two or more circuits through electromagnetic induction (e.g., the electrical input 505 and heat pump 760). The transformer 830 in various embodiments can operate with alternating current (AC) and can be used primarily to change the voltage level of the current flowing through it. For example, transformation of voltage can be achieved in various examples without altering the frequency of the AC, which allows for either an increase (step-up) or decrease (step-down) in voltage depending on what is desired or necessary. In some embodiments, the transformer 830 can be absent from a load source system 300.

Additionally, or alternatively, one or more additional or alternative power inputs may be used as a power source, which may be AC and/or DC. For example, in some embodiments the electrical input 505 can be DC power. In some embodiments, there can be one or more additional DC power inputs in addition to an AC electrical input 505.

DC power (e.g., nominally 240 VDC) from the charger 510 may be provided to the battery 305 by way of a safety relay in various examples. Current from the battery 305 can be provided to various elements of the load source system 300 by way of a safety relay and can serve as a source for powering elements such as a processor and/or safety triggers of the load source system 300 by way of a DC/DC regulator, or the like.

The AC power input 505 may connect (e.g., with a cord and plug) to an electrical receptacle (e.g., common receptable with 120 VAC 15 A, 20 A, or the like or an appliance outlet with 230 VAC with 20 A, 30 A, 50 A, or the like) to provide outside power to the load source system 300. In some embodiments, an AC/DC conversion module can use the AC power input from the power input 505 to charge the battery 305 source, used to charge supplementary battery systems or directly power various systems or elements.

In some variations, the amount of current drawn from the power input 505 may be limited in some embodiments (e.g., through a configuration setting). For example, the limit may be set below 10 A, 15 A, 20 A, 30 A, 50 A, or the like. For example, where a water heater 140 is located with other appliances, there may be insufficient circuit capacity to operate all appliances at once so a water heater 140 having a load source system 300 can be configured to draw less power. For example, a washer and drier might be on the same circuit as a water heater 140 having a load source system 300 and the water heater 140 can be configured to a lower maximum charging rate to facilitate operation of all appliances on the circuit.

In some embodiments, one or more safety-related features for a load source 200 can be integrated in the structure and design of the load source 200 itself. This can include eliminating or reducing the chance of a safety issue arising, limiting the severity of a safety issue that occurs or cannot be avoided, or the like.

With respect to the physical design of an enclosure of a battery 305 of various embodiments, there can be various suitable ways to avoid risk of battery fires, the severity of a battery fire, potential for human exposure to high voltages and the exposure of a battery 305 (e.g., battery cells) to moisture, humidity and the like. For example, some embodiments can include a configuration of a load source 200 where the battery 305 is disposed within the load source 200 close to the ground, and the battery 305 or enclosure thereof can be designed as a “bucket” or “tub” shape making water ingress into or about the battery 305 less likely or impossible if there is moisture or liquid on the ground. For example, in some scenarios one might use a mop to clean the floor surrounding the load source 200 or where there may be a liquid spill near a load source 200 this can be an important feature (e.g., a stove 125 in a kitchen that may be mopped or where cooking spills can occur).

An enclosure of a battery 305 in some embodiments can be sealed with a pressure relief vent or breather valve to allow for the expected expansion and/or contraction of the battery 305 (e.g., battery cells) while the battery 305 is in use. This way, in some examples the battery 305 can be shielded from excessive moisture or liquid without having problems with pressure differentials or escape of gasses during (e.g., abnormal) venting of the battery 305.

In some embodiments of load sources 200 with liquid transportation systems such as a water heater 140, such liquid flow can be diverted or directed to cool the battery 305 and that heat transfer can be configured to preheat the water in some examples, requiring less additional energy to bring the liquid to a desired temperature set point. For example, a method of water heat exchange can include obtaining cold water from a water in-line 792A (e.g., from a residential water utility source), directing the water to the battery 305 such that the battery 305 is cooled by the cold water and heat is transferred to the water.

For example, a water-cooled battery system can work by circulating coolant (e.g., water) through or around the battery 305 to absorb heat generated during operation of the battery 305. Such a cooling mechanism can be desirable for maintaining optimal battery temperature and preventing overheating, which can degrade performance or damage the battery 305. A battery in some examples can be structured with cooling channels integrated within or adjacent to the battery 305 (e.g., one or more battery cells). These channels can allow cold water (e.g., from a water in-line 792A) to flow through the channels to draw heat away from the battery 305. Some embodiments can comprise metal plates or cooling fins in contact with the battery 305 or cells of the battery 305, through which water can flow, maximizing surface contact to efficiently absorb and transfer heat.

The water can absorb thermal energy from the battery 305, becoming hotter as it passes through the battery 305, and can then be directed out of the battery 305 to a water tank 760 to provide the water tank 760 with at least preheated water; to a radiator or heater exchanger 770 where the heat can be dissipated in some examples, or the like.

Some embodiments can include a thermal management system that can actively monitor the temperature of the battery 305 and/or water tank 760, adjusting the flow of water based on real-time thermal data associated with the battery 305, water tank 760, or the like. For example, where a determination is made that the battery is above a temperature threshold, water (e.g., from a water in-line 792A) can be actively directed to the battery 305 (e.g., via actuating a valve) to cool the battery 305. In another example, where water is being heated by a battery 305 and a determination is made that the temperature of water within a water tank 760 is below a threshold temperature, the heated water from the battery 305 can be actively directed to the water tank 760 from battery 305 (e.g., via actuating a valve) to heat or provide heated water to the water tank 760. In some embodiments, where water is being heated by a battery 305 and a determination is made that water heated by the battery is not needed or desirable for a heating purpose (e.g., to heat or provide heated water to the water tank 760), the heated water from the battery 305 can be actively directed to a heat exchanger 770 (e.g., via actuating a valve) where heat from the water can be dissipated into the environment. In various embodiments, such determination can be made by a computer 815, control system 440, controller 825, via a processor 410, a load source system 300, or the like. Such a method can be desirable for maintaining proper temperature of elements of a load source 200 such as water in a water tank 760, a battery 305, a computer 815, a control system 440, a controller 825, a processor 410, a load source system 300, or the like.

While various embodiments can use a liquid coolant such as water to cool a battery 305, in some embodiments an air moving system such as air handling circuit can be routed or re-routed to run cold air in through the battery 305 (e.g., before being sent to a destination, expelled, or the like). Accordingly, in some embodiments, the methods discussed above can be applied to any suitable fluid for cooling of a battery 305, heating of various elements, or the like.

Some embodiments of load sources 200, such as appliances, can have a sheet metal chassis, housing, physical superstructure, or the like. Such a structure in various examples can be made from a thermally conductive material that can be coupled to the battery 305 as a heatsink. In some examples, having the battery rigidly attached to a mechanical superstructure can strengthen the mechanical structure and replace or reduce the number of structural components of a load source.

In some embodiments, such a structure can be made from materials like aluminum, copper, or other suitable material that has high thermal conductivity. Such materials can absorb heat generated by the battery 305 during operation and distribute the heat across the chassis or housing, preventing the battery 305 from overheating and improving overall thermal management of the load source 200.

In one example, a chassis can comprise fins or ridges integrated into the chassis to increase the surface area, maximizing heat dissipation. As the battery 305 heats up during use, the heat can transfer from the battery 305 into the conductive metal housing. The heat can then be dispersed through the metal structure and transferred into the surrounding air and/or integrated with a cooling system (e.g., a water or air cooling system discussed herein), to provide for thermal regulation. Such approaches can allow the battery 305 in various embodiments to remain at a safe operational temperature, improving performance and longevity. Some embodiments can include thermal interface materials (TIMs), such as thermally conductive paste or pads, positioned between the battery 305 and a thermally conductive structure to provide for efficient heat transfer. By coupling the battery 305 to a thermally conductive housing, various examples of such a system can reduce the need for dedicated cooling components, simplifying design and potentially lowering costs while maintaining safe battery temperatures.

Fire-retardant materials such as gypsum-board, sheet-rock, or the like can be used in enclosure walls of a battery 305 in some embodiments, in order to increase the degree of fire resistance of the battery 305, to provide a specified number of minutes or amount of fire resistance against external fires such as a home fire, or the like.

For large and/or heavy household objects, in various embodiments it can be desirable or required have a low center of gravity or be physically tied to a wall to avoid a tipping hazard. Some examples of a stove 125 or other load source 200 can comprise the battery 305 at the very bottom of the load source 200, which may be desirable to lower the center of gravity sufficiently so as not to require an additional mechanical tie in to the ground or surrounding structure. This placement choice can be present in some embodiments of a water heater and/or an HVAC system. In some embodiments, a battery 305 can be disposed within a load source 200 such that it is less than or equal to 12, 10, 8, 6, 5, 4, 3, 2, 1, 0.5, 0.25 inches from the ground, or the like, or a range between such example values.

In some examples the location of the center of gravity of a load source 200 can be measured as the height from the ground to the center of mass of the load source 200. In some embodiments, a load source 200 such as a stove 125 can have a center of gravity of 5, 6, 7, 8, 9, 10, 15, 20, 25 inches from the ground, or the like or a range between such example values. The ratio of the height of the load source 200 (e.g., stove 125) to the height of the center of gravity of the load source 200 in some embodiments can be 0.1, 0.15, 0.2, 0.25, 0.3, 0.35, 0.4 or the like. By keeping the center of gravity lower, the load source 200 can be more stable in various examples, allowing the load source 200 to better withstand tipping forces and providing a safer design, a design that confirms with certain tipping regulations, or the like.

In various embodiments, a battery 305 that operates in a load source 200 can use voltages that can be dangerous to users (e.g., humans) if touched. In addition to the voltage there can be a significant amount of current that can be sourced rapidly in some embodiments. One solution to reduce the potential for shock hazard at the time of installation or removal of the battery 305 in some examples can be that the appliance has a mechanical backplane deep in the chassis or housing that includes pluggable battery connections. The battery installer in some such examples simply slides the battery 305 in the chassis of the load source 200 and secures the battery 305 against the backplane to establish an electrical connection between the battery 305 and load source system 300 of the load source 200.

Pluggable battery connections can include a system where the battery 305 can easily be inserted or removed from the load source 200 without requiring complex wiring or manual electrical connections. For example, the backplane in the chassis of the load source 200 can comprise connectors or terminals in some embodiments that align with corresponding connections on the battery 305. When the battery 305 is slid into place, such connectors automatically engage, allowing the battery 305 to deliver power to the load source system 300 without the user needing to touch or manipulate any wires directly. In various examples, this not only simplifies installation but also reduces the risk of electric shock by preventing exposure to live electrical contacts.

In one example, the backplane can have spring-loaded or compression-type contacts that make a secure electrical connection when the battery 305 is pushed into place. Another example can include a connector where the battery 305 has dedicated prongs or terminals that fit into sockets embedded in the chassis of the load source 200. The use of keyed connectors, which only allow the battery 305 to be inserted in a correct orientation, can improve safety and ease of use in some embodiments.

Pluggable connections in some embodiments can comprise industrial-grade connectors, such as modular power connectors, quick-connect power terminals, connectors or the like, which can be designed for high-current applications. These connections can be protected in some embodiments by insulating materials that only expose the contacts when the battery is fully seated, minimizing the risk of accidental contact with live electrical parts during installation or removal.

Additional safety features of some embodiments can include a mechanical lock to avoid the battery 305 backing out and/or a mechanical door that shields the contacts of the battery when it is outside the load source 200 until a mating feature in the backplane opens it. Further safety features can include an interlocking mechanism that prevents the battery 305 from being removed while the load source 200 is powered on, reducing the risk of accidental disconnection. Another example can be the use of an automatic cover that slides into place over battery terminals when the battery 305 is removed, shielding the contacts from dust or inadvertent touch. Some designs can incorporate a temperature-sensitive lock that prevents battery removal if the battery 305 is too hot, protecting both the user and the system from overheating issues. Additionally, the load source system 300 in some examples can include sensors that detect whether the battery 305 is fully seated and only allow power to flow when the battery 305 is properly installed, further minimizing the potential for connection issues or shock hazards.

In various embodiments, a load source system 300 can comprise a humidity sensor, liquid sensor, or the like (e.g., that can detect rapid changes) which can be used to generate data to detect the presence of liquid (e.g., water) and inform the load source system 300 or allow the load source system 300 to determine to disconnect the battery 305 or take other appropriate safety action. In various embodiments, a load source system 300 equipped with humidity or liquid sensors can continuously monitor environmental conditions to detect the presence of moisture or liquid intrusion. For instance, a humidity sensor in some examples can track rapid changes in the surrounding air's moisture levels, which can indicate a spill or leak near the battery 305. If water is detected, the load source system 300 can take action, such as shutting off power to the battery 305 or activating safety protocols to prevent short circuits or electrical hazards. Liquid sensors disposed near vulnerable components of the load source system 300 can detect direct contact with water, triggering an alert or automatically disconnecting the battery 305 to avoid damage. For example, a sensor can be installed beneath a housing of the battery 305 or within a chassis of the load source 200 to detect any accumulation of liquid that might pose a risk. Additionally, if the load source system 300 identifies a sudden spike in humidity near critical components, in some examples it can inform the user through a notification or autonomously shut down operations to protect the load source 200. Such sensors can work in tandem with other safety features in various embodiments, such as mechanical locks or shielding mechanisms, to enhance overall safety by preventing electrical hazards in wet or humid conditions.

In some embodiments, the battery 305 can comprise a plurality of individual cells to achieve the voltages required or desired to run the load source 200. One way to reduce the fire hazard of the battery 305 in various examples can be to package smaller numbers of cells in partitions, that if damaged or otherwise compromised, would result in a fire or failure in that partition that could be contained and not spread to other partitions of the battery 305. For example, if one partition is damaged or compromised due to physical stress, overheating, a short circuit, or the like, the resulting failure or fire can be isolated to that specific partition. The partitions can be physically separated by fire-resistant barriers or insulating materials to prevent the spread of heat, flames, or battery material to other sections of the battery 305. These partitions in some examples can be made from materials like ceramic, fiberglass, or other suitable flame-retardant composites that can withstand high temperatures. Such a compartmentalized approach can ensure that a localized failure remains contained, thus protecting the overall integrity of the battery. Such a configuration can be desirable in some embodiments of batteries used in load sources 200, where the energy density is high, and the consequences of a full battery failure could be catastrophic. Such partitioning can simplify maintenance in some examples, as only the compromised partition may need to be replaced, rather than the entire battery 305.

A battery 305 in some embodiments can be divided electrically into lower voltage “sub-packs” still contained in a larger battery enclosure during shipping, warehousing, or when triggered by an error state in the larger system. This can reduce the potential for human injury and electrical fire. Such a division into sub-packs can be implemented in some examples using a removable key software controlled contactors, or the like.

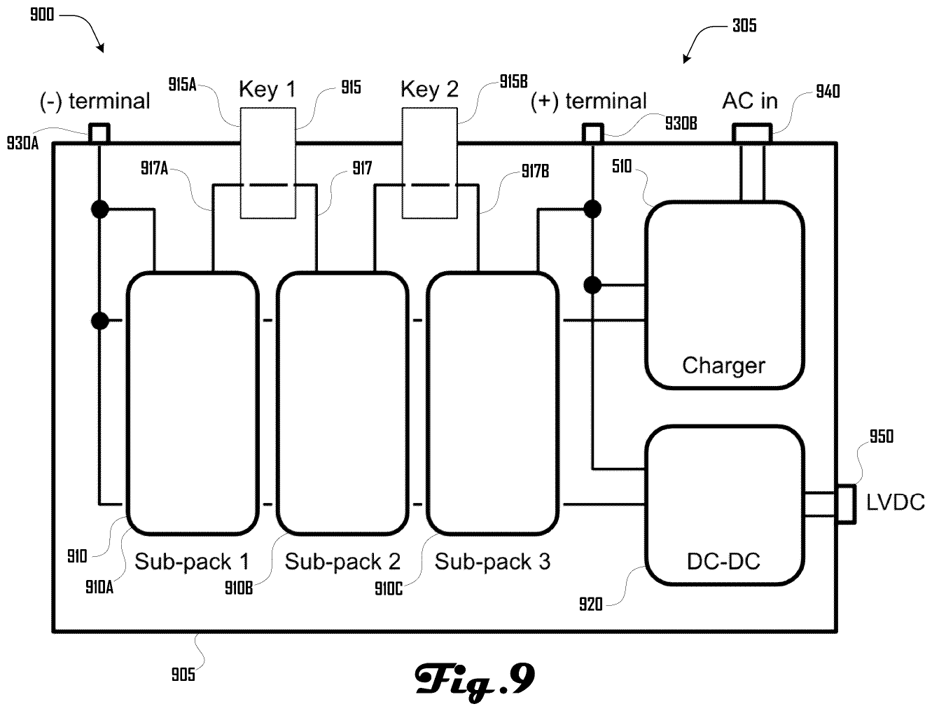

Turning to FIG. 9, an example battery architecture 900 of a battery 305 is illustrated, which shows a battery enclosure 905 with three decomposable sub-packs 910A, 910B, 910C within the enclosure 905 that can be isolated using keys 915A, 915B. These keys 915 can be physical and/or can be set by software in various embodiments. In this example instantiation, a charger 510 and DC-DC converter 920 are also shown within the battery enclosure 905, which may limit exposed high-voltage DC conductors in various embodiments.

In various embodiments, ‘decomposable’ can refer to the ability of the sub-packs 910 within the battery enclosure 905 to be separated or disassembled into smaller, manageable parts or modules. This characteristic can allows the sub-packs 910 of various examples to be isolated or decoupled from each other, such as when using the keys 915. Accordingly, in various embodiments the battery 305 can be modular, such that individual sub-packs 910 can be serviced, replaced, or isolated independently without affecting the entire battery system. This can desirable in various examples for maintenance, fault management, and optimizing performance, as one faulty sub-pack 910 can be disconnected without shutting down the entire system. The use of a modular architecture can support flexibility in the design, enabling a more efficient and safer approach to battery management.

A negative terminal 930A can be located externally on the enclosure 905 and can connect internally to the first sub-pack 910A. This negative terminal 930A can provide a primary output for the negative polarity current of the sub-packs 910 of the battery 305, facilitating the discharge of electrical energy from the battery 305 to external systems, such as elements of a load source system 300.

A positive terminal 930B, similarly located outside the enclosure 905, can connect internally to the third sub-pack 910C, the charger 510, and the DC-DC converter 920. The positive terminal 930B can serve as the output for the positive polarity current from the battery 305. By connecting to the charger 510 and the DC-DC converter 920, in various embodiments the positive terminal 930B can allow for controlled power distribution and voltage regulation, which may ensure that both high- and low-voltage demands of the load source system 300 are met. The DC-DC converter 920 in some examples can facilitate the conversion of high-voltage output from the battery 305 into a lower voltage suitable for specific components of the appliance, such as control units or sensors, enhancing efficiency and safety.

An AC input 940 can provide a connection point on the outside of the enclosure 905, enabling the battery 305 to be charged via an external AC power source (e.g., input 505). This AC input can connect to the charger 510 within the enclosure, which can be configured for converting the incoming AC power into DC power used for charging the battery 305. By keeping the charger 510 inside the enclosure 905, the architecture 900 of various examples minimizes the exposure of high-voltage DC conductors, reducing the risk of electrical hazards during charging and making the battery 305 and a load source 200 that may be associated with the battery 305 safer for users and maintenance personnel.

An LVDC connection 950 disposed on the enclosure 905 can provide an external interface to the low-voltage DC power output generated by the DC-DC converter 920. This output via the LVDC connection 950 can be configured to supply low-voltage systems within the load source system 300, such as in some embodiments to control electronics, sensors, or other suitable potentially low-voltage subsystems. The DC-DC converter 920 in various embodiments can ensure that the battery 305 can supply power at multiple voltage levels, which may accommodate the varied power demands of a load source 200 while maintaining safety and operational efficiency.

The sub-packs 910A, 910B, and 910C can be isolated using physical and/or software keys 915, enabling maintenance or fault isolation in some examples without compromising the overall integrity of the battery pack 900. Such a modular approach in various embodiments can allow individual sub-packs 910 to be serviced or replaced without affecting the entire battery pack 900, enhancing safety, reliability, and ease of maintenance. In some embodiments, a sub-pack 910 may comprise one or more battery cells.

As shown in FIG. 9, the keys 915 extend through the enclosure and couple with key respective key lines 917 that are connected to the sub-packs 910. Specifically, the first key 915A extends through the enclosure 905 and to a first key line 917A that electrically couples the first and second sub-packs 910A, 910B. The second key 915B extends through the enclosure 905 and to a second key line 917B that electrically couples the second and third sub-packs 910B, 910C.

In various embodiments, the keys 915 can be used for configuration and control of the sub-packs 910 within the battery enclosure 905. The keys 915 in various examples can serve as mechanisms for selectively coupling or isolating the sub-packs 910A, 910B, and 910C, allowing for modular control over the operation of the battery 305. For example, keys 915 can function as switches or interlocks that manage electrical connections between the sub-packs 910 via the key lines 917. In one embodiment, the keys 915 may be physical switches that are manually engaged or disengaged to either establish or sever the connection between sub-packs 910 via the key lines 917, thereby allowing for maintenance, fault isolation, modular battery management, or the like. For instance, if a fault is detected in sub-pack 910A, key 915A could be disengaged to isolate sub-pack 910A from the rest of the system, ensuring that the other sub-packs can continue to operate without disruption.

In some embodiments, the keys 915 can be implemented as software-based controls, allowing for remote or automated switching of the electrical connections 917 between sub-packs 910. Such software-based keys 915 can operate in some examples in response to specific triggers, such as a safety condition detected by a battery management system 1160, or during operations where sub-packs 910 need to be isolated for charging, discharging, balancing, maintenance or the like. Additionally, in some embodiments, the keys 915 can be electro-mechanical devices that integrate physical and software components, providing both manual override and automated control capabilities.

The use of such keys 915 in various embodiments can enable greater flexibility and safety in battery management. By providing the ability to decouple individual sub-packs 910, a load source system 300, battery management system 1160, user, or the like can reduce the risk of electrical hazards, perform maintenance more efficiently, and optimize the overall performance of the load source system 300.

Some embodiments can include additional power electronics packaged into a battery pack that defines a battery 305, which can reduce potential exposure to hazardous voltages. Examples of such power electronics include a charger 510, DC-DC converter, inverter, and the like. In some examples, the number of high-voltage conductors in a load source 200 can be reduced.

Temperature sensors internal to an enclosure of a battery 305 can be used in some embodiments to ensure safety operation. In addition to sensors in some examples, temperature cut-outs (e.g., utilizing a bimetallic strip which breaks a circuit when it reaches a specified temperature) can be used to facilitate disconnection at set temperatures, independent of or absent software. Fast-acting devices (e.g., pyrofuses) can be used in some examples to break contact before damage occurs in a fault condition. Safety features of further embodiments can include thermal runaway detection systems that monitor individual cell temperatures, the rate at which such temperature rises, and the like, which may allow for preemptive action before a hazardous event occurs. For instance, if the internal temperature of the battery 305 starts to rise rapidly due to overcharging or an internal short circuit, the load source system 300 can trigger a response to cool down the battery 305, such as activating cooling fans, liquid cooling loops, or the like. Another example can involve integrating redundant layers of temperature monitoring. In addition to physical cut-outs like bimetallic strips, electronic temperature management systems of some examples can dynamically adjust the charging and discharging rates of the battery based on real-time temperature data.

Pyrofuses, which can be designed to react to sudden spikes in temperature or pressure, can be located in some examples near high-risk components such as power terminals or within partitions between battery cells. If a specific threshold is reached, the pyrofuse can be configured to sever the connection between the battery and the load source 200, preventing the flow of electricity and halting the potential progression of overheating. Such fuses, along with thermal sensors, cut-outs, and the like, can form a multi-tiered safety approach, which can ensure that the battery 305 remains operational under normal conditions while rapidly disconnecting power in the event of a fault. In some embodiments, a combination of passive and active safety mechanisms can enhance the overall reliability and safety of the load source 200.

Various embodiments can be equipped with detection circuits for electrical and/or thermal fault detection, which in some examples can preserve the functionality and safety of the load source system 300, detect malfunctions of components (e.g., oven 360, cooktop 370), and the like.

Impedance spectroscopy (IS) can be used for diagnostics of a battery 305 in some examples, such as by stimulating batteries with known frequencies to detect battery health (e.g., by detecting dendrite growth). In a load source system 300 of various embodiments, IS can be carried out continuously or periodically in order to monitor health of a battery 305 over time. In some embodiments, the heating elements of an oven 360, cooktop 370, water tank 760, or the like can be used as a load for such testing. In some examples, spectrograms generated by IS can be cross-referenced with temperature and/or discharge histories of the battery 305 to build a predictive dataset of battery health over time. These datasets can then be used to modify the discharge rates to prolong battery lifetime.

For example, a method of battery diagnostics and configuration can comprise obtaining IS data based on stimulating a battery 305; determining a health status or one or more conditions of the battery 305; determining whether or not to modify a use configuration of the battery 305; and if so, changing the use configuration of the battery 305 to a determined new use configuration. For example, determining a use configuration, determining whether to change a use configuration, or the like can be based on temperature and/or discharge histories of the battery 305.

A load source system 300 of various embodiments can measure the characteristics of the incoming AC electricity from the wall (e.g., via electrical input 505) and report such characteristics via a network connection, via a communication system 450, a user interface 460, or the like. Such characteristics can include grid information, such voltage amplitude, frequency, and waveform. Such characteristics in some examples can also measure characteristics of a household electrical system (e.g., via power lines 155 of a powered building system 100). For example, voltage sag when charging the battery 305 can indicate a branch circuit of a powered building system 100 is overloaded.

In some embodiments, temperature sensors (e.g., associated with an oven 360, cooktop 370, water tank 760, or the like) can be used to detect a home fire, kitchen fire, or the like. In some examples, a load source system 300 can be network-connected (e.g., via communication system 450) and can have access to data from a plurality of temperature sensors, which can include temperature sensors of the load source system 300, another load source system 300, another device having one or more temperature sensors, or the like. In various embodiments, data from such a plurality of temperature sensors can be configured to identify and report unusual temperature-related events in a home such as fire, overheating, or the like. For instance, data from such a plurality of sensors can be used to identify a house fire by recognizing specific patterns of temperatures across the plurality of sensors which could not occur from normal operation of a load source 200, other load sources 200, other devices, or the like. In various embodiments data from other suitable sensors of one or more load source systems 300 or other devices can be used to detect other issues.

In one example, data from one or more moisture or liquid sensors can be configured to detect a flood. In another example, data from one or more smoke sensors of one or more load source systems 300 can be used to detect fine particulates in the air, providing early warning of a fire even before the temperature rises. Carbon monoxide (CO) sensors can be used to detect dangerous levels of CO, which could indicate a malfunctioning gas stove or heating system. One or more motion sensors can monitor unusual activity around appliances or within a kitchen, identifying possible human error or malfunction, such as a pot left unattended on a stove 125. One or more vibration sensors disposed in one or more battery compartments or near mechanical components can be used to detect unexpected movements or vibrations that could signal structural damage, mechanical failure, seismic activity, or the like.

For water-related risks, data from humidity sensors, water sensors, and the like can be used to detect leaks, bursts in pipes, or the like, before water levels rise enough to trigger a flood sensor. Gas leak detectors in some examples can monitor the surrounding environment for dangerous leaks from gas-powered appliances. Collecting data from one or more sensors can allow a load source system 300, powered building system 100 or the like to generate a more comprehensive understanding of the overall safety of the home, responding to a wide array of potential hazards. When network-connected, such data could be sent to homeowners or emergency services, allowing for remote monitoring and faster responses to emergency situations.

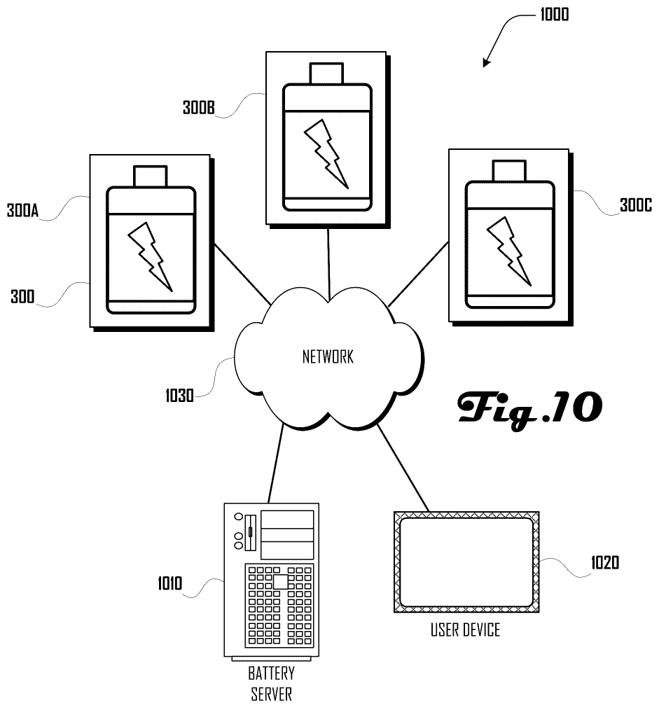

Turning to FIG. 10, an example embodiment of a load source network 1000 is illustrated that comprises three load source systems 300A, 300B, 300C, a load source server 1010 and a user device 1020, which are operably connected via a network 1030. In various embodiments, the network 1030 can comprise various suitable wired and/or wireless networks, including Wi-Fi, Bluetooth, a wired connection, a cellular network, the Internet, a local area network (LAN), wide area network (WAN), a wired connection, or the like. In various embodiments, the load source systems 300A, 300B, 300C can communicate with each other and/or the load source server 1010 and user device 1020 via a communication system 450 (see FIG. 4).

In some embodiments, the load source systems 300 can obtain data from, send data to, or be controlled by one or both of the load source server 1010 and user device 1020 as discussed in more detail herein. In some embodiments, the load source server 1010 and/or user device 1020 can be remote from are proximate to the load source systems 300 of the load source network 1000. For example, in some embodiments, the load source systems 300 can be disposed within or associated with load sources 200 of a house and the user device 1020 can be used to configure the load source systems 300 individually or collectively. The user device 1020 can be a smart phone in some examples, and may be used by a user while in or around the house or used while the user is remote from the house. In some examples, the load source server 1010 can be a remote physical or cloud-based server or server system that can be configured to store data related to the load source systems 300, store data provided by the load source systems 300 and/or user device 1020, or configure the load source systems 300 and/or user device 1020 as discussed in more detail herein.

While the embodiment of a load source network 1000 of FIG. 10 shows one example, it should be clear that numerous suitable additional configurations of a load source network 1000 are within the scope and spirit of the present disclosure. For example, in further embodiments, any suitable plurality of load source systems 300 can be part of a load source network 1000 including 1, 2, 3, 4, 5, 6, 7, 8, 9, 10, 20, 50, 100, 1k, 10k, 100k, 1M, 5M, 10M, 50M, or the like. One or more load source systems 300 can be part of one or more load sources 200. Similarly, there can be any suitable number of load source servers 1010 and user devices 1020 or one or both of a load source server 1010 and user device 1020 can be absent. Additionally, in some examples, a load source server 1010 and/or user device can be part of one or more load source systems 300 and need not be a separate element as shown in the example of FIG. 10. For example, in some embodiments, there can be a network of a plurality of load source systems 300 with one or more of such load source systems having the capabilities, functionalities, elements or the like of one or both of a load source server 1010 and user device 1020. For example, a mesh network of a plurality of load source systems 300 can have a central hub load source system 300 that controls, stores data for, or provides data to the entire network.

In various embodiments, there may be different sets of batteries that are associated with a given user or administrator in a load source network 1000. For example, in some embodiments there can be a plurality of separate powered building systems 100 (see e.g., FIG. 1) that each comprise a plurality of load source systems 300 and each of these separate powered building systems 100 can be associated with a different user or administrator and respectively controlled by a different user device 1020 associated with the different user or administrator. However, in some embodiments, all of such separate powered building systems 100 can communicate with the same load source server 1010, which can be configured to store data associated with different user or administrator accounts associated with the different powered building systems 100. Such pooled data can be used to configure, or provide information to the plurality of different powered building systems 100 as discussed in more detail herein, including network-wide, worldwide, country-wide, statewide, county-wide, town-wide, block-wide, or the like.

In some examples, the load source server 1010, user device 1020, or one or more of the load source systems 300 and can have access to data from a plurality of temperature sensors, which can include temperature sensors of one or more of the load source systems 300A, 300B, 300C, another device (e.g., user device 1020) having one or more temperature sensors, or the like. In various embodiments, data from such a plurality of load source systems 300 can be used to identify and report unusual temperature-related events in a home such as fire, overheating, or the like. For instance, data from such a plurality load source systems 300 can be used to identify a house fire by recognizing specific patterns of temperatures across load source systems 300 which could not occur from normal operation of a load source 200.

Some embodiments of load sources 200 (like various embodiments of a heat pump water heater or heat pump mini split such as discussed in U.S. patent application Ser. No. 18/818,377, filed Aug. 28, 2024, entitled “BATTERY-INTEGRATED WATER HEATER SYSTEM AND METHOD,” with attorney docket number 0122186-003US0, which is incorporated herein by reference) can have an onboard heat pump and can produce hot or cold gradients that are sunk to the environment. In some examples, such thermal gradients can be used to maintain the temperature of the battery 305. For instance, while using a battery-enabled heat pump water heater, the battery 305 can be kept cool and run at high discharge rates using the cold output from the heat pump. Incoming domestic water (e.g., via a water in-line 792A) can also be used to regulate the temperature of the battery 305.

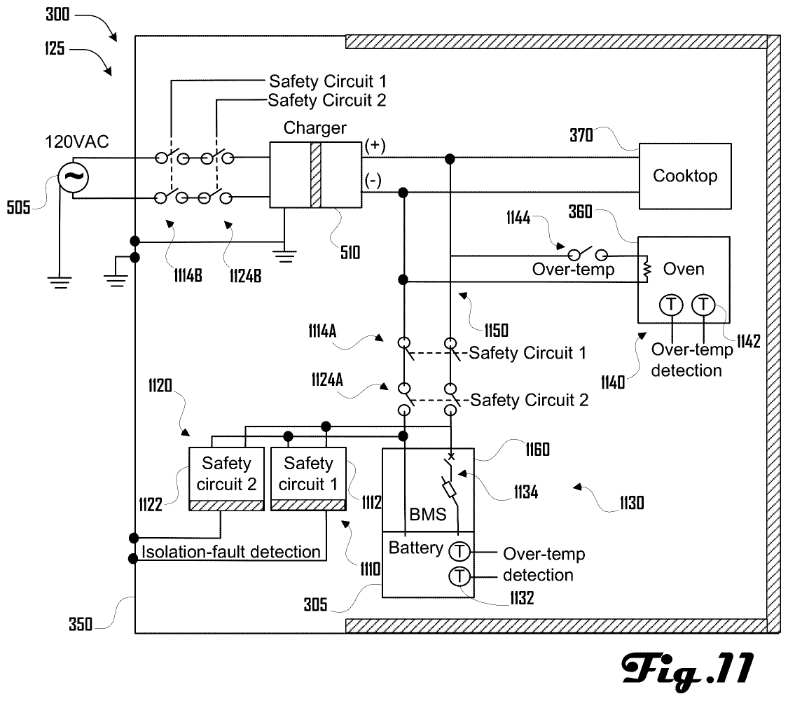

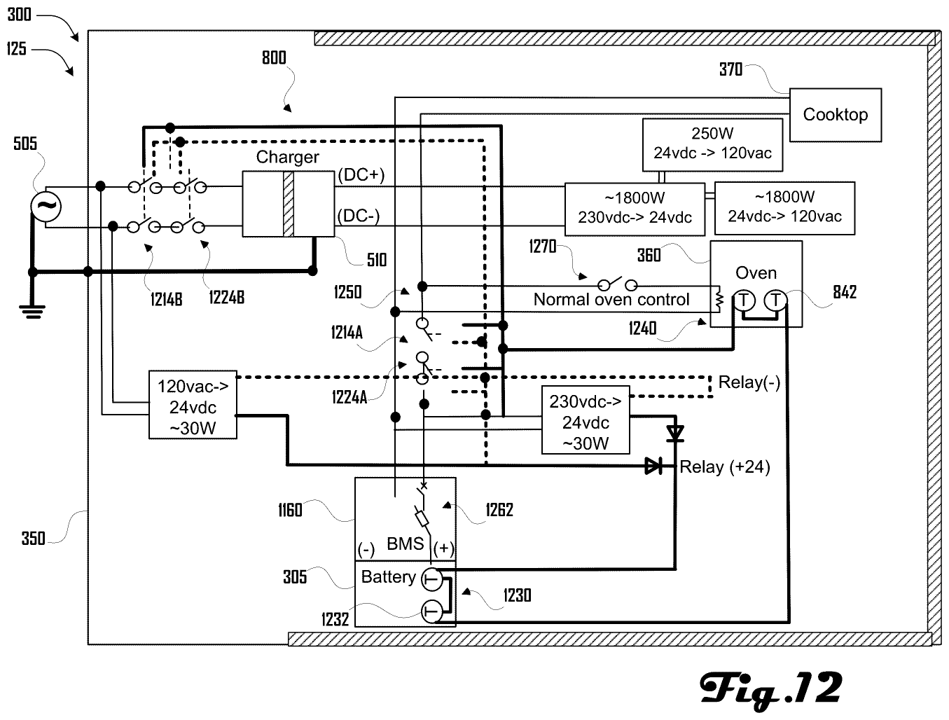

Turning to FIGS. 11 and 12, example embodiments of a stove 125 load source 200 that comprises a load source system 300 having a battery 305 and a battery management system 1160 associated with the battery 305. In some embodiments, the battery management system 1160 can be part of a battery pack that defines the battery 305 (e.g., a modular battery pack that allows the battery 305 to be inserted into and/or removed from the load source 200). For example, some embodiments can include a smart battery where a battery pack has capabilities such as sensing, communication, and the like. Additionally and alternatively, a battery management system 1160, or portions thereof, can be part of the load source system 300, while being separate from but associated with the battery 305. For example, some embodiments can include a modular battery 305 or battery pack that can be inserted into and/or removed from the load source 200 and thereby be separated from a battery management system 1160 or portions thereof.

Turning to FIG. 11, an example embodiment of a load source system 300 of a stove 125 is illustrated, which comprises a plurality of safety systems 1110, 1120, 1130, 1140. The load source system 300 in this example comprises a first safety system 1110 that comprises a first safety circuit 1112 and two switch pairs 1114A, 1114B. The load source system 300 in this example further comprises a second safety system 1120 that comprises a second safety circuit 1122 and two switch pairs 1124A, 1124B.

In various embodiments, the first and second safety circuits 1112, 1122 can be connected to the housing 350 of the oven 125 and connected to a string 1150 connected to the battery 305, a battery management system 1150, an oven 360, a cooktop 370 and a charger 510. The first and second safety circuits 1112, 1122 can be configured to actuate switch pairs 1114A, 1124A disposed in parallel on the string 1150. In various embodiments, actuating at least one of the switch pairs 1114A, 1124A on the string 1150 can cause the battery 305 to be disconnected from the oven 360, cooktop 370 and charger 510, which can prevent or stop electrical power flowing to and/or from the battery 305 to and/or from the oven 360, cooktop 370 and charger 510. For example, actuating at least one of the switch pairs 1114A, 1124A on the string 1150 can prevent or stop the charger 510 from charging the battery 350; prevent or stop the battery 305 from powering the oven 360; prevent or stop the battery 305 from powering the cooktop 370; and the like. Such a configuration can be desirable in various embodiments to cut power to heating elements such as the oven 360 and/or cooktop 370 in response to a determined or detected safety event by the first and/or second safety circuits 1112, 1122. Such a configuration can be desirable in various embodiments to cut power being provided to the battery 305 in response to a determined or detected safety event by the first and/or second safety circuits 1112, 1122.

The first and second safety circuits 1112, 1122 can be configured to respectively actuate the switch pairs 1114B, 1124B disposed between the AC electrical input 505 and charger 510. In various embodiments, actuating at least one of the switch pairs 1114B, 1124B between the AC electrical input 505 and charger 510 can cause the charger 510 to be disconnected from the AC electrical input 505, which can prevent or stop electrical power flowing to the charger 510 from the electrical input 505. For example, actuating at least one of the switch pairs 1114B, 1124B can prevent or stop the charger 510 from charging the battery 350; prevent or stop the charger 510 from powering the oven 360; prevent or stop the charger 510 from powering the cooktop 370; and the like. Such a configuration can be desirable in various embodiments to cut power to heating elements such as the oven 360 and/or cooktop 370 in response to a determined or detected safety event by the first and/or second safety circuits 1112, 1122. Such a configuration can be desirable in various embodiments to cut power being provided to the battery 305 in response to a determined or detected safety event by the first and/or second safety circuits 1112, 1122.

In various embodiments, the first and second safety circuits 1112, 1122 can respond to electrical hazards such as an insulation fault, an incorrect installation, damaged battery, DC isolation fault, AC hazard, and the like. In various embodiments, the first safety circuit 1112 can be configured to simultaneously trip the switch pairs 1114A, 1114B, which can be configured to stop or prevent power to heating elements such as the oven 360 and/or cooktop 370 based on power from the battery 305 and/or the electrical input 505. Such a configuration can be desirable in various embodiments to cut power to heating elements such as the oven 360 and/or cooktop 370 in response to a determined or detected safety event by the first and/or second safety circuits 1112, 1122, regardless of whether the oven 360 and/or cooktop 370 are being powered by one or both of the battery 305 and power from the electrical input 505.

In various embodiments, the load source system 300 of the stove 125 can comprise a third safety system 1130 associated with the battery 305, which can comprise at least one battery temperature sensor 1132 associated with the battery 305, which can be configured to sense a temperature of the battery 305, which can be used to make a determination that the battery 305 is above a threshold temperature for a threshold amount of time. In response, the third safety system 1130 can trigger a battery switch 1134, which can prevent or cut power being provided to the battery 305 and/or prevent or cut power being provided by the battery 305. Such an embodiment can be desirable for identifying or determining presence of a battery over-temperature event and responding by generating a battery cut-out.

In various embodiments, the third safety system 1130 can comprise any suitable number of battery temperature sensors 1132 of any suitable type(s), which can be disposed, in, on or about the battery 305, including in some examples as part of a battery management system 1160 associated with the battery 305. In various examples, the battery switch 1134 can be part of a battery management system 1160, or disposed in any other suitable location.

In various embodiments, the load source system 300 of the stove 125 can comprise a fourth safety system 1140 associated with the oven 360, which can comprise at least one oven temperature sensor 1142 associated with the oven 360, which can be configured to sense a temperature of the oven 360, which can be used to make a determination that the oven 360 is above a threshold temperature for a threshold amount of time. In response, the fourth safety system 1140 can trigger an oven switch 1144, which can prevent or cut power being provided to the oven 360. Such an embodiment can be desirable for identifying or determining presence of an oven over-temperature event and responding by generating an oven cut-out.

In various embodiments, the fourth safety system 1140 can comprise any suitable number of oven temperature sensors 1142 of any suitable type(s), which can be disposed, in, on or about the oven 360, including in some examples as part of an oven system associated with the oven 360. In various examples, the oven switch 1144 can be disposed in any other suitable location.

In further embodiments, other elements of the stove 125 can have associated temperature safety systems, including heating elements such as the cooktop 370, one or more heating zones 372 of the cooktop 370, and the like. Such temperature safety systems can be desirable for identifying or determining presence of an over-temperature event for such elements.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

For example, FIG. 12 illustrates an example embodiment of a load source system 300 of a stove 125 comprising a relay system 1200 configured for responding to a determined oven over-temperature event and responding to at least a determined battery over-temperature event. For example, the relay system 1200 can extend between one or more respective temperature sensors 1232, 1242 of a battery safety system 1230 and oven safety system 1240. The relay system 1200 can further extend between switches 1214A, 1214B, 1224A, 1224B. Accordingly, the relay system 1200 can be configured for responding to both a determined oven over-temperature event and responding to at least a determined battery over-temperature event.

In some embodiments, the switches 1214A, 1224A can be part of 2× Single Pole Single Throw-Normally Open (SPST-NO) switch assembly disposed on a string 1250 between the battery 305, oven 360, cooktop 370, and charger 510 that also includes a normal oven control switch 1270 and normal battery switch 1262 that can be part of a battery management system 1160. In some embodiments, the switch pairs 1214B, 1224B can be part of a 2× Double Pole Single Throw-Normally Open (DPST-NO) switch assembly disposed between the electrical input 505 and the charger 510. In some embodiments, the switches 1214A, 1214B can be part of a first circuit and the switches 1224A, 1224B can be part of a second circuit. In some embodiments, the relay system 1200 can be configured to respond to a determined electrical hazard event, or the like.

In various embodiments, a load source system 300 (e.g., one or more suitable portions thereof) and/or the battery management system 1160 can generate, display or indicate error codes. For example, in some embodiments, an error identified by the battery management system 1160 can cause one or more elements of the load source system to cease operation, have limited operation, switch between operational modes, or the like, based on factors such as the identity or nature of the error, or the like. In some embodiments, an error identified by the load source system 300 can cause one or more elements of the battery management system 1160 and/or battery 305 to cease operation, have limited operation, switch between operational modes, or the like, based on factors such as the identity or nature of the error, or the like.

This can include examples where the battery 305 or battery management system 1160 associated with the battery 305 reports poor health of the battery 305; where the load source system 300 or portion thereof is faulty, broken, defective, or the like; where there is an ID (e.g., a manufacturer-programmed software key) mismatch between the battery 305 or battery management system 1160 and the load source system 300 or vice versa. For example, a battery module (e.g., battery 305 that may or may not include a battery management system 1160) and load source system 300 do not recognize each other or are not mutually supportive. A battery management system 1160 and load source system 300 can communicate errors through various suitable signals, communication protocols, and/or communication system (e.g., communication system 450) and may in some examples have secondary low-power states dedicated to error code transmission and display in various embodiments.

In various embodiments, communication between a management system 1160 and load source system 300 can be desirable to ensure seamless operation and safety of the stove 125. For example, the battery management system 1160 can be configured to continuously monitor various battery parameters, such as temperature, voltage, current, and overall health. If an issue like poor health or faulty performance is detected, the battery management system 1160 in various examples can trigger alerts or initiate safety protocols to mitigate the risks. This in some embodiments can involve reducing power output, disconnecting the battery, or limiting certain operational functions of the stove 125 such as the oven 360, cooktop 370, and the like.

In some embodiments, various suitable data points or conditions can be monitored by the battery management system 1160 or other suitable system of a load source (e.g., a load source computing device) to determine whether the battery 305 is in “poor health.” For example, a significant drop in the overall capacity of the battery 305 may be detected, which can indicate a reduced ability to store and deliver energy. This can be observed in some examples through discrepancies between the rated capacity of the battery 305 and actual output during normal operation of the battery 305. Additionally, increased internal resistance within the cells of the battery 305 may indicate aging or degradation, leading to inefficiency in energy transfer and increased heat generation during charging or discharging.

Temperature anomalies, such as consistent overheating or unusual fluctuations in the thermal profile, can indicate poor health in various examples. Excessive heat can accelerate wear on the battery 350 and might be a result of internal short circuits, which would be a safety concern. Voltage irregularities, such as cells of a battery 305 operating at consistently lower or higher voltages than their rated values, could suggest issues like overcharging, undercharging, or cell imbalances, which could lead to premature failure of the battery 305.

In some embodiments, track charge/discharge cycles can be tracked, where a higher-than-expected number of cycles or rapid depletion of charge during regular usage may be a sign of poor health of the battery 305. In some embodiments, detecting an abnormal energy leakage or parasitic drain, where energy is lost even when the load source 200 is not in use, could also signal a fault in the battery 305. One or more of such conditions, individually or collectively, could prompt the system to flag the battery as being in poor health and trigger a corresponding alert, error reporting, or the like and can result in a mode change of the battery 305 or other system of the load source 200 for safety and performance considerations.

Where it is determined that the battery 305 is in poor health, various operational changes can be initiated to safeguard the load source 200 and/or battery 305 and prevent further damage or safety risks. For instance, in some embodiments, the battery management system 1160 can reduce the power output of the battery 305 by limiting the current supplied to the load source 200 or reducing the charging rate, thereby minimizing stress on the battery 305. By lowering the operational load on the battery 305, the load source system 300 can help prevent thermal runaway or other hazardous conditions associated with failing cells of a battery 305.

Additionally, the load source system 300 may switch the load source 300 to a lower power consumption mode or selectively disable certain high-energy functions of the load source 200. For example, in a smart 125, the heating elements may be throttled or restricted from reaching high temperatures, or in a heat pump 120, the load source system 300 may reduce the compressor operation to decrease energy demands. Such a response in various examples can help ensure that the battery 305 continues to function, albeit in a limited capacity, while reducing the risk of overloading the compromised battery 305.

In some instances, the load source system 300 may also isolate sub-packs 910 within the battery, such as using one or more keys 915 (see FIG. 9), to effectively take degraded cells or sub-packs 910 offline, while allowing the remaining healthy sub-packs 910 to continue operating. This in various embodiments can allows for partial operation of the load source 200 even when some portions of the battery 305 have been flagged as compromised. Furthermore, the load source system 300 may initiate a controlled discharge of the battery 305, ensuring that any stored energy is safely dissipated over time, such as if the battery 305 is no longer deemed safe to continue charging or holding energy at high, desirable or suitable levels.

In II response to poor battery health, the load source system 300 in various embodiments can also prioritize user safety by issuing a shutdown sequence or placing the battery 305 into a low-power or standby mode. This can be accompanied in some examples by generating alerts or notifications to the user, service personnel, a user device 1020 or a remote load source server 1010, indicating that maintenance or battery replacement is required or desirable. Such actions may be automated based on predefined thresholds for parameters like voltage drop, internal resistance, or abnormal temperature, or the like, which may ensure that the load source system 300 reacts promptly to any sign of degradation of the battery 305. Such actions and others described herein can be taken by or initiated by one or more suitable elements or computing devices of the load source system 300, such as processor 410, such as a computer 815, battery management system 1160.

In some embodiments, a load source system 300 of a load source 200 such as a stove 125, water heater 140, heat pump 120, or the like, can determine that elements within the load source 200 are faulty by monitoring operational parameters and comparing them to expected performance thresholds. For example, temperature sensors within a stove 125 could detect that a heating element is not reaching a desired temperature or is fluctuating outside of an acceptable range, indicating a fault in the heating element. In another example of a water heater 140, the load source system 300 can monitor water temperature and flow sensors to detect whether heating elements or thermostats are functioning correctly, with discrepancies in water heating time or sustained low water temperatures indicating potential faults.

In other examples, electrical sensors within the load source system 300 can monitor current and voltage levels to detect whether certain circuits or components, such as control boards or relays, are functioning improperly. A heat pump 120 in some examples can use pressure sensors to monitor refrigerant levels or compressor performance, where a drop in pressure could signal a refrigerant leak or compressor failure. Additionally, fan motors or circulation pumps within a load source system 300 can be monitored through voltage and current draw; if these components draw excessive current or fail to operate at expected levels, the load source system 300 can determine that such elements are malfunctioning or have failed.

In some embodiments, the load source system 300 could use self-diagnostic protocols to run checks on key components during startup or periodic intervals, identifying elements such as sensors, relays, or valves that are unresponsive or returning abnormal data. For instance, a stove 125 could run a diagnostic test to verify that safety interlocks, such as door locks or gas shutoff valves, are functioning as expected. If a diagnostic sequence detects that an interlock is stuck or not responding, the load source system 300 can flag the component as faulty and potentially disable certain operations to prevent unsafe conditions.

The load source system 300 in some embodiments can use communication protocols to exchange data between the battery 305, battery management system (BMS) 1160, and various sensors and controllers within the load source system 300. If a communication system detects missing or corrupted data from system components, such as power regulators or temperature control modules, it the load source system 300 can determine that such components are faulty, triggering a reduced functionality mode or shutting down the load source 200 until repairs can be made.

The load source system 300 can comprise error-handling mechanisms for determining when a mismatch occurs between the battery 305 and the load source system 300. For example, if a manufacturer-programmed software key mismatch between the battery 305 and load source system 300 is detected (e.g., by battery management system 1160), the battery management system 1160 can restrict operation of the battery 305 and/or portions of the load source system 300 to prevent damage or safety hazards to the battery 305 or other portions of the load source system 300. This can be desirable in some examples where different brands or models of batteries 305 and load sources 200 are used interchangeably. A communication system (e.g., communication system 450) of the load source system 300 and/or battery management system 1160 can allow for error signals to be transmitted via any suitable communication protocols such as CAN bus, I2C, or proprietary systems, which can allow for the load source system 300 and/or battery management system 1160, or components thereof, to be aware of potential faults or misconfigurations.

When the load source 200 is in a low-power state (e.g., when power is unavailable from the electrical input 505 and/or when the battery 305 has no power or power below a low-power threshold), the load source system 300 can be configured to continue to determine and send error codes or status updates to provide diagnostic information, even if other elements of the load source system 300 are inoperable, operating at a reduced capacity, or the like. For example, where power is unavailable from the electrical input 505 and/or when the battery 305 has no power or power below a low-power threshold, elements such as the stove 360, one or more heating zones 372 of the cooktop 370, and the like can be switched to operating in a reduced power configuration, configured to be inoperable, or the like, but systems that identify errors, communicate error codes, receive error codes, and/or engage safety features (e.g., battery management system 1160) can remain fully or at least sufficiently powered to provide some or all of such functions.

In one example, if the battery 305 goes below a low-power threshold, stove elements such as an oven 360 and/or cooktop 370 can be configured to be inoperable or to operate at reduced power so that power from the battery 305 is not consumed by the oven 360 and/or cooktop 370, but the battery 305 can be configured to still provide power to the battery management system 1160 and other suitable systems that provide for identifying errors, communicating error codes, receiving error codes and/or engaging safety measures.

In various embodiments, the battery management system 1160 can act as a safeguard for both the battery 305 and the load source 200, which may ensure that any detected issues are communicated promptly and appropriate action is taken, whether it involves adjusting power delivery, signaling for maintenance, or shutting down parts of the system to prevent damage.

Some examples can use communication protocols (e.g., SMBus, I2C, RF, or the like) for unidirectional or bidirectional data exchange between the battery management system 1160 and other elements of the load source system 300. Such communication paths may be established wirelessly or through circuitry or other suitable communication lines that are internal to either the load source 200, the battery 305, the battery management system 1160 or the like. In various examples of unidirectional communication, in some embodiments communication may be established through partial circuitry that can be external to the load source 200, the battery 305, and/or the battery management system 1160, such as an NFC, battery-powered sticker, or the like, on the battery 305 (e.g., on a battery module, battery housing, or the like) encoding a battery ID that can be read out by a transceiver on the load source 200. Such a battery ID can be a unique identifier, a battery model identifier, a battery type identifier, or the like. In some embodiments, the load source can comprise an NFC, battery-powered sticker, or the like, that can be read to obtain a load source ID, which can be a unique identifier, a load source model identifier, a load source type identifier, or the like. In various embodiments, a battery ID and/or load source ID can be stored and communicated in any suitable way.

In some embodiments, a method of determining a battery mismatch can comprise obtaining a battery ID (e.g., via a transceiver) and determining whether a battery mismatch is present. Such a determination in some embodiments can be made based, at least in part, on determining that a battery type identified from a battery ID is incompatible with the type of load source. Where a battery mismatch is identified, remediation actions can be taken as a result, which may include disconnecting the battery 305, preventing power from being drawn from battery 305, reducing power consumption by the battery 305, generating an error code, communicating an error code, or the like. In some embodiments, such a battery mismatch can be determined and/or remediated by a load source 200 and/or the battery management system 1160.

In some embodiments, a method of determining a load source mismatch can comprise obtaining a load source ID (e.g., via a transceiver) and determining whether a load source mismatch is present. Such a determination in some embodiments can be made based, at least in part, on determining that a load source type identified from a load source ID is incompatible with the type of battery 305. Where a load source mismatch is identified, remediation actions can be taken as a result, which may include disconnecting the battery 305, preventing power from being drawn from battery 305, reducing power consumption by the battery 305, generating an error code, communicating an error code, or the like. In some embodiments, such a load source mismatch can be determined and/or remediated by a load source 200 and/or the battery management system 1160.

Various embodiments can implement mutual authentication to establish trust between the load source 200, battery 305 and/or the battery management system 1160. Various embodiments can include a robust error signaling mechanism for error code transmission and recognition. The battery management system 1160 in some embodiments continuously or periodically monitors one or more health parameters of the battery 305 and reports such health parameters, reports poor battery health, or the like to the load source system 300. In some embodiments, such reporting can be continuous, can be periodic and/or can be triggered based on one or more health parameters being above or below a health threshold. In some embodiments, such health parameters can comprise one or more of voltage, current, temperature, state of charge (SOC), state of health (SOH), internal resistance, charge/discharge cycles, capacity degradation, cell balancing status, fault conditions, and the like.

The load source system 300 in some embodiments assesses the condition of the load source 200 and can communicate such a condition to the battery management system 1160 continuously, periodically and/or triggered based on one or more health parameters being above or below a health threshold. In some embodiments, load source health parameters can include one or more of temperature, power consumption, energy efficiency, operating voltage, current draw, operational cycles, start-up and shut-down behavior, fan speed, sensor accuracy, internal resistance (e.g., in electrical components), error codes, control board diagnostics, motor performance, airflow or coolant flow, safety switch engagement, connectivity status (e.g., for smart devices), an indication of wear or degradation in mechanical parts, and the like.

Some embodiments can include device and battery ID recognition (e.g., to ensure compatibility). Some embodiments can use error flags to signal mutual errors (e.g., battery incompatibility, device faults, and the like). The battery management system 1160 in some embodiments can switch to a low-power state or secondary low voltage output for error code transmission, preserving energy. The battery management system 1160 in some embodiments can have a secondary power source (e.g., AC wall power and/or a smaller secondary battery) for error code transmission and display while operating in a low-power mode.

The battery management system 1160 can communicate with the load source system 300 in various suitable ways. For example, some embodiments can include bidirectional data exchange through communication protocols. Some embodiments can include mutual authentication signals to establish trust. Some embodiments can include flags and error codes indicating battery health, compatibility, battery status and/or other issues or states.

The battery management system 1160 and/or load source system 300 can communicate errors and other status indicators to a user in various suitable ways. For example, some embodiments can include error messages and/or codes displayed on a device screen or on the battery management system 1160 and/or load source system 300 (e.g., via stove interface 380, stove screen 384, load source system interface 460, water heater interface 780, water heater screen 782, and the like).

Some embodiments can include LEDs changing colors or blinking patterns to represent different error types. Some embodiments can include sounds or alarms corresponding to specific error conditions. Some embodiments can include vibrations to alert users to errors (e.g., in situations where visual or auditory alerts may not be effective.). Such visual, audio and/or haptic presentations can be generated by various suitable elements of the battery management system 1160 and/or load source system 300.

Some embodiments can include companion apps that send push notifications detailing error information and providing troubleshooting guidance. For example, referring to FIG. 10, in some embodiments such notifications can be generated by one or more load source system 300A, 300B, 300C and/or a load source server 1010 and presented on the user device 1020 as a push notification, or the like.

In various embodiments, both the battery management system 1160 and/or load source system 300 can incorporate these communication and error signaling features, and they can operate in secondary low-power modes in some examples dedicated to error code transmission and display, ensuring comprehensive safety and efficiency. For example, in some embodiments, the battery management system 1160 can be operable as a separate computing device or robust subsystem and include one or more elements shown in FIG. 4, which may or may not be redundant to similar elements that are part of a load source system 300, but not part of the battery management system 1160.

In various embodiments, a load source system can be configured to provide blackout alerts, power restoration detection alerts, and the like. For example, an advantage of various energy storage equipped devices can be the existence of a battery (e.g., battery 305, or the like) that continues to power the load source system 300 in the event of a blackout (e.g., when the primary wall AC power source 505 becomes unavailable). Through the use of battery power, the load source system 300 in some embodiments powers circuitry that measures or senses a voltage along the primary power source's input path and powers one or more elements that can inform the user about the state of the primary power source (e.g., such elements can be part of a battery management system 1160 or other suitable element of a load source system 300).

Use cases for such a feature can include one or more of the following in some examples: alerting the user that there is a grid blackout; alerting the user that the grid has been restored following a blackout; alerting the user that the grid is unstable or noisy; alerting the user that the grid is stable or clean; and the like.

A battery management system 1160 or other suitable element of a load source system 300 can communicate errors to a user in various suitable ways. Some embodiments can include error messages and/or codes displayed on a screen. Some embodiments can include LEDs changing colors or blinking patterns to represent different error types. Some embodiments can include sounds or alarms corresponding to specific error conditions. Some embodiments can include device vibrations to alert users to errors (e.g., in situations where visual or auditory alerts may not be effective). Some embodiments can include companion apps that send push notifications detailing error information and providing troubleshooting guidance. By knowing the status of the grid, in various embodiments the user may make safer and more educated decisions related to their home activities and operation of one or more load source systems 300.

As discussed herein, load sources 200 of various embodiments can include water heaters 140, heat pumps 120, and the like. Unlike cooking ranges 125 of various embodiments, such load sources 200 may not be located in parts of the home that a user will frequent, such as a basement or garage. For these “hidden” load sources 200 to communicate their status to the user, it may not be sufficient to communicate the status on onboard or local UI (e.g., interface 460) of the load source system 300 of the load source 200, as the user may not readily see it. If the user is unaware of issues detected by the load source 200, it may present an undesirable safety issue. Accordingly, some embodiments can include a trans-device communication protocol between devices within the ecosystem, such that the status of a “hidden” load source 200 can alert/be made readily visible to the user (e.g., via an appliance or device that is more frequently observed by the user).

For example, referring to the example of FIG. 10, in some embodiments, one or more of the load source systems 300A, 300B, 300C can be part of a “hidden” load source 200 that can communicate alerts, errors, status or other information to other load source systems 300, a user device 1020 and/or load source server 1010 in a load source network 1000 via a network 1030.

In some embodiments, such communication between such devices can include one or more of: (ESE) Appliance to other (ESE) Appliance (e.g., the local UI of a cooking range 125 displays the status of the water heater 140); (ESE) Appliance to a user device 1020 such as a cell phone, smart phone, home automation system, television, gaming system, or the like (e.g., SMS, email, app, via LTE, or the like); (ESE) Appliance to network (e.g., email, app) via Wifi, or the like.

One or more load source systems 300, load source servers 1010, user devices 1020, or the like can present error messages, alerts, status, or the like in various suitable ways. Some embodiments can include error messages and codes displayed on the device screen. Some embodiments can include LEDs changing colors or blinking patterns to represent different error types. Some embodiments can include sounds or alarms corresponding to specific error conditions. Some embodiments can include device vibrations to alert users to errors (e.g., in situations where visual or auditory alerts may not be effective). Some embodiments can include one or more companion apps (e.g., an app of a user device 1020 supported by the load source server 1010) that send push notifications detailing error information and providing troubleshooting guidance.

In various embodiments, a load source system 300 can have various functionalities or capabilities that are beneficial for activities such as shipping of the load source system 300, warehousing of the load source system 300, installation of the load source system 300 in a building 105 (e.g., monitoring, tracking, sensing, data logging, diagnostics, remote intervention, low-power mode, and the like).

For example, because various embodiments of a load source 200 have a battery 305, data can be collected during times when no external power is available (e.g., from a power source 505), such as during shipping, warehousing, and the like. In various embodiments, the battery 305 can be configured for powering sensors 490 of the load source system 300. For example, such sensors 490 can continuously or periodically monitor various parameters, states or aspects of the load source 200 (e.g., ensuring the safety of the load source 200 during shipping).

Monitoring the health of the battery 305 as a whole or at the cell-level can be desirable in some embodiments to ensure that the battery 305 remains stable during shipping or warehousing. Anomalies or issues with the battery can be detected and addressed promptly in various examples. For example, during shipping or warehousing and when a load source is not connected to an electrical input 505, the load source system 300 can monitor the health of the battery 305 via only power from the battery 305 or other internal power source, and if an issue with the battery 305 is detected, the load source system 300 can send an alert to a load source server 1010, user device 1020, or the like, which can alert a shipping or warehousing manager of the issue. In one example, where a battery 305 is determined to have failed or be failing (e.g., unable to hold a suitable charge) or determined to have run out of power or be below a power threshold, an alert can be sent to a shipping or warehouse manager, who can then replace the battery 305, repair the battery 305, charge the battery 305 or perform other remediation as necessary.

Location tracking of one or more load sources 200 can be desirable in various examples for users such as customers, manufacturers, sellers, shippers, warehousers, installers, and the like. For example, providing customers with the ability to track the location of their stove 125, water heater 140, or the like during manufacturing, shipping, delivery and installation can add transparency and convenience to the customer. In some examples, a customer can be informed that their appliance has been “born” and its location can start being reported to the customer; the user can be informed of and track a purchased appliance location during shipping, which may be from a manufacturer, warehouse, store, third-party seller, or the like; the customer can be informed of and track an appliance during delivery to their home and during installation; and the like. Similarly, it can be desirable for manufacturers, sellers, shippers, warehousers, installers, and the like to obtain location data of a load source 200 for tracking. In various embodiments, a load source system 300 can send location data to a load source server 1010 at various suitable intervals or when triggered by a user, which can allow such location data to be provided to a customer or other user via a customer user device 1020.

In some embodiments, humidity and/or thermal sensors can detect or determine if a load source 200 has been exposed to extreme environmental conditions, such as high humidity or temperature, which might affect its performance, quality or safety of the load source 200. Such a determination or data can be used to alert various users to intervene and remedy the environmental conditions, remove the load source 200 from the environment, repair the load source 200, or the like. In various embodiments, a load source system 300 can send environmental data or an alert to a load source server 1010 at various suitable intervals or when triggered, which can allow such environmental data or alert to be provided to a customer or other user via a customer user device 1020.

Some embodiments can include temperature monitoring via thermal sensors used to monitor temperature fluctuations during manufacturing, shipping, storage, delivery, installation, use, and the like. Extreme temperatures can affect performance and safety of the battery 305 in some examples, so monitoring this temperature (e.g., of the battery 305 or environment of a load source 200) can be desirable in various embodiments. In some cases, in addition to temperature monitoring, active cooling or heating can be used to control the range of battery temperatures. In various embodiments, a load source system 300 can send temperature data or an alert (e.g., of a temperature above or below a threshold) to a load source server 1010 or to a user device 1020 at various suitable intervals or when triggered, which can allow such temperature data or alert to be provided to a customer or other user via a customer user device 1020. In some embodiments, such temperature data or alert can be presented at the load source 200 (e.g., via interface 460).

Some embodiments can include impact data logging, which can be useful for assessing the severity of any shocks or drops the appliance experiences during transit. Sensors used to identify motion, velocity or force associated with an impact can include accelerometers, gyroscopes, vibration sensors, force sensors, pressure sensors, and the like. In various embodiments, a load source system 300 can send such data or an alert (e.g., of an impact above a threshold) to a load source server 1010 or to a user device 1020 at various suitable intervals or when triggered, which can allow such data or alert to be provided to a customer or other user via a customer user device 1020. In some embodiments, such data or alert can be presented at the load source 200 (e.g., via interface 460). Such alerts can provide transparency for customers for quality assurance purposes; can be used to determine who may or may not be at fault for damage to a load source 200; can be used to order diagnostics or repair of the load source 200; or the like.

In various embodiments, a load source 200 can be configured for remote diagnostics. For example, if one or more issues are detected with the load source 200 (e.g., during manufacture, shipping, warehousing, delivery, installation, or the like), in various embodiments the load source 200 can communicate with a central system (e.g., a load source server 1010, user device 1020, or the like) to diagnose the problem remotely. This in various examples can help service teams prepare for necessary or desirable repairs or replacements such as before the load source 200 reaches the customer. For example, where a battery 305 is determined to be faulty, failing or out of power, appropriate parties can be notified or replace, repair or charge the battery 305 as necessary. In various embodiments, a load source system 300 can send diagnostic data or an alert (e.g., of one of more issues) to a load source server 1010 or to a user device 1020 at various suitable intervals or when triggered, which can allow such data or alert to be provided to a customer or other suitable user via a user device 1020. In some embodiments, such data or alert can be presented at the load source 200 (e.g., via interface 460).

Various embodiments can be configured to allow for remote intervention in addressing issues related to a load source 200. For example, in the event that an unsafe condition of a battery 305 is detected at a load source 200 and reported to a central control system such as a load source server 1010 or user device 1020, in various embodiments the battery 305 can be remotely controlled (automatically or with a human in the loop) and put into a more passively safe state, or otherwise remediate the identified unsafe condition.

For example, a method of remotely remediating an undesirable condition in a load source 200 can include determining at the load source 200 an undesirable condition of the load source 200, such as an undesirable condition of a battery 305 or other system. In some embodiments, such a determination can be made by a battery management system 1160. The method can further include sending an alert of the determined undesirable condition to a remote system such as via a network 1030 to a load source server 1010, user device 1020, or the like (see FIG. 10). Such a remote system can generate and send remediation instructions to the load source 200 via the network 1030, which can cause a load source system 300 of the load source 200 to implement one or more remediation actions to remediate the determined undesirable condition.

In another embodiment, a method of remotely remediating an undesirable condition in a load source 200 can include generating condition data at the load source 200, and sending the condition data to a remote system such as via a network 1030 to a load source server 1010, user device 1020, or the like (see FIG. 10). Such a remote system can process the condition data and determine whether an undesirable condition is present in the load source 200, such as an undesirable condition of a battery 305 or other system. If so, the remote system can generate and send remediation instructions to the load source 200 via the network 1030, which can cause a load source system 300 of the load source 200 to implement one or more remediation actions to remediate the determined undesirable condition.

A load source 200 (e.g., a stove 125, water heater 140, or heat pump 120) may be subject to various undesirable conditions, which may include heating elements, which may overheat or malfunction; the battery 305 and its associated circuitry, which could experience overcharging, undercharging, or other electrical faults; and the control and power regulation circuits, which may suffer from overload or failure. Ventilation and cooling systems within the load source 200 could experience clogging or insufficient airflow, resulting in excessive heat accumulation. Mechanical components, such as pumps or fans in a heat pump 120 or water heater 140, could encounter mechanical wear or failure. In some examples, sensors or communication systems responsible for network connectivity may also malfunction or degrade, leading to operational inefficiencies. Additional examples can include the water pipes in a water heater 140, which could leak or become clogged, and the induction or gas burners in a stove 125, which could experience ignition failures or erratic temperature control.

To determine whether an undesirable condition is present, various types of data from a load source 200 can be used. For instance, temperature sensors may monitor internal heat levels, detecting abnormal rises that signal overheating or component failure. Battery health data, such as voltage, charge capacity, and discharge rate, can be monitored to identify issues such as excessive charging or capacity loss. Pressure sensors in water heaters 140 or heat pumps 120 may provide information regarding leaks or pressure loss. Humidity sensors could detect the presence of water where it is undesirable, such as in electrical components or control circuits. Additionally, vibration or impact sensors could track physical disturbances, such as dropping or mishandling the appliance, which could lead to structural damage. Energy consumption data, including abnormal spikes or drops in power usage, could indicate component degradation or system inefficiencies. Connectivity and diagnostic logs sent to a remote device can in some examples provide data on software or network issues, allowing for remote diagnostics and possible remediation.

Some embodiments can include a low-power mode for manufacturing, shipping, warehousing, delivery, or the like, which can be desirable in various examples to ensure that the battery 305 remains in a healthy state by minimizing standby losses, preventing deep discharge, and extending its overall lifespan. This in various examples can also reduce the risk of the battery 305 becoming a safety hazard when stored for extended periods, expending too much energy, becoming depleted before a load source 200 of the battery 305 gains access to a power supply 505, or the like.

Instead of relying on manual activation of a such a low-power mode, a load source 200 in some embodiments can be designed to automatically enter a low-power mode when stored for extended periods (e.g., for a defined period of time without being connected to a power input 505). In various examples, this can reduce the risk of human error in setting such a mode and can ensure health of the battery 305 even if the load source 200 remains in storage and/or in transit for an extended duration.

In some embodiments, transportation carriers (e.g., airlines) or warehousers can require the battery 305 of a load source 200 to be in a low state of charge level to allow safe flight, transport, storage, or the like, or to comply with applicable regulations. For example, a battery 305 can be required to be charged below a certain threshold. In some embodiments, a safe transport status can be indicated via an interface 460 (e.g., by an externally visible LED) to indicate that the battery 305 is at or below one or more given charge threshold. In some embodiments, a battery 305 or load source system 300 can have a switch or other input to enable a “safe transport mode,” which upon engaging the input, it can internally and automatically discharge the battery 305 to a safe level or at least below one or more defined thresholds.

Some embodiments can include a physical battery interlock that must be actuated before the appliance is operable to be fully powered up, which can be a safety feature of various examples. Such a battery interlock can ensure in various examples that the appliance remains at a lower voltage potential until it is ready for installation. This can reduce the risk of accidental electrical contact during transport or installation, making it safer for both users and service personnel.

In various embodiments, a physical battery interlock for a load source 200 can be designed to ensure that the battery 305 is securely connected and properly engaged before the load source 200 is fully powered on. One example embodiment of such a physical battery interlock can involve a mechanical locking mechanism that requires the battery 305 to be physically inserted and secured into place within a housing of the load source 200 before one or more electrical circuits can be closed. This battery interlock can be configured such that the battery 305, when slid into its compartment, must press or actuate a spring-loaded pin or latch that, once fully engaged, allows the flow of current from the battery 305 to the power circuitry of the load source 200. Until the battery 305 is properly seated and the interlock is engaged, the appliance would remain in a low-voltage or standby state, thereby reducing the risk of accidental electrical discharge or short circuits during installation, transport, or maintenance.

In some implementations, a battery interlock can be integrated with an electrical switch or sensor that communicates with a control system of a load source system 300 of a load source 200. Upon engaging the interlock, this sensor can signal the load source system 300 that the battery 305 is ready for use, triggering the load source system 300 to transition from a low-power state to full operational mode. For added safety, the battery interlock in some examples can include a secondary mechanism, such as a mechanical lock or an electronic verification system, to prevent removal or disengagement of the battery 305 while the load source 200 is powered on. This can ensure that the battery 305 cannot be removed or disconnected while the load source 200 is in use, thereby protecting the user from potential electrical hazards. Furthermore, the interlock may be configured in some embodiments to automatically disconnect or shut down the load source 200 if the battery 305 is not properly secured or becomes loose, preventing unsafe operation in the event of a mechanical or electrical failure.

Some embodiments can comprise color-coded interlocks that can provide a visual cue to users and service personnel in some embodiments. For example, a red interlock might indicate that the battery is in a high-voltage state, while green indicates it's safe for installation.

Some embodiments can include one or more labels configured to detect and/or indicate humidity, G-force, tip indications, or the like on the packaging, which can be a proactive approach in some examples to inform users about potential incidents during shipping. This information can help users assess whether the load source 200 has been handled roughly or subjected to unusual conditions during transit. This awareness can prevent unexpected malfunctions and can ensure safe operation upon installation.

Load sources 200 of some embodiments can be designed to generate an impact history report that can be accessed by users. This report in some examples can detail significant impacts or tilts (e.g., above a certain threshold) the load source 200 experienced during shipping, warehousing, delivery, and the like, which may provide users with more comprehensive information about handling conditions and possible damage to the load source 200.

Some embodiments of a load source 200 can include integrating a digital component that allows the load source 200 to communicate warranty status of the load source 200 to a server manufacturer associated with the manufacturer (e.g., load source server 1010). For example, if an enclosure or housing of the load source 200, battery 305, or the like is tampered with, the load source 200 can automatically send a notification to void the warranty status. This can provide a more foolproof way of tracking tampering.

One example of a method of voiding a warranty status can include obtaining data related to activities or conditions at a load source 200 that may be associated with a warranty of the load source 200; determining that the data is indicative of an activity or state that would void the warranty; and as a result, voiding the warranty associated with the load source 200. In some examples, such data can be obtained from one or more sensors 490 of a load source system 300 and the data can be processed at the load source system 300 to determine a warranty voiding activity or state and/or such data can be sent to a remote device for such processing such as a load source server 1010, user device 1020, or the like. In some embodiments, the warranty can be voided by the load source server 1010, user device 1020, or the like, causing updating of a warranty registry associated with the load source system 300 associated with the data.

In some embodiments the packaging or housing of a load source 200, battery 305, or the like can comprise shock-absorbing materials to reduce the risk of damage during transit, installation, or the like. This can provide an additional layer of protection for the load source 200, battery 305, or other elements or systems of the load source system 300.

A load source 200 or battery 305 in some embodiments can have various layers of safety mechanisms or systems that can have a variety of effects and can work independently or together in concert to call for help, safely exhaust stored energy, and/or ensure the stored energy of the battery 305 or other system is inaccessible to a user in a way that could cause harm or danger to the user. In some embodiments, the load source 200, battery management system 1160, or other suitable system of a load source system 300 can be configured to detect and/or communicate one or more of the following events, states or conditions: a thermal or temperature condition above a specified acceptable bound; an electrical short condition; a water ingress condition; or the like.

In some embodiments, such communications of such events, states or conditions can be communicated to the manufacturer of the load source 200, an owner of the load source 200, a manager of the load source (e.g., in a business or workplace), safety personal including the fire department, police, or rescue, and the like. In various examples, such communication can be to a load source server 1010, user device 1020, or the like.

In some embodiments, the load source 200, battery management system 1160, battery 305 or other suitable system of a load source system 300 can be filled with or comprise an intumescent material that swells when heated or ignited. Such an intumescent material in various examples can be configured to fill open spaces within the device, displacing oxygen and making continued ignition more difficult; push apart components that may be electrically shorting, stopping a shorting and sparking condition; and the like.

In some embodiments, the load source 200, battery management system 1160, battery 305 or other suitable system of a load source system 300 comprises a built-in smoke detector that do one or more of, trigger an alarm, trigger other electronic safety systems, trigger an automated extinguishing system, such as in a fire extinguishing bomb, and the like.

The load source 200, battery management system 1160, battery 305 or other suitable system of a load source system 300 can be configured to dump or dissipate stored energy of the battery 305 in the event of a safety condition trigger.

In various embodiments, such a system for dissipating or dumping stored energy from the battery 305 in the event of a safety condition trigger can be configured through one or more suitable methods to ensure rapid and safe energy dissipation. One example can include a resistive load bank integrated into the load source system 300, which is activated when a safety trigger, such as an overvoltage, short circuit, or thermal event, is detected. In some examples, the battery management system 1160 or load source system 300 can divert stored energy from the battery 305 to the resistive load bank, where the energy can be converted to heat and safely dissipated. The battery management system 1160 may continuously monitor the voltage and current of the battery 305 during the process to ensure the stored energy is fully depleted or reduced to safe levels before allowing the load source system 300 to reset or resume normal operation.

In another example configuration, the battery management system 1160 can be configured to disconnect the battery 305 from the load source 200 and simultaneously route the energy to a dedicated discharge circuit. This circuit can include high-power resistors or capacitors designed to absorb and neutralize the excess energy, preventing hazardous conditions such as overheating, overcharging, or electrical shock. Additionally, the management system 1160 in some examples can incorporate fast-acting relays or pyrofuses that, upon detecting certain fault conditions, can immediately sever the connection between the battery 305 and the load source 200, ensuring that energy is contained and dissipated in a controlled manner without affecting other components of the load source 200. In some cases where temperature sensors, or the like, detect unsafe thermal conditions, the battery management system 1160 can further throttle or completely halt energy delivery from the battery 305 to allow for safe dissipation before any critical system failure occurs. The electrical energy in a battery 305 can be dissipated in some embodiments by being run through a passive heating element in some examples to heat up a sufficiently large volume of one or more of, air (e.g., with a fan), metal, water, ceramic, phase-change material, or the like.

Such a safety system in some embodiments can be either active in that it measures the temperature and prevents the mass from rising above an ignition or otherwise unsafe temperature, and/or passive in that the size of the mass being heated is sufficient such that it cannot rise above an unsafe temperature.

The load source 200, battery management system 1160, battery 305 or other suitable system of a load source system 300 of various embodiments can be configured to retain enough energy such that load source system 300 has sufficient power to safely shut down and/or lock the energy storage. Such a system can do this in some examples by one or more of: measuring the remaining energy and retaining a buffer sufficient to achieve proper shutdown; incorporating a long-duration secondary battery sized exclusively for shutting down; and the like.

The load source 200, battery management system 1160, battery 305 or other suitable system of a load source system 300 can in some embodiments have physical interrupts to the battery 305 (e.g., on both the positive and negative sides of an energy storage system). This can increase safety by making the disconnects redundant.

The load source 200, battery management system 1160, battery 305 or other suitable system of a load source system 300 can have self-diagnosis and/or predictive maintenance in some embodiments. For example, the load source 200, battery management system 1160, battery 305 or other suitable system of a load source system 300 can comprise embedded with sensors 490 and software that continuously or periodically monitor and record the performance metrics of the battery 305 and/or other components of the load source system 300. Such systems can be capable in some examples of performing self-diagnostics and predicting potential failures based on the collected data. In the event of any irregularities or potential hazards, the load source system 300 in various embodiments notifies the user or concerned authorities and may recommend preventive maintenance or other necessary actions (e.g., via the interface 460, a load source server 1010, user device 1020, or the like).

Some embodiments include a system that constantly or periodically monitors the insulation resistance of the appliance to detect any degradation. If a significant drop in insulation resistance is detected, indicating a potential short circuit or a compromised component, the system can shut down the battery or appliance and alert the user. Various examples can include insulation monitoring devices or circuits integrated into the electrical system of the load source system 300. Such devices continuously or periodically assess the quality of the insulation by measuring the resistance between the conductive elements of the load source system 300 (e.g., wiring, heating elements, or other internal components), the grounded or non-conductive parts of the load source system 300, and the like. A significant drop in insulation resistance can indicate that the insulation material has degraded or been compromised, which could lead to a short circuit or electrical fault.

For example, such monitoring can be accomplished in some embodiments by incorporating an insulation resistance monitoring circuit or a ground fault detection system (see e.g., FIG. 11). Such systems in some embodiments can work by applying a small voltage between conductive parts and ground, measuring the resulting current, and calculating the resistance. A significant decrease in insulation resistance (e.g., due to wear, moisture ingress, or mechanical damage) can trigger the load source system 300 to shut down the battery 305 or other sensitive electrical components of the load source 200 to prevent potential hazards such as electrical shock, fire, or damage to the load source 200. Additionally, a battery management system 1160 or other suitable control unit can be programmed to notify the user or service personnel of the issue via an alert system, thereby enabling prompt maintenance or repair, or the like.

In some embodiments, a load source system 300 can determine its location (via GPS or other suitable sensor 460) and can adjust safety protocols of the load source system 300 based on the location, which may in some examples be used to determine an environment, area, building, city, state, country, jurisdiction, or the like, that the load source system 300 is present in. For instance, if a determination is made that the load source system 300 is within, or within a defined vicinity of, a school or hospital, the load source system 300 can be configured to switch to a higher safety margin mode, disable certain functionalities of the load source system 300, or the like. In another example, in case of natural disasters like floods, the load source system 300 can automatically go into a shutdown mode, or the like, to prevent electrical hazards based on a determination that the load source system 300 is present in or within a defined proximity to a location where such a natural disaster is occurring or has occurred. In various embodiments, such a shutdown, mode change, or the like can be determined and/or triggered by a load source system 300, a load source server 1010, a user device 1020, or the like.

In some embodiments, a method of changing a mode of a load source system 300 based on location data can include obtaining location data from a load source system 300, determining whether a mode change is desirable or necessary based on the location of the load source system 300, and if so, causing the load source system to make the mode change. For example, in some embodiments, determining whether a mode change is desirable or necessary based on the location of the load source system 300 can be based on identifying specific geographic coordinates or general location data obtained via GPS or other suitable sensors 460. Upon determining that the load source system 300 is within a defined area such as a residential zone, school, hospital, or other sensitive environment, the load source system 300 may automatically enter a safer operational mode. This may involve reducing power output, adjusting operational parameters, or even disabling certain functionalities altogether to comply with local safety regulations or to minimize the risk of harm in case of malfunction. Such location-aware functionality can allow the load source system 300 to be more contextually aware and to operate in a manner that is tailored to the specific needs of its environment. For example, in proximity to schools, where there may be children, the system could automatically limit high-power operations, whereas in an industrial zone, more flexible settings may be allowed. In some examples, a certain jurisdiction (e.g., city, town, county, state, country, or the like) may have specific power or safety requirements generally or based on location such as in a residence, industrial zone, school zone, hospital, daycare, or the like, and the load source system 300 can be configured to change configuration to comply with such regulations generally and/or specifically based on location.

In other embodiments, the load source system 300 may adjust its mode based on dynamic environmental factors such as the onset of natural disasters, inclement weather, or the like. For instance, if it is determined that the load source system 300 is located within a location or region experiencing a flood, earthquake, or severe weather event, the load source system 300 can enter an emergency shutdown mode to prevent electrical hazards such as short circuits, overheating, or fire. The determination to change operational modes can be driven by real-time updates from a load source server 1010, location-based weather alerts, or user-provided input via a user device 1020, or the like. Such dynamic adaptability in various embodiments can ensure that the load source system 300 remains safe, compliant, and efficient, irrespective of its location.

Some embodiments can integrate a (e.g., harmless) distinct-smelling compound into the battery 305 or a battery unit or module that comprises the battery 305. In case of malfunction or overheating, the battery 305 can be configured to emit this odor as an indication of malfunction or overheating. For example, a malfunction or overheating can physically cause a container, sac, pouch, or the like, having a compound to rupture and cause emission of the odor. In some examples, heat above a certain threshold can cause a reaction or state change of a compound to generate the odor. The scent in some examples can be something unmistakable, like freshly baked cookies or even something more pungent. The unexpected smell can indicate that something is amiss, prompting the user to investigate.

While some examples of a load source system can rely solely on a single type of energy storage (e.g., lithium-ion batteries), a load source system 300 in some embodiments can use a hybrid energy storage system incorporating supercapacitors and/or other types of batteries. This diversity can offer safety advantages in some examples; for instance, supercapacitors can be charged and discharged much more rapidly than batteries in some examples, offering an alternative way to dump energy quickly in an emergency. This can also mitigate risks associated with a particular type of energy storage going into a failure mode, as a secondary system can be configured to step in various embodiments.

In various embodiments, a load source system 300 such as a stove 125 can be configured to operate in different operating modes depending on state of the battery 305. For example, a load source system 300 can be configured to operate a stove 125 in a full power mode or in one or more limited power mode (e.g., when the battery 305 is dead or when it is desirable to conserve power stored in the battery 305 and/or being drawn from a receptacle 165).

In various embodiments, a benefit of having a load source system 300 such as a stove 125 that comprises a battery 305 can be that the stove 125 can be operated even when the power from the grid and/or renewable sources is out, intermittent or limited. To facilitate uninterrupted use of a stove 125 under such condition, in some examples, an interface 460 can be configured to alert a user about the charge status of the battery 305 and/or the remaining energy left in the battery 305 so the user can make informed decisions on how much energy to use while cooking, such as delays in regaining power delivery from a utility or renewable sources; when the cost of energy from the grid is expensive; or the like.

A display or other presentation of energy consumption can be visualized in various suitable ways (e.g., to suit user preferences), such as an absolute percentage of battery capacity remaining, quantity of energy stored in kWh or Wh, an estimated time of exhaustion based on the current energy draw, an average of the last X number of minutes of cooking, and the like. In some embodiments, the load source system 300 can determine energy consumption using a machine learning approach based on a cooking training dataset (e.g., including data amassed over the life of the stove 125, a moving window of time therein, or the like).

In the case where the battery 305 is depleted, the user can be notified via the interface 460, such as via a display 384, another visual indicator, an audio indicator, or the like. The interface 460 in various examples can indicate that the stove 125 range will function at limited capacity based on the amount of energy coming from a receptacle 165 the stove 125 is connected to. In some embodiments, when limited power is available based on lack of power from the battery 305 or receptacle 165, the stove 125 can be configured to still have a functional oven 360, but in some examples, the stove 125 can take longer to reach temperature due to operating at lower than full power. In some embodiments, when limited power is available based on lack of power from the battery 305 or receptacle 165, the stove 125 can be configured to operate with a reduced number of burners and/or with less than max power output on one or more burners.

In various environments, a load source system 300 of a stove 125 can be configured to operate in any suitable number of power configurations, including one, two, three, four, five, ten, twelve, or the like. For example, some embodiments can include a full power operating configuration and a minimal operating power configuration, where the minimal operating power configuration provides less operating capacity than the full power operating configuration. Some embodiments can include a full power operating configuration, a first reduced operating power configuration that provides less operating capacity than the full power operating configuration, and a second reduced operating power configuration that provides less operating capacity than the first reduced operating power configuration and full power operating configuration.

Full and reduced or minimum operating power configurations of a stove 125 can provide more or less operating capacity in various suitable ways. For example, in embodiments where a stove 125 comprises an oven 360, a full power operating configuration can allow the oven 360 to operate at 100% power capacity, and one or more reduced operating power configurations can limit the oven 360 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow the oven 360 to operate at 100% power capacity and a minimum operating power configuration that limits the oven 360 to operating at 50% power or less. Another embodiment can include a full power operating configuration can allow the oven 360 to operate at 100% power capacity, a first reduced operating power configuration that limits the oven 360 to operating at 65% power or less, and a second reduced operating power configuration that limits the oven 360 to operating at 35% power or less.

In embodiments where a stove 125 comprises a cooktop 370 with one or more heating regions 372 (e.g., separate induction burners), a full power operating configuration can allow the one or more heating regions 372 to operate at 100% power capacity, and one or more reduced operating power configurations can limit at least one of the one or more heating regions 372 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow one or more heating regions 372 to operate at 100% power capacity and a minimum operating power configuration that limits the one or more heating regions 372 to operating at 50% power or less individually or collectively. Another embodiment can include a full power operating configuration that can allow the one or more heating regions 372 to operate at 100% power capacity, a first reduced operating power configuration that limits the one or more heating regions 372 to operating at 65% power or less individually or collectively, and a second reduced operating power configuration that limits the one or more heating regions 372 to operating at 35% power or less individually or collectively.

In some embodiments, where a stove comprises a cooktop 370 with a plurality of heating regions 372 (e.g., 2, 3, 4, 5 separate induction burners, or the like), different power configurations can limit the total number of heating regions 372 that are able to function at the same time. For example, where a cooktop 370 consists of four heating regions 372, a full power operating configuration can allow up to all four heating regions 372 to operate simultaneously and one or more reduced operating power configuration can limit the maximum heating regions 372 operating simultaneously to three, two or one at a time. In some examples, such a limitation can be on specific heating regions 372 or can apply to any sets of two, three or four heating regions 372 of the four heating regions 372.

In various embodiments, once power from a previously unavailable or unused source becomes available, the stove 125 can switch from a limited operation configuration to a fully operational configuration. For example, after operating in a limited operation configuration from only power from the receptacle 165, as a result of the battery 305 being depleted or below a minimum charge threshold, once the battery 305 has charged to a minimum change state (e.g., defined by a set charge percentage or historical data for how the stove 125 has been used), the stove 125 can return to a fully operational configuration based on power from the battery 305 and receptable 165. Such a configuration change can be presented via an interface 460 in various suitable ways.

In another example, after operating in a limited operation configuration from only power from the battery 305 as a result of the power from the receptacle 165 being unavailable or unused, the stove 125 can return to a fully operational configuration based on power from the battery 305 and receptable 165 once power from the receptacle 165 becomes available or usable (e.g., after a power outage; once the cost of power from the grid is below a cost threshold making it desirable to use; once renewable power becomes available via the receptacle 165 at a sufficient amount such as to provide full power instead of grid power; or the like).

In various embodiments, the load source system 300 can determine or predict a time to achieve different operational capabilities. For example, where a stove 125 is operating in a limited capability mode due to the battery 305 being depleted or having insufficient power, a determination or prediction can be made regarding how long it will take for the battery 305 to charge to a level where the stove 125 will be able to operate at a greater operational capacity and/or a full operational capacity. For example, where a minimum charge of 10% is required for the stove 125 to operate at full power, a determination can be made regarding the time it will take for the battery 305 to charge to 10% capacity. Such a determination can be made based on data such as current charging rate, current power use by the stove 125, predicted power use by the stove 125, current charging current, current charging voltage, stages of a charging protocol, and the like.

Similarly, in some embodiments, where a stove 125 is operating in a full operating configuration or a greater than minimum operating configuration, a determination or prediction can be made regarding how long the battery 305 has sufficient charge to operate at such a level and until the stove will switch to a minimum or lower operating configuration. For example, where a minimum charge of 10% is required for the stove 125 to operate at full power, a determination can be made regarding the time it will take for the battery 305 to be depleted to below or equal to 10% capacity. Such a determination can be made based on data such as current charging rate, current power use by the stove 125, predicted power use by the stove 125, current charging current, current charging voltage, stages of a charging protocol, and the like.

In some embodiments, an interface 460 of the load source system 300 can include a timer counting down to when the stove 125 is predicted to be able to operate at a full capacity configuration; is predicted to be able to operate at greater than a minimum capacity configuration; is predicted to be required to operate at a minimum operating configuration, is predicted to be required to operate at below a maximum operating configuration; and the like. In various examples, an ability of a load source system 300 to provide information about energy consumption, battery status, and switching between normal and one or more limited modes can enhance the user experience by empowering the user to make informed decisions about their us-age of the enhanced induction stove system, thereby optimizing energy usage and user satisfaction. In various embodiments, a load source system 300 can automatically switch between one or more operational power modes without user interaction, such as when battery charge reaches or exceeds one or more threshold, when battery charge reaches or falls below one or more threshold, or the like. In some embodiments, operational power modes can be configured by a user, such as via an interface 460 of a load source system 300.

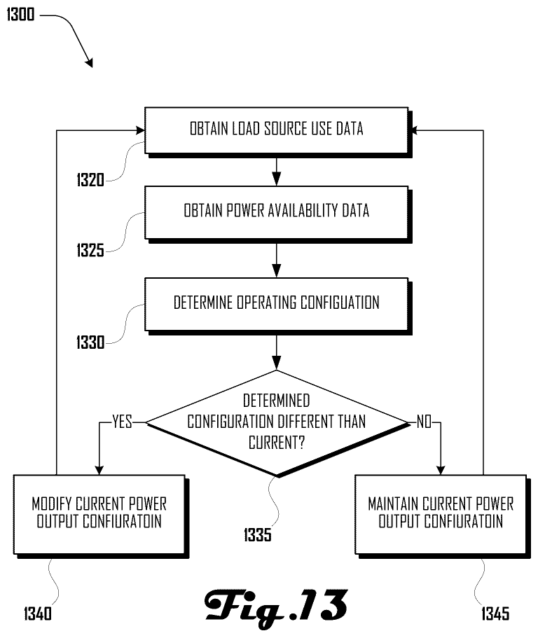

Turning to FIG. 13, an example method 1300 of determining an operating configuration is illustrated, which includes block 1320 where load source use data is obtained (e.g., stove use data), and block 1325 where power availability data is obtained. At block 1330, an operating configuration is determined, and at 1335, a determination is made whether the determined operating configuration is different than a current operating configuration. If so, at 1340, the current output configuration is modified (e.g., to the determined operating configuration). However, if not, the current operating configuration is maintained at 1345. The method 1300 returns to 1320 regardless of whether a current operating configuration is changed or modified, which can allow for monitoring of whether a change in operating configuration is necessary, desirable, or the like. Such monitoring can be in real-time or periodically at various suitable intervals (e.g., real-time, a number of seconds, minutes, hours, days, or the like).

In various embodiments, load source use data can include data regarding elements of a load source 200 being used, such as an oven 360, one or more heating regions 372 of a cooktop 370, and the like. For example, use data can include the identity of one or more heating regions 372 of a cooktop 370 being used, a power level that a heating region 372 is set at, an amount of power being consumed by a heating region 372, a mode of a heating region 372, a power level that the oven 360 is set at, an amount of power being consumed by the oven 360, a mode of the oven 360, an amount of power being consumed by an auxiliary electrical output 540, a mode of an auxiliary electrical output 540, and the like.

In various embodiments, power availability data can include an indication of whether power is available from a battery 305, an amount of power available from a battery 305, voltage and/or current available from a battery 305, an indication of whether power is available from a receptacle 165, an amount of power available from a receptacle 165, voltage and/or current available from a receptacle 165, one or more source of power coming from the receptacle 165, cost of power coming from the receptacle 165, and the like.

In various embodiments, determining an operating configuration can be based at least in part on whether power is available from the battery 305 and/or receptacle 165. For example, where a determination is made that power from the receptacle 165 has become unavailable, but power from the battery 305 remains available, a determination can be made that an operating configuration should be changed to a reduced power configuration from a full power configuration. In another example, where a determination is made that power from the battery 305 has become unavailable, but power from the receptacle 165 remains available, a determination can be made that an operating configuration should be changed to a reduced power configuration from a full power configuration. In another example, where a determination is made that power from both the receptacle 165 and battery 305 are available after one being unavailable, then a determination can be made that an operating configuration should be changed from a reduced power configuration to a full power configuration.

In various embodiments, power from the battery 305 may be unavailable due to the battery 305 lacking charge, lacking charge above a threshold minimum amount, being broken, being absent from the load source system 300, being improperly installed in the load source system 300, where using power from the battery 305 is undesirable, or the like. In various embodiments, power from the receptacle 165 may unavailable due to a power outage of an electrical grid, lack power generated by a renewable source (e.g., solar, or wind), or where using power from the receptacle 165 is undesirable due to cost, being from a non-renewable source, or the like.

For example, in some embodiments, a determination can be made to change to a reduced power configuration from a full power configuration when the cost of power from an electrical grid obtained via the receptacle 165 is above a cost threshold, which may be based on price data, time of day, a selection by a user, or the like. In some embodiments, a determination can be made to change to a full power configuration from a reduced power configuration when the cost of power from an electrical grid obtained via the receptacle 165 is below a cost threshold, which may be based on price data, time of day, a selection by a user, or the like.

In some embodiments, a determination can be made to change to a reduced power configuration from a full power configuration when power from a renewable source becomes available, when power from a renewable source becomes available at an amount above a threshold, or the like. In some embodiments, a determination can be made to change to a full power configuration from a reduced power configuration when power from a renewable source becomes unavailable, when power from a renewable source becomes unavailable at an amount below a threshold, or the like.

In various embodiments, an operating configuration can be selected based on a mode of the load source system 300, which in some examples can be selected by a user, set based on a timer, set based on obtained data, and the like. In some embodiments, a mode can include a battery charging priority mode; a renewable energy mode that prioritizes use of renewable energy sources in powering the load source and/or charging the battery 305; a cost saving mode that prioritizes use of free energy sources such as renewable energy and/or when cost of power from the grid is more affordable; or a performance mode that prioritizes higher functionality of the load source 200 over battery charging, use of renewable energy, cost of power from the grid, or the like.

In some embodiments, a determination can be made to change to a reduced power configuration from a full power configuration when a user switches from a performance mode to a battery charging priority mode. In some embodiments, a determination can be made to change to a full power configuration from a reduced power configuration when a user switches from a battery charging priority mode to a performance mode.

In some embodiments, a determination can be made to change to a reduced power configuration from a full power configuration when a user switches from a performance mode to a cost saving or renewable energy priority mode. In some embodiments, a determination can be made to change to a full power configuration from a reduced power configuration when a user switched from a cost saving or renewable energy priority mode from a performance mode.

In some embodiments, a reduced power configuration can include limiting, stopping or preventing operation of one or more elements of a load source system 300, and for a stove 125 can include limiting, stopping or preventing operation of one or more of an oven 360, heating zones 372 of a cooktop 370, and an auxiliary electrical output 540.

In some embodiments, such a method 1300 of FIG. 13 can be performed by one or more load source system 300, a user device, or battery server to configure one or more load source systems 300. For example, using FIG. 4 for purposes of illustration, in some embodiments, the load source system 300 can control its own configuration (e.g., via the method 1300). In some embodiments, individual load source systems 300 can be as a group by another device or one of a set of load source systems 300 (e.g., a primary load source system 300). Accordingly, load source use data and power availability data can be obtained from a plurality of load source systems 300 or from a single load source system 300, which may or may not include communication of such data via a network (e.g., via communication system 450).

As discussed herein, determining an output configuration can be for various suitable purposes, such as to maximize use of renewable energy sources (e.g., solar panels 115); to maximize storage of power from renewable energy sources; to maximize storage of power from a power grid 110 when such power is at a low or lower cost; to maximize performance of a load source 200; to maximize energy efficiency of a load source; to maximize energy storage by one or more batteries 305; to minimize charging time for one or more batteries 305; and the like. For instance, a shorter nighttime cooking session can be completely covered in some examples by an on-board or associated battery 305, charged during the day with ample solar resources, while a longer, more demanding nighttime cooking session could be powered jointly by the battery 305 and low-capacity outlet (e.g., receptacle 165). In this way, the charge and discharge control laws of the system and/or network can maximize the use of renewable-generated electricity, in some examples, without impacting the experience of the user.

In various embodiments a load source system 300 can include settings that enable a user (e.g., via interface 460) to control functional and usability related aspects of the load source system 300, which in some examples can include a selection of a charging mode, such as based on user preferences, based on external factors, or the like. One embodiment can include a charging mode configured to charge the battery 305 via a receptacle 165 during off-peak hours for lower cost and less grid strain. For example, such a charging mode can be based on the time of day, day of the week, month, time of the year, or the like, which can be set by a user, based on historical patterns, or the like. In some examples, such a charging mode can be based on electricity pricing data (e.g., obtained from a utility company), with charging occurring when price drops below a threshold.

Another example charging mode can be configured to keep the battery 305 topped up all the time in preparation for utility power interruption or other desired use of the battery 305. Yet another example charging mode can be configured to charge the battery 305 during times when the electricity supplied to the receptacle 165 comes from a renewable resource such as solar or that at least prioritizes charging when renewable power is being supplied to the receptacle (e.g., only charging the battery 305 via renewable power unless the battery 305 reaches or is below a charge threshold). In various examples, such a charging mode can be based on data obtained regarding power sources, which can include a house server providing information on an amount of power being generated by one or more renewable sources and/or being provided by an electrical power grid.

To provide a user with information about such one or more charging modes, an interface 460 of the load source system 300 may display such charging modes on a digital display, along with a short description for each charging mode. In this way, the user can be informed about the options available to them and can choose the charging mode that best suits their needs or preferences.

In a home that has multiple appliances that have built-in batteries 305 that are networked together, one or more of the appliances may include an integrated control interface. An integrated control interface may be used, for example, to set global energy policies for the network of appliances such as charging after 9 pm or staying charged all the time in case of a blackout. In one example, it can be desirable to instruct a connected mini-split air conditioner to turn off from your stove because the stove is downstairs from the air conditioner, and you are already cooking on the stove. The ability to control appliances from other appliances can allow for embodiments of such appliances that do not have their own interface and rely on other nodes in the appliance network to control them.

In some embodiments, a stove 125 comprising a load source system 300 can include a temperature cruise control feature that allows users of the stove 125 to dynamically maintain a consistent temperature on one or more heating zones 372 of a cooktop 370. In some examples such a cruise control feature may enable a hybrid approach of mixing power-based control input for a heating zone 372 with temperature control input to the heating zone 372. Such a temperature cruise control feature in some examples can include a power level-based input mode that results in delivering a substantially consistent amount of continuous heat that is adjusted based on a power level (e.g., varying between low, medium-low, medium, medium-high, and high). This can emulate traditional gas stoves with an open loop heating situation where a user has to gauge the temperature and adjust the power level based on the conditions of what is in the pan. An interface 460 can include a mechanism to engage a temperature cruise control mode. When in a temperature cruise control mode, one or more sensors 490 (e.g., temperature sensors) may be used to maintain a substantially consistent temperature of the heated pan or cooking element. For example, in some embodiments, each heating zone 372 of a cooktop 370 can be associated with one or more sensor 490 (e.g., temperature sensor) configured to determine the temperature of a pot or pan at the heating zone 372, the temperature of the cooktop 370 at the heating zone 372, or the like.

In an embodiment, a method of maintaining temperature at a heating zone 372 can comprise obtaining an indication to enter a temperature-maintaining mode at a heating zone 372 of a cooktop 370, and in response, entering the temperature-maintaining mode at a heating zone 372 of a cooktop 370. The method can further include determining a temperature to maintain, which can be based on a user input, user setting, default setting, or the like. The method can further include obtaining temperature data associated from one or more sensors 490 associated with the heating zone 372 and determining whether the temperature is outside a range from the defined temperature to maintain (e.g., +/−0° C., 0.5° C., 1.0° C., 1.5° C., 2.0° C., 5.0° C., 10.0° C. 25.0° C., 50.0° C. or the like or a range between such example values). Where a determination is made that the temperature is within the range, a current power level of the heating zone 372 can be maintained; however, where a determination is made that the temperature is not within the range, power of the heating zone 372 can be increased or decreased to raise or lower the temperature to be within the temperature range. Such temperature sensing and power regulation can occur automatically at any suitable time interval while the temperature-maintaining mode is engaged. The method can further include receiving an indication to cease the temperature-maintaining mode at the heating zone 372 of the cooktop 370 and returning to a normal or default heating mode. In various embodiments, each of a plurality of heating zones 372 of a cooktop 370 can be configured to be set to different temperatures to maintain in accordance with separate temperature-maintaining modes of the separate heating zones 372.

In one variation, the knob 382 used to set power level may become the initiator for engaging and/or disengaging a temperature cruise control mode. For example, each burner control knob 382 may comprise a momentary push button that allows the user to turn on the “maintain temperature” mode once the user has identified a desired temperature for the given heating zone 372. In some examples, the user can be presented with and select a desired temperature setting (e.g., an interface 460 presents a temperature such as 200° C. that the user can select) or the user can select a temperature without an explicit temperature being indicated by an interface 460). In some variations, the knob 382 is not only a rotary element but also has a latching push button that enables the “maintain temperature” mode. Once this mode is enabled, the heating zones 372 can be configured to maintain the specified temperature without the need for the user to continuously check and adjust it. In one example, when the user identifies the ideal temperature based on tangible feedback such as cooking the perfect pancake, they can enable the “cruise control” mode to maintain that temperature consistently, similar to how a car maintains a speed. The “cruise control” mode may disable in some embodiments as soon as the user turns the knob 382 (or performs another suitable action), giving them control over the burner's temperature and power level. A temperature control cruise control feature of various embodiments can enhance the user experience by providing an intuitive interface for maintaining consistent burner temperatures, optimizing cooking quality and user satisfaction. Also, while the example of knobs 382 of an interface 380 are discussed as one example, initiating, controlling and terminating a cruise control mode can be done in various suitable ways such as with various suitable elements of an interface 460.

In various embodiments, an oven 360 of a stove 125 can comprise a cruise control mode. For example, the oven 360 of a stove 125 may include one or more temperature sensors and a digital temperature control loop that can enable the oven 360 to maintain a temperature within a desired range. In some embodiments, an oven 360 and/or heating zone 372 of a cooktop 370 can include a preheating mode that overshoots a set temperature point during preheating of the oven 360 and/or one or more heating zone 372. In some embodiments, a plurality of temperature sensors can provide better determination of the uniformity of temperature in the cavity of an oven 360. An average temperature can be determined based on data from a plurality of sensors 490 in some examples, and suitable operational adjustments can be applied based on that determined value. In some examples, where data from a plurality of temperature sensors identifies a difference in temperature above a threshold, the load source system 300 can enable a convection fan of the oven 360 to mix air in the cavity of the oven 360 to generate an increased temperature uniformity within the cavity of the oven 360.

For example, a method of heating an oven 360 can include obtaining data from a plurality of temperature sensors and determining whether a difference between one or more detected temperature is above a threshold difference, and if so, automatically turning on a fan of the oven 360. If a difference between one or more detected temperature is not above a threshold difference, then the fan can be automatically turned off or not turned on. Sampling of data from temperature sensors can occur at any suitable interval.

In some embodiments, a method of power allocation for a localized power grid that includes a battery supplemented appliance includes: in response to an appliance activation, providing power to the appliance, which may include providing battery power to the appliance; in response to external power usage, providing power to the external power usage, which may include providing battery power to the external power usage; and in response to battery depletion, providing power to the battery.

The method in various examples can provide dynamic power allocation for a local energy grid connected to a high-power consumption load source 200 such as a stove 125 comprising an energy storage device (e.g., a battery 305). The method may function with a load source system 300 as described herein but may additionally or alternatively be incorporated with any applicable system. Example use cases for such a method can include office buildings, local households, residential type buildings (e.g., apartment complexes, hotels), local communities (e.g., HOAs, condominium communities, gated communities, etc.), data farms, and/or any other type of local energy grid.

Providing power to the load source 200 can enable function of the load source 200 by providing power to the load source 200 once the load source 200 has been activated. In some embodiments, the load source 200 can comprise a high-power consumption stove 125 that may not be able to function powered directly by the local power grid (e.g., a 220V appliance, such as a stove 125, connected to a 110V receptacle 165). In some embodiments, the load source 200 can comprise a high-power consumption stove 125 that may not be able to fully function powered directly by the local power grid; for example, a 220V appliance, such as a stove 125, connected to a 110V receptacle 165 that is configured to fully function with 220V power; configured to fully function with greater than 110V power; configured to operate at a limited power configuration at 110V; configured to operate at a minimal power configuration at 110V; and the like.

In other words, some embodiments can include a load source 200 such as a stove 125 comprising a load source system 300 that is inoperable to operate in a full power configuration based on power from a receptacle 165 that the load source 200 is plugged into. In some embodiments, such a load source 200 may be inoperable to operate solely via power from the receptacle 165 that the load source 200 is plugged into and may require a combination of power from the receptacle 165 and a battery 305 of the load source system 300 to operate in a full power configuration (e.g., greater than 110V, at 220V, or the like). In some embodiments, such a load source 200 may be inoperable to operate in a full power configuration solely via power from the receptacle 165 that the load source 200 is plugged into and may require a combination of power from the receptacle 165 and a battery 305 of the load source system 300 to operate in a full power configuration (e.g., greater than 110V, at 220V, or the like), but may be able to operate in a reduced, low or minimal power configuration solely via power from the receptacle 165 that the load source 200 is plugged into. In some embodiments, the load source system 300 may be able to operate in a first reduced power configuration solely via power from the receptacle 165 that the load source 200 is plugged into; able to operate in a second reduced power configuration solely via power from the battery 305 of the load source 200; able to operate in a third reduced power configuration via a combination of power from the receptacle 165 that the load source 200 is plugged into and via power from the battery 305; and able to operate in a full power configuration via power from the receptacle 165 that the load source 200 is plugged into and from power from the battery 305. In various embodiments, the first, second and third reduced power configurations can have reduced operating capability of the load source 200 compared to the full power configuration. In various embodiments, the first and second reduced power configurations can have reduced operating capability of the load source 200 compared to the third power configuration.

In various examples, such embodiments can be desirable for providing operability of a load source 200 when power from the battery 305 is unavailable or undesirable to use; when power from the receptacle 165 is unavailable or undesirable to use; and/or when power from both the receptacle 165 and the battery 305 are available and desirable to use.

In various embodiments, providing power from the battery 305 to the load source 200 can function to provide supplementary power to the load source 200 in addition to or as an alternative to power from the receptacle 165, such that the load source 200 may operate in one or more power configuration. In some variations, not all load source 200 functionalities may require supplementary power, thus power from the battery 305 may be provided in some examples only when additional power is necessary for the load source 200 to function.

In some variations, a method may be implemented with a system that includes multiple battery integrated load sources 200. In some such variations, power may be provided to each load source 200 separately, wherein providing battery power to the load source 200 can function individually for each load source 200. For example, a battery 305 integrated with a single load source 200 may provide supplementary power for function of that single load source 200.

Providing power to the external power usage can function to provide electrical power to a device connected to the local power grid. Providing power to the external power usage in various examples can provide sufficient power to the device to enable the device to function within device specifications. Some examples can provide power to multiple devices, and in some household energy grid implementations, can function in allocating power to dozens of devices/operations as necessary or desired.

Providing power to the external power usage may include providing power from the battery 305 to the external power usage. Providing battery power to the external power usage may in some examples be dependent on the amount of external power usage and level of battery charge (e.g., current amount of power stored in the battery 305). Providing battery power to the external power usage may allow for supplementary power for the external power usage when more power is being used, and the battery 305 is sufficiently charged. Additionally, where the battery 305 is incorporated with the load source 200, providing battery power to the external power usage in some examples can be reserved for times when the load source 200 is not activated, and the battery 305 is not providing (e.g., supplementary) power to the load source 200. Thus, providing battery power to the external power usage can function in various examples to provide supplementary power for general power usage on the local grid during times of increased power need and/or when the load source 200 has reduced or no power need.

In some variations that include multiple batteries 305 integrated with multiple load sources 200, each battery 305 may have a separate call for providing battery power to the external power usage, wherein each non-activated load source 200 may have its integrated battery 305 provide power for external power usage, while each activated load source 200 may have its integrated battery 305 provide power for use of each activated load source 200.

Providing power to the battery 305 can function to charge the battery 305 from external power. Although providing power to the battery 305 may occur in various examples any time the battery 305 needs to be charged, in some examples charging the battery 305 can be initiated in times of low power consumption of the local power grid, (e.g., during times that the load source 200 is not in use and there is less than normal external power usage). For example, for a household power grid this may occur during the night.

In some embodiments, a load source 200 can comprise a stove 125 with a load source system 300 that operates on a standard 120V, 20-amp receptable 165, while still providing the functionality and quality of cooking experience available in a stove 125 that operates plugged into a standard 240V, 20-amp, 30-amp or 50-amp receptacle 165. Various embodiments can comprise a stove 125 with a load source system 300 that does not require electrical upgrades (e.g., installing a new 220V receptacle in place of a 110V receptacle) or skilled labor beyond that needed to perform a standard stove replacement, allowing the stove 125 to be installed in occupied apartments with limited resident disruption.

Various embodiments can include a stove 125 with a minimum of three cooking zones 372, at least two of which use induction coils; an electrically heated oven 360; be configured to plug into and operate from a standard three-prong household wall socket (e.g., 120 VAC+/−10%, single phase, 60 Hz socket on a 20-amp circuit breaker); be configured for installation that does not require an electrician or other skilled labor and can be completed by property management staff within two hours; have a width of 24″ or 30″, and a form factor that matches a standard slide-in range; that will achieve relevant UL certifications and meet all other applicable, industry standard safety requirements; be a cost-effective electrification retrofit option for multifamily residential buildings; and the like.

In various embodiments, a load source 200 (e.g., a stove 125) can be configured to pass one or more of the following standards: ASTM F1496: Standard Test Method for Performance of Convection Ovens; ASTM F1521: Standard Test Methods for Performance of Range Tops; UL 858: Standard for Household Electric Ranges; UL 2595: Standard for Safety for General requirements for battery-powered appliances; UL 1642: Standard for Lithium Batteries (Cells); UL 2054: Standard for Household and Commercial Batteries; UL/IEC 62133-2: Standard for Safety for Secondary Cells and Batteries containing Alkaline or Other Non-Acid Electrolytes-Safety Requirements for Portable Sealed Secondary Cells & for Batteries Made From Them for Use in Portable Application; UL 1973: Standard for Batteries for Use in Stationary, Vehicle Auxiliary Power and Light Electric Rail (LER) Applications; UL 9540A: Standard for Test Method for Evaluating Thermal Runaway Fire Propagation in Battery Energy Storage Systems; and the like.

Various embodiments can include a load source 200 (e.g., a stove 125) having one or more of the following characteristics: maximum power of the load source 200 running off an electrical panel that does not exceed 1,800 W; maximum Amps used by the load source 200 while in use that does not exceed 16 A; a minimum of three cooking zones 372, with at least two of which comprising induction coils; one induction coil that is at least 8 inches in diameter and placed at the front of the range to facilitate its preferential use; a glass cooktop 370; being without exposed resistance coils for the cooking zones 372; the ability to combine two or more cooking zones into a larger single zone; have a water heat-up time on the cooking zones 372 of the cooktop 370 that is no more than 7 minutes (e.g., following ASTM F1521 Standard Test Methods for Performance of Range Tops); cooking zones 372 having a turndown ratio of at least 6:1 in at least 10 increments from lowest to highest heat (e.g., via knobs 382 of an interface 380); controls of a cooktop 370 and/or oven 360 that include a clock, timer, oven temperature display and oven/broiler presets (e.g., via an interface 380); controls of an interface 380 that are Americans with Disabilities Act (ADA) compliant; have a set of controls (e.g., knobs 382) that are no higher than 48 inches above the ground and placed at the front of the stove 125 such that a user does not need to reach past or over a cooking zone 372 to control the cooking zone 372; an oven 360 with minimum volume of 2.5 cu ft for 24″ width or 4.5 cu ft for 30″ width; an oven 360 with a minimum of three rack positions; an oven 360 with a broiler; an oven 360 with a convection fan; an oven 360 with an oven light; an oven 360 with performance that meets or exceeds ASTM F1496; an oven 360 and/or broiler capable of operating at full power simultaneously with the largest heating zone 372 of the cooktop 370 at full power for at least 10 minutes; a battery 305 integrated into the stove 125 such that the battery 305 cannot be removed by a user, but that can be swapped out by a trained technician with the proper tools; a battery 305 with a minimum of 5,000 charge cycles; and ability to operate two or more heating zones 372 of a cooktop at full power simultaneously with an oven 360 at full power for a minimum of ten minutes.

It should be clear that the embodiments discussed herein are only some example embodiments of a load source system 300 and that load source systems 300 having fewer or more elements or having more or less complexity are within the scope and spirit of the present disclosure. For example, one or more of the elements of FIG. 3-8 can be specifically absent in some embodiments, can be present in any suitable plurality, or the like. In some embodiments, a communication system 450 can be absent and the load source system 300 can be inoperable for wired and/or wireless communication with other devices. In some embodiments, elements such as processor 410 and clock 430 can be absent. The interface 460 can comprise a plurality of interface elements or a complex interface in some examples or can be a simple interface 460 in some embodiments or can be absent. In some embodiments, an interface for the load source system 300 can be embodied on a separate device such as a user device (e.g., a smart phone, laptop, home automation system, or other suitable device). Additionally, load source systems 300 can be various suitable sizes, including systems that weigh 1-5 pounds, 10-30 pounds, 50-100 pounds, 150-500 pounds, 500-1,500 pounds, or the like.

Additionally, in some embodiments, on-board or network control laws can be adaptive to patterns of use, which can allow a given battery capacity to adapt to expected demands. Further, these laws in various embodiments can be configured to adapt to local time-of-use rates, allowing behind-the-scenes energy arbitrage. Implementation of these control laws can be based on reinforcement learning and controls techniques, accompanied by best practice user interfaces allowing homeowner monitoring and tuning.

Various embodiments can be configured for managing the thermal requirements of the battery 305 of the load source 200. Due to the high-energy density, thermal runaway of lithium batteries can be a safety concern and should be prevented in various examples. Additionally, on a less catastrophic level, operating batteries at elevated temperatures can impact lifetime of the battery. Because of these factors, a battery management system 760 can have integrated temperature sensing and thermal interlocking. Accordingly, various embodiments can comprise a battery management system 760 along with careful thermal design to isolate battery compartments from regions of the appliance or local environment with unsafe operating temperatures. For instance, an effective design strategy for thermal management in various embodiments is building high aspect ratio packs adjacent to the ambient environment. Another strategy can be to incorporate fire suppression at the appliance level in the individual load source system 300. For example, in some embodiments a load source system 300 can include a fire suppression system that comprises sensors operable to determine whether a fire is occurring in the battery, and if so, execute fire-suppression measures such as releasing foam, liquid, gas, generating a vacuum, or the like to extinguish the fire.

Some embodiments can be configured for obtaining adequate safety certifications by placing batteries directly into appliances and obtaining sufficient buy-in from appliance manufacturers to adopt this technology. Mitigation strategies may include one or more of the following. First, some embodiments can include data analytics and software modeling to estimate the most effective appliance targets and quantify value propositions. For instance, some examples can include localized estimates of the value per watt-hour capacity for each appliance based on time-of-use electricity prices, grid scale and distributed renewables enabled, and avoided electrical upgrade costs. Second, some embodiments can include hardware units which can sit between an existing appliance and the electrical outlet, before integrating with appliances. These hardware units can verify the value proposition in terms of achievable demand response under real-world use, as well as test robustness of the hardware, networking, and control electronics and can be used in place of appliances with integrated batteries, along with appliances with integrated batteries, with conventional appliances before replacement with a battery-integrated appliance, and the like. Third, various embodiments can include safety certifications through UL or another body, as well as green certifications through the nascent ENERGY STAR Connected Functionality program or similar.

In various embodiments (see, e.g., FIG. 3), the battery can reside within the appliance itself, whether a stove, refrigerator, HVAC system, clothes washer, clothes dryer, TV, game machines, tools, BBQ, lighting, lawnmower, grass blower, vacuum cleaner, blender, juicer, food processor, basement freezer, speakers, audio equipment, cooling fans, or other appliances. These batteries, in some examples, may be factory installed and integrated directly with the control electronics of the appliance.

In various embodiments, control schemes of such appliances may operate in several modes including one or more of the following examples. First, such appliances may effectively share loads between a wall plug and a battery based on estimated usage requirements without impeding user experience. This scheme may be used in some examples to maximize the energy used from a solar installation or other alternative energy source, or to enable the use of high-capacity devices running from a 110V socket or enable the use of time-of-use electricity rates. Another control scheme may operate when the appliance is not in use, nor expected to be in use in the near future, where the appliance provides energy arbitrage services, which can enable a house to absorb and store cheap electricity from the grid for later use.

In various embodiments, control schemes for battery integrated appliances may function using several levels of data including one or more of the following examples. First, they may rely only on calendar and time of day to predict loads and supply. Second, they may incorporate historical use data to tailor the algorithms to the habits of the user. Third, they may report data back to a central system where it is aggregated and used to provide control laws. Fourth, it may accept user input to switch control modes (for instance, a user can press a button to prepare the stove to cook a large meal, during which it will pre-charge to full capacity and/or load share between the battery and plug during operation). Fifth, they may use data about electricity rates (e.g., time-of-use rates) from the utility to tailor control laws to use the cheapest electricity from the grid. Sixth, they may use data from a rooftop solar array to predict and maximize the use of available solar electricity.

Additional benefits may be provided to the appliances by the batteries in accordance with further embodiments. For example, many conventional appliances have performance limited by the peak power provided by the wall outlet. The batteries can allow for much higher peak powers, which can be used to increase the performance of appliances. For instance, induction stoves can have extremely fast temperature ramp up, higher peak outputs, and lower noise. On-demand water heating can have higher capacity, enabling storage-free water heaters with higher outputs. Electric kettles can be made to boil faster. For devices with motors, these motors can be run with higher peak powers, and if desired, at voltages more optimal than the AC from the wall. In some cases, the battery thermal management can be synergistic with the appliance performance. For instance, the heat from the battery pack can boost the coefficient of performance of heat pump devices like electric dryers.

With a home electric system, many costs can be proportional to peak power. Installing batteries at end uses can decrease peak power, and hence decrease these costs. By enabling hybrid AC/DC systems, battery-integrated appliances may also enable the use of higher efficiency solid state power conversion, including inverters and DC/DC voltage conversion.

Battery-integrated appliances of various embodiments can provide fire retardant capabilities, to protect against thermal runaway of lithium batteries, and can include a fire alarm to warn of an emergency. Device health monitoring may also be incorporated to monitor the state of health of the battery pack. This can be implemented through capacity monitoring, internal resistance measurements, or impedance spectroscopy. Such devices may also be made waterproof to protect batteries and electronics. These devices can also provide voltage regulation services for the house electrical system.

In various embodiments, a battery can allow high-power appliances to be usable with 120V receptacles as opposed to having to install a 240V power source. In some examples, batteries can have 4-24 hours of storage. Some embodiments can obtain real-time or historical use data for a room, house, building, block, city, state, and the like. In various examples, it can be beneficial to minimize inversions (e.g., inverter in battery module that sits on DC bus can prevent multiple inversions). Some embodiments can have power sharing between appliances (e.g., via extension cords, existing or new in-wall wiring, Ethernet, and the like). Some examples can have a battery module that is integral or replaceable within the appliance. Such a battery module can be configured to be a self-contained unit that is waterproof, heatproof, and the like, and can provide for shallow cycling of battery, fire suppression, battery monitoring, and the like. The whole module, including control systems, may be a replaceable unit since control systems may be inexpensive compared to the battery.

The battery module in various examples can obtain and use different types of data to control battery use. This can depend on network connectivity or complexity of the system. A simple battery module can simply include a clock and lookup table with the battery module operating based on time, day, season, or the like. Another more complex version can store use history from only the battery module itself or local battery modules and use a clock to control battery operation. Another more complex version can have network connectivity (e.g., to the Internet), which can provide access to data from an electrical grid, use data from remote modules, etc.

Various embodiments can be configured to forecast use based on data discussed above, or the like. Some embodiments can be configured to operate based on user input (e.g., user indicates he is about to or will cook a meal at a later time or date). Forecasting can be based on data such as user calendars, user defined schedules, or the like.

Some devices can have large ramp-up requirements and having a local battery 305 can reduce this, resulting in faster, better appliances (e.g., faster heating). Appliances can be configured to dial up voltages as necessary to provide for improved appliances. Other benefits can include electrostatics in washer/dryer, quieter operation from supersonic induction, increased efficiency of inverters, and the like.

While specific examples are discussed herein, these examples should not be construed to be limiting on the wide variety of alternative and additional embodiments that are within the scope and spirit of the present disclosure. For example, appliances, devices or systems can be associated with one or more batteries as discussed herein. Also, while residential examples are the focus of some examples herein, further embodiments can include multi-family buildings, commercial buildings, vehicles, or the like.

As used herein, first, second, third, etc., are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeably without departing from the teaching of the embodiments and variations herein.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

1. A computer-implemented method of operating a load source, the method comprising:
obtaining data associated with the load source, the load source comprising:
an interface configured to control the load source and present an indication of one or more errors,
a power cord connected to a 120V receptacle,
a charger that obtains power from the 120V receptacle,
a housing,
a rechargeable 230 VDC-250 VDC lithium-based battery integrally disposed within the housing, the battery configured to receive power from and be charged by the charger,
a load source computing device, and
a battery management system associated with the battery,
wherein the battery management system is configured to identify a first error based at least in part on a first set of data associated with the load source and report the first error to the load source computing device to cause a change in operation of the load source, and
wherein the load source computing device is configured to identify a second error based at least in part on a second set of data associated with the load source and report the second error to the battery management system to cause a change in operation of the battery;
identifying, by the battery management system, the first error based at least in part on the first set of data associated with the load source and reporting the first error to the load source computing device to cause a change in operation of the load source; and
identifying, by the load source computing device, the second error based at least in part on the second set of data associated with the load source and reporting the second error to the battery management system to cause a change in operation of the battery.

2. The computer-implemented method of claim 1, wherein the first error identified by the battery management system comprises one or more of:
that the battery is in poor health,
that a system of the load source is faulty, or
that there is an ID mismatch between the battery and load source.

3. The computer-implemented method of claim 1, wherein the second error identified by the load source computing device comprises one or more of:
that a system of the load source is faulty,
that an environmental condition is causing damage or danger to the load source, and
that a location of the load source is associated with a location that is identified as causing or potentially causing damage or danger to the load source.

4. The computer-implemented method of claim 1, wherein the load source is an inductive stove that comprises:
a cooktop having a plurality of heating regions that each include an inductive heating coil;
an induction driver that drives the inductive heating coils of the heating regions of the cooktop including in a first configuration with only power from the battery, a second configuration with only power from the 120V receptacle and a third configuration with power from both the battery and the 120V receptacle; and
an electric oven configured to be powered in the first configuration with only power from the battery, the second configuration with only power from the 120V receptacle and the third configuration with power from both the battery and the 120V receptacle,
wherein the change in operation of the load source based at least in part on the first error being reporting to the load source computing device includes one or more of:
at least a portion of the cooktop operating in a low-power configuration,
at least a portion of the cooktop being disabled,
the electric oven operating in a low-power configuration, and
the electric oven being disabled.

5. The computer-implemented method of claim 1, wherein the load source is configured to operate in a low-power error reporting mode, where one or more systems of the load source are disabled or operating in a low-power configuration as a result of to power being unavailable from one or both of the battery and 120V receptacle, but where sufficient power is provided to the battery management system and the load source to still allow for the reporting of the first error to the load source by the battery management system and the reporting of the second error to the battery management system by the load source.

6. The computer-implemented method of claim 1, wherein the battery comprises:
a battery enclosure,
a battery charger within the battery enclosure,
DCDC converter within the battery enclosure,
a plurality of decomposable sub-packs within the battery enclosure, the decomposable sub-packs configured to be isolated using one or more keys, the keys being configured to be physically actuated and/or actuated by the battery management system.

7. A computer-implemented method of operating a load source, the method comprising:
obtaining data associated with the load source, the load source comprising:
a power cord connected to a 120V receptacle,
a housing,
a rechargeable battery integrally disposed within the housing,
a load source computing device, and
a battery management system associated with the battery,
wherein the load source is configured for one or both of:
the battery management system configured to identify a first error based at least in part on a first set of data associated with the load source and report the first error to the load source computing device to cause a change in operation of the load source, and
the load source computing device configured to identify a second error based at least in part on a second set of data associated with the load source and report the second error to the battery management system to cause a change in operation of the battery;
wherein the computer-implemented method further includes one or both of:
identifying, by the battery management system, the first error based at least in part on the first set of data associated with the load source and reporting the first error to the load source computing device to cause a change in operation of the load source; and
identifying, by the load source computing device, the second error based at least in part on the second set of data associated with the load source and reporting the second error to the battery management system to cause a change in operation of the battery.

8. The computer-implemented method of claim 7, wherein the load source further comprises a charger that obtains power from the 120V receptacle and wherein the battery configured to receive power from and be charged by the charger.

9. The computer-implemented method of claim 7, wherein the first error is identified by the battery management system and comprises one or more of:
that the battery is in poor health,
that a system of the load source is faulty, or
that there is an ID mismatch between the battery and load source.

10. The computer-implemented method of claim 7, wherein the second error is identified by the load source computing device and comprises one or more of:
that a system of the load source is faulty,
that an environmental condition is causing damage or danger to the load source, and
that a location of the load source is associated with a location that is identified as causing or potentially causing damage or danger to the load source.

11. The computer-implemented method of claim 7, wherein the load source is an inductive stove that comprises:
a cooktop having a plurality of heating regions that each include an inductive heating coil;
an induction driver that drives the inductive heating coils of the heating regions of the cooktop including in two or more of: a first configuration with only power from the battery, a second configuration with only power from the 120V receptacle and a third configuration with power from both the battery and the 120V receptacle; and
an electric oven configured to be powered in two or more of: the first configuration with only power from the battery, the second configuration with only power from the 120V receptacle and the third configuration with power from both the battery and the 120V receptacle,
wherein the change in operation of the load source based at least in part on an error report and the change in operation includes one or more of:
at least a portion of the cooktop operating in a low-power configuration,
at least a portion of the cooktop being disabled,
the electric oven operating in a low-power configuration, and
the electric oven being disabled.

12. The computer-implemented method of claim 7, wherein the load source is configured to operate in a low-power error reporting mode, where one or more systems of the load source are disabled or operating in a low-power configuration as a result of to power being unavailable from one or both of the battery and 120V receptacle, but where sufficient power is available to the battery management system and the load source to still allow for both the reporting of the first error to the load source by the battery management system and the reporting of the second error to the battery management system by the load source.

13. The computer-implemented method of claim 7, wherein the battery comprises:
a battery enclosure, and
a plurality of decomposable sub-packs within the battery enclosure, the decomposable sub-packs configured to be isolated using one or more keys, the keys being configured to be physically actuated and/or actuated by one or both of the battery management system and the load source computing device.

14. A computer-implemented method of operating a load source, the method comprising:
obtaining data associated with the load source, the load source comprising:
a housing,
a battery integrally disposed within the housing,
a load source computing device, and
a battery management system associated with the battery,
wherein the load source is configured for one or both of:
the battery management system configured to identify a first error based at least in part on a first set of data associated with the load source and report the first error to the load source computing device to cause a change in operation of the load source, and
the load source computing device configured to identify a second error based at least in part on a second set of data associated with the load source and report the second error to the battery management system to cause a change in operation of the battery;
wherein the computer-implemented method further includes one or both of:
identifying, by the battery management system, the first error based at least in part on the first set of data associated with the load source and reporting the first error to the load source computing device to cause a change in operation of the load source; and
identifying, by the load source computing device, the second error based at least in part on the second set of data associated with the load source and reporting the second error to the battery management system to cause a change in operation of the battery.

15. The computer-implemented method of claim 14, wherein the load source further comprises a charger that obtains power from a receptacle and wherein the battery configured to receive power from and be charged by the charger.

16. The computer-implemented method of claim 14, wherein the first error is identified by the battery management system and comprises one or more of:
that the battery is in poor health,
that a system of the load source is faulty, or
that there is an ID mismatch between the battery and load source.

17. The computer-implemented method of claim 14, wherein the second error is identified by the load source computing device and comprises one or more of:
that a system of the load source is faulty,
that an environmental condition is causing damage or danger to the load source, and
that a location of the load source is associated with a location that is identified as causing or potentially causing damage or danger to the load source.

18. The computer-implemented method of claim 14, wherein the load source is an inductive stove that comprises:
a cooktop having a plurality of heating regions that each include an inductive heating coil;
an induction driver that drives the inductive heating coils of the heating regions of the cooktop including at least one of: a first configuration with only power from the battery, a second configuration with only power from a receptacle and a third configuration with power from both the battery and the receptacle; and
an electric oven configured to be powered in at least one of: the first configuration with only power from the battery, the second configuration with only power from the receptacle and the third configuration with power from both the battery and the receptacle,
wherein the change in operation of the load source based at least in part on an error report, and the change in operation includes one or more of:
at least a portion of the cooktop operating in a low-power configuration,
at least a portion of the cooktop being disabled,
the electric oven operating in a low-power configuration, and
the electric oven being disabled.

19. The computer-implemented method of claim 14, wherein the load source is configured to operate in a low-power error reporting mode, where one or more systems of the load source are disabled or operating in a low-power configuration as a result of to power being unavailable from one or both of the battery and a receptacle that the load source is coupled with, but where sufficient power is available to at least one of the battery management system and the load source to still allow for both the reporting of one or both of the first error to the load source by the battery management system and the reporting of the second error to the battery management system by the load source.

20. The computer-implemented method of claim 14, wherein the battery comprises:
a battery enclosure, and
a plurality of sub-packs within the battery enclosure, the sub-packs configured to be isolated using one or more keys, the keys being configured to be physically actuated and/or actuated by one or both of the battery management system and the load source computing device.
